(19) United States
(12) Patent Application Publication
(10) Pub. No.: US 2026/0209593 A1
(43) Pub. Date: Jul. 23, 2026

(54) PROCESS FOR PREPARING RED MUD CEMENT AND CONCRETE COMPOSITIONS COMPRISING THE RED MUD CEMENT

(71) Applicant: St Loarn Group Limited, Kilkelly (IE)

(72) Inventors: Rodney Zubrod, Kilkelly (IE); Sean Cox, Kilkelly (IE)

(73) Assignee: St Loarn Group Limited, Kilkelly (IE)

(21) Appl. No.: 19/421,669

(22) Filed: Dec. 16, 2025

(30) Foreign Application Priority Data
Jan. 20, 2025 (EP) 25152890.7

(51) Int. Cl. C09K 8/42; C04B 7/13; C04B 14/04; C04B 18/04; C04B 18/06; C09K 8/46

(52) U.S. Cl. CPC C09K 8/426; C04B 7/13; C04B 14/045; C04B 18/0409; C04B 18/064; C09K 8/46; C04B 2201/20; C04B 2201/52

(57) ABSTRACT

The present invention relates to a cement composition, a method of preparing the cement composition, and methods, uses and applications for the cement compositions. The present invention also relates to a cementitious composition, a method of preparing the cementitious composition, and methods, uses and applications for the cementitious compositions. The present invention further relates to a concrete composition, a method of preparing the concrete composition, and methods, uses and applications for the concrete compositions. Disclosed herein are methods of cementing of subterranean formations, specifically in wells such as hydrocarbon wells.

### BACKGROUND

The present invention relates to a cement composition, a method of preparing the cement composition, and methods, uses and applications for the cement compositions. The present invention also relates to a cementitious composition, a method of preparing the cementitious composition, and methods, uses and applications for the cementitious compositions. The present invention further relates to a concrete composition, a method of preparing the concrete composition, and methods, uses and applications for the concrete compositions.

The present application further relates to use of the cement, cementitious and concrete compositions as defined herein in construction applications.

Concrete is the second most used material on the earth and second only to water. Concrete is the most widely used building material worldwide. The carbon dioxide released during the production of the Ordinary Portland Cement (OPC) used in concrete consists of as much as 1,000 kilograms per metric ton produced, as a result of the energy required to produce heat during the kiln process, and the carbon dioxide released during heating of calcium carbonate (limestone). This release constitutes about 5 to 10-percent of global manmade carbon dioxide releases.

Concrete produced with OPC is susceptible to degradation from various exposures including low pH materials, high pH materials, sulfates, chlorides, freeze and thaw cycling, heat, and other common exposures. Accordingly, concrete produced with OPC has a relatively short life cycle, which thereby further increases its carbon footprint. There is therefore a need to reduce the use of OPC, in order to reduce the carbon footprint of construction.

Cement is also utilized in many other construction products, ranging from standard concrete to specialty concrete, fireproofing, grout, mortar, asphalt, and soil stabilization, amongst others.

EP3494098 and US2018037504 disclose density controlled cold fusion concrete cementitious spray applied fireproofing materials.

US2012037043 discloses materials, and methods for creating materials, that does not require heat to create a functional construction material. One purpose of the materials and methods disclosed in US2012037043 is to provide industries, such as the construction industry, with a product that significantly reduces the generation of carbon dioxide during production, unlike Portland Cement and some geopolymer cements.

EP4249449 discloses methods of preparing cold fusion concrete and cement using mining waste.

Red Mud is the by-product/waste from the Bayer Process of extracting alumina from the Bauxite Mineral. Bauxite is extracted/mined from the earth, then dried and ground into a fine particle. This dried and ground Bauxite is then mixed with sodium hydroxide, heat and pressure is applied, and the alumina is extracted. The waste from this process is abundant in sodium, alumina, sodium silicate, calcium, Ferrous Oxide, and other metallic materials. Currently about 5-billion tons of Red Mud (or “Bauxite Residue”) is stored throughout the globe in impoundments with little beneficial use, with another approximate 200-million tons produced yearly. The production of alumina through the Bayer Process is an energy and carbon intensive process.

CN114163256A discloses a porous capsule noise reduction and sound insulation material and its preparation method and application. The insulation material is a foamed material formed using inter alia red mud, hydraulic cement, alkali activator, foaming agent and foam stabilizer.

CN114591054A discloses a red mud aerated brick formed. The method of manufacture involves an energy intensive calcination step, involving calcination of red mud and coal slag for several hours, a moulding step, followed by demoulding and cutting to form blocks, which are subsequently placed in a high pressure environment followed by release of pressure and steam treatment to form the red mud aerated bricks.

CN110204258A discloses a full-solid non-burning foamed concrete based on tail gas carbonization. The foamed concrete is formed from a mixture comprising red mud, carbide slag, fly ash, desulfurized gypsum an alkali activator, a foaming agent and a water reducer. The method of manufacture involves an energy intensive carbonization step, whereby the red mud, carbide slag, fly ash, desulfurized gypsum are carbonized in the presence of tail gas from a power plant.

CN110028275A discloses a sound-absorbing brick prepared using solid waste. The method of manufacture involves foaming a mixture of solid waste materials including inter alia red mud, followed by moulding, demoulding and autoclaving at high temperature and pressure.

A fundamental aspect of most subterranean well construction involves primary and remedial cementing. Once a section has been drilled a pipe string may be run into a wellbore and cemented in place. The process of cementing a pipe string in place is commonly referred to as “primary cementing”, which involves introducing/pumping a cement composition into an annulus between the walls of the well bore and the exterior surface of the pipe string. The cement composition sets and forms a barrier positioning and protecting the pipe string. The hardened cement casing about the pipe string is substantially impermeable, and protects the water table, as well as protecting the pipe string from corrosion, and physically reinforcing the pipe string. When servicing a well bore fluids may be lost to the subterranean formation via lost circulation zones, for example fractures lateral of the wellbore. Loss of fluids, such as drilling fluid to lost circulation zones is costly, and can delay completion of the drilling operation. In addition, loss of secondary fluids such as cement/sealant compositions is also costly, and it is highly desirable to minimize such losses. Remedial cementing involves repairing casing strings, and plugging lost circulation zones. Once a lost circulation zone is identified, a lost circulation material may be pumped into the well bore to seal the lost circulation zone. Once the lost circulation zone is sealed, drilling can recommence.

When a well is no longer commercially viable and needs to be decommissioned, the well bore must be plugged prior to abandonment. “Plug and abandon” (P&A) regulations vary, but most require that cement plugs be placed within a wellbore to seal off the wellbore for abandonment, thereby preventing fluid low therefrom, and preventing contamination of the water table. In P&A operations, a plugging composition is introduced to a particular depth within the wellbore. Plugging compositions need to function under a variety of conditions, such as at varying temperatures and pressures.

Cement slurries used in oil and gas wells must be able to consistently perform over a wide range of temperatures and pressures, and in the presence of corrosive materials. A cement slurry may be used in permafrost zones with temperatures below 0° C. as well as in areas of high temperature deep below the surface of the earth.

U.S. Pat. No. 8,307,899B2 is directed to plug-and-abandon operations that use plugging compositions comprising cement kiln dust, pumicite, and/or lime. An embodiment includes a method of plugging a well bore for abandonment comprising: placing a plugging composition in the well bore, the plugging composition comprising: cement kiln dust in an amount of about 5% to about 100% by weight of cementitious components, pumicite in an amount of about 5% to about 100% by weight of cementitious components, 0% to about 24% of Portland cement by weight of cementitious components, and water; and allowing the plugging composition to set and form a plug.

U.S. Pat. No. 9,212,534B2 discloses plugging and abandoning a well using a set-delayed cement composition comprising pumice. The set-delayed cement compositions comprises pumice, hydrated lime, a phosphonic acid derivative cement set retarder, and a polycarboxylated ether dispersant.

U.S. Pat. No. 11,905,789B2 describes a method of sealing an open annular space in a hydrocarbon well, said method comprising:
a) deploying a cutting tool downhole to cut a helical coil opening in one or more casings at a section of an open annular space in a well to be sealed, wherein said helical coil opening provides access to said open annular space external to an outermost casing;
b) optionally deploying a base plug below said section;
c) deploying solid bismuth alloy to said section;
d) deploying a heater to said section to melt said solid bismuth alloy to form molten alloy;
e) allowing said molten alloy to flow out said helical coil openings and allowing said molten alloy to solidify, thereby plugging said section with a plug; and
f) drilling through said plug leaving a sealed annulus.

Cement is susceptible to failure if contaminated, and resins are also employed for P&A operations. Resin sealing materials include ThermaSet® by Wellcem AS, CannSeal® by AGR, and WellLock® by Halliburton. The WellLock® resin system involves cross-linking a polyfunctional amine and a difunctional epoxide to create a three-dimensional polymer network.

U.S. Pat. No. 8,685,903B2 discloses a method may comprise introducing a lost circulation composition into a lost circulation zone, the lost circulation composition comprising hydraulic cement, nano-particles, amorphous silica, clay, and water. The method further may comprise allowing the lost circulation composition to set in the lost circulation zone. Another embodiment includes a lost circulation composition. The lost circulation may comprise hydraulic cement, nano-particles, amorphous silica, clay, and water.

U.S. Pat. No. 10,005,949B2 discloses a method of cementing comprising: introducing a cement composition comprising nano-hydraulic cementitious particles, a hydraulic cement having a mean particle size greater of about 1 micron or greater, and water into a well bore, wherein the water is present in an amount between about 33% to about 200% of the cement composition, wherein the nano-hydraulic cementitious particles have a mean particle size of between about 20 nanometers to about 100 nanometers, the nano-hydraulic cementitious particles being selected from the group consisting of a Portland cement, a pozzolanic cement, a gypsum cement, a soil cement, a calcium phosphate cement, a high-alumina content cement, a silica cement, a high-alkalinity cement, and any combination thereof; and allowing the cement composition to set in the subterranean formation by reaction of the nano-hydraulic cementitious particles and the hydraulic cement with the water to form a hardened mass.

U.S. Pat. No. 10,954,423B2 discloses a method of servicing a wellbore in a subterranean formation having one or more lost circulation zones comprising placing a wellbore servicing fluid comprising a sealing composition into the wellbore, wherein the sealing composition comprises a latex and an accelerator and wherein the latex, the accelerator or both are encapsulated with an encapsulation material.

WO2014075134A1 discloses a geopolymer concrete characterised in that the geopolymer concrete comprises at least one silico-aluminate material, a solid component activator comprising sodium carbonate and sodium silicate, an aggregate and water, wherein the water solubilises the solid component activator to form an alkaline environment for activating the at least one silico-aluminate material to bind the at least one silico-aluminate material with the aggregate to form the geopolymer concrete.

US20210087457A1 discloses a pumpable geopolymer cement composition comprising:
an aluminosilicate source material; an alkaline solution comprising a carrier fluid, an alkaline activator material and a silicate material, wherein, the weight:weight ratio of the alkaline solution:aluminosilicate source material is from 0.1 to 2:1, and the weight:weight ratio of the silicate material:alkaline solution is from 0.15 to 1:1.

The present invention relates to a method of preparing cement, cementitious compositions, and concrete compositions using red mud. The present invention also relates to the compositions per se, as well as their use in a variety of applications. In addition to converting waste (red mud/bauxite residue) into a useful material, the claimed methods and compositions can contribute to a reduction in the use of OPC, and in turn, a reduction in the carbon footprint of construction.

### SUMMARY

The present invention relates to a cement composition, a method of preparing the cement composition, and methods, uses and applications for the cement compositions. The present invention also relates to a cementitious composition, a method of preparing the cementitious composition, and methods, uses and applications for the cementitious compositions. The present invention further relates to a concrete composition, a method of preparing the concrete composition, and methods, uses and applications for the concrete compositions. The present invention further relates to well cements, and methods of cementing involving subterranean formations. For example, the present invention provides a method of servicing a subterranean formation having one or more lost circulation zones, and a lost circulation composition. The present invention further provides a method for cementing to manufacture a casing for a pipe string in a primary cementing operation, and compositions for such methods. The present invention further provides a method of plugging a wellbore, and compositions therefore. In addition, compositions disclosed herein are particularly useful for manufacturing precast concrete due to their high strength. Further compositions disclosed herein are useful for fireproofing, fence-posting and soil stabilization.

Disclosed herein is a method of servicing a subterranean formation having one or more lost circulation zones, comprising:
introducing a lost circulation composition into a lost circulation zone,
the lost circulation composition comprising a cement component and water; and allowing the lost circulation composition to set in the lost circulation zone, wherein the cement component comprises: red mud and gypsum and optionally additives, wherein the additives are present in no more than 50 wt % based on the total weight of the cement component,
wherein the red mud is present in an amount of from 40 wt % to 95 wt % and the gypsum is present in an amount of 5 wt % to 50 wt % based ion the total weight of the cement component, optionally wherein the lost circulation cement composition has a unit weight (or density) in the range of from 10 ppg to 25 ppg, optionally from 10 ppg to 20 ppg, and allowing the lost circulation composition to set in the lost circulation zone.

The red mud may be present in an amount of from about 50 wt % to 75 wt % based on the total weight of the cement component, optionally, wherein the red mud is present in an amount of from 55 wt % to 72 wt %, such as from 57 wt % to 71 wt % based on the total weight of the cement component.

The gypsum may be present in an amount of from 5 wt % to 30 wt % based on the total weight of the cement component, optionally, wherein the gypsum is present in an amount of from 8 wt % to 28 wt %, such as from 9 wt % to 26 wt % based on the total weight of the cement component.

The lost circulation cement composition may have a unit weight in the range of from 10 ppg (1198 kg/m³) to 15 ppg (1797 kg/m³).

The lost circulation composition may have a compressive strength after 24 hours in the range of from 7 MPa to 21 MPa in accordance with ASTM C39, optionally wherein the compressive strength after 24 hours is in the range of from 10 MPa to 20 MPa.

The water to cement ratio may be in the range of from 0.5 to 0.9, such as from 0.55 to 0.85.

The lost circulation composition may have a thickening time at 37.8° C. in the range of from 2.5 hours to 5 hours.

The lost circulation composition may have a 10-second static gel strength of at least about 15 lbf/100 ft² (7.18 N/m²) at room temperature, and wherein the lost circulation composition has a 10 minute static gel strength of at least about 25 lbf/100 ft² (11.97 N/m²) at room temperature.

The additives may comprise metasilicate, optionally, wherein the metasilicate is present in an amount of from 1 wt % to 12 wt % such as in an amount of from about 1 wt % to 8 wt %, suitably from 1.5 wt % to 6 wt % based on the total weight of the cement component.

Also disclosed herein is a method for cementing comprising providing a geopolymer cement composition comprising:
a cement component and water,
wherein the cement component comprises red mud and gypsum and optionally additives wherein the additives are present in no more than 50 wt % based on the total weight of the cement component,
wherein the red mud is present in an amount of from 50 wt % to 75 wt % and the gypsum is present in an amount of 5 wt % to 20 wt % based ion the total weight of the cement component, optionally wherein the geopolymer cement composition has a unit weight (or density) in the range of from 10 ppg to 20 ppg, such as from 10 ppg to 15.5 ppg,
introducing the geopolymer cement composition into a wellbore annulus in a subterranean formation during a primary cementing operation; and allowing the geopolymer cement composition to set in the subterranean formation.

The red mud may be present in an amount of from 52 wt % to 72 wt % based on the total weight of the cement component, optionally, wherein the red mud is present in an amount of from 55 wt % to 72 wt %, such as from 55 wt % to 65 wt % based on the total weight of the cement component.

The gypsum may be present in an amount of from 5 wt % to 30 wt % based on the total weight of the cement component, optionally, wherein the gypsum is present in an amount of from 5 wt % to 25 wt %, such as from 7 wt % to 20 wt % based on the total weight of the cement component.

The geopolymer cement composition may have a unit weight in the range of from 10 ppg (1198 kg/m³) to 15 ppg (1797 kg/m³).

The geopolymer cement composition may have a 24 hour strength in the range of from 4 MPa to 24 MPa.

The additives may comprise pozzolan, optionally, wherein the pozzolan is present in an amount of 10 to 30 wt %, such as from about 15 wt % to 25 wt % based on the total weight of the cement component.

The additives may comprise metasilicate, optionally, wherein the metasilicate is present in an amount of from 1 wt % to 12 wt % such as in an amount of from 1 wt % to 10 wt %, suitably from 2 wt % to 8 wt % based on the total weight of the cement component.

The water to cement ratio may be in the range of from 0.5 to 0.9, such as from 0.52 to 0.88, optionally from 0.55 to 0.85.

Further disclosed herein is a method of plugging a wellbore, comprising providing a geopolymer cement composition comprising:
a cement component and water,
wherein the cement component comprises red mud and gypsum and optionally additives wherein the additives are present in no more than 50 wt % based on the total weight of the cement component,
wherein the red mud is present in an amount of from 40 wt % to 95 wt % and the gypsum is present in an amount of 5 wt % to 50 wt % based ion the total weight of the cement component, optionally wherein the geopolymer cement composition has a unit weight (or density) in the range of from 10 ppg to 20 ppg, such as from 10 ppg to 17 ppg;
introducing the geopolymer cement composition into the wellbore; and allowing the geopolymer cement composition to set in the wellbore.

The gypsum may be present in an amount of from 10 wt % to 40 wt % based on the total weight of the cement component, optionally, wherein the gypsum is present in an amount of from 15 wt % to 35 wt %, such as from 15 wt % to 30 wt % based on the total weight of the cement component.

The geopolymer cement composition may have a 24 hour compressive strength in the range of from 13 MPa to 34 MPa, suitably in the range of from 18 MPa to 30 MPa.

The water to cement ratio may be in the range of from 0.3 to 0.7, such as from 0.4 to 0.6.

Disclosed herein is a method for preparing a cement composition comprising combining:
(a) red mud; and
(b) gypsum;
to provide a cement composition, wherein the red mud is present in an amount of from about 20 wt % to about 95 wt % based on the total weight of the cement composition, and wherein the gypsum is present in an amount of from about 5 wt % to about 50 wt % based on the total weight of the cement composition.

The red mud may be present in an amount of from about 25 to about 95 wt %, such as from about 30 to about 90 wt % based on the total weight of the cement composition, optionally, from about 35 to about 85 wt %, such as from about 40 wt % to about 80 wt % based on the total weight of the cement composition, for example about 45 to about 75 wt % based on the total weight of the cement composition. For example, the red mud composition may be present in an amount of from about 50 to about 95 wt %, such as from about 60 to about 95 wt % based on the total weight of the cement composition. Alternatively, the red mud may be present in an amount of from about 25 to about 55 wt %, such as from about 25 to about 50 wt %, for example from about 25 wt % to about 45 wt % based on the total weight of the cement composition. Alternatively, the red mud may be present in an amount of from about 35 to about 55 wt % based on the total weight of the cement composition.

The gypsum is present in an amount of from about 5 wt % to about 50 wt % based on the total weight of the cement composition, such as from about 10 to about 45 wt %, optionally from about 15 wt % to about 40 wt %. For example, the gypsum may be present in an amount of from about 5 to about 45 wt %, optionally from about 5 to about 40 wt %, such as from about 5 to about 35 wt %, such as from about 5 to about 25 wt %, for example from about 5 to about 15 wt % based on the total weight of the cement composition.

Optionally, the red mud may be present in an amount of from about 60 to about 95 wt % based on the total weight of the cement composition and the gypsum is present in an amount of from about 5 to about 40 wt % based on the total weight of the cement composition. Advantageously, when the red mud is present in an amount of from about 60 to about 95 wt % based on the total weight of the cement composition and the gypsum is present in an amount of from about 5 to about 40 wt % based on the total weight of the cement composition, the cement composition is particularly well suited for forming quick set concrete, for example quick set low strength concrete (with and without aggregate), and quick set well cement.

Optionally, the red mud is present in an amount of from about 25 to about 45 wt % based on the total weight of the cement composition and the gypsum is present in an amount of from about 5 to about 45 wt % based on the total weight of the cement composition. Advantageously, when the red mud is present in an amount of from about 25 to about 45 wt % based on the total weight of the cement composition and the gypsum is present in an amount of from about 5 to about 45 wt % based on the total weight of the cement composition, the cement composition is particularly useful for forming quick set self-levelling concrete.

Optionally, the red mud is present in an amount of from about 35 to about 55 wt % based on the total weight of the cement composition and the gypsum is present in an amount of from about 5 to about 15 wt % based on the total weight of the cement composition. Advantageously, when the red mud is present in an amount of from about 35 to about 55 wt % based on the total weight of the cement composition and the gypsum is present in an amount of from about 5 to about 15 wt % based on the total weight of the cement composition, the cement composition is particularly well suited for forming fire proofing concrete, or for soil stabilization and/or for backfilling fence posts.

Suitably, the red mud comprises Fe₂O₃, SiO₂, Al₂O₃, CaO, TiO₂, Na₂O, P₂O₅, and K₂O.

Optionally, the cement composition further comprises a pozzolan.

The cement composition may comprise a pozzolan in an amount of from about 10 to about 35 wt % based on the total weight of the cement composition, such as in an amount of from about 15 to about 30 wt % based on the total weight of the cement composition. Suitably, the cement composition may comprise a pozzolan in an amount of from about 20 to about 25 wt % based on the total weight of the cement composition.

Suitably, the pozzolan comprises calcium oxide or calcium hydroxide and silicon dioxide. The calcium oxide or calcium hydroxide may be present (in the pozzolan) in an amount of from about 1 to about 60 wt % based on the total weight of the pozzolan. The silicon dioxide may be present (in the pozzolan) in an amount of from about 5 to about 70 wt % based on the total weight of the pozzolan. Suitably, the calcium oxide or calcium hydroxide is present in an amount of from about 1 to about 60 wt % based on the total weight of the pozzolan and the silicon dioxide is present in an amount of from about 5 to about 70 wt % based on the total weight of the pozzolan.

Suitably, the pozzolan is selected from the group comprising carbide slag, granulated ground blast furnace slag, fly ash, attapulgite, kaolin, zeolites, and ground waste glass.

The cement composition may further comprise metasilicate. Suitably, the metasilicate is sodium metasilicate or sodium metasilicate pentahydrate.

Optionally the metasilicate is present in an amount of from about 2 to about 20 wt % based on the total weight of the cement composition, such as in an amount of from about 4 to about 18 wt %, optionally, from about 6 to about 16 wt %, such as from about 8 to about 12 wt % based on the total weight of the cement composition.

Optionally, the cement composition comprises sodium metasilicate in an amount of from about 2 wt % to about 20 wt % based on the total weight of the cement composition.

The cement composition may further comprise a retarder. The retarder may be selected from the group comprising: sodium tetraborate; tartaric acid; boric acid; sodium citric dehydrate and citric acid.

Suitably, the retarder is present in an amount of from about 1 to about 20 wt % based on the total weight of the cement composition, more suitably in an amount of from about 1 to about 15 wt %, such as in an amount of from about 4 to about 12 wt % based on the total weight of the cement composition, for example in an amount of from about 5 to about 10 wt % based on the total weight of the cement composition. For example, the retarder may be present in an amount of from about 1 to about 10 wt % based on the total weight of the cement composition, or from about 4 to about 10 wt %, optionally from about 5 to about 10 wt % based on the total weight of the cement composition.

The cement composition may further comprise zeolite. Optionally, the cement composition further comprises zeolite in an amount of from about 1 to about 5 wt % based on the total weight of the cement composition.

The cement composition may further comprise a rheology modifier and/or a permeability adjuster. For example, the cement composition may further comprise a rheology modifier and permeability adjusting polymer or copolymer.

Suitably, the rheology and permeability adjusting polymer or copolymer is selected from latex, vinyl acetate and polyvinyl alcohol.

Optionally, the cement composition may comprise:
(a) from about 60 to about 95% by weight of red mud; and
(b) from about 5 to about 40% by weight of gypsum.

Suitably, such cement compositions are particularly useful for quick set low strength concrete.

Optionally, the cement composition may comprise:
(a) from about 20 to about 55% by weight of dried red mud; and
(b) from about 5 to about 15% by weight of gypsum;
(c) from about 10 to about 35% by weight of pozzolan; and
(d) from about 2 to about 20% by weight of metasilicate.

Suitably, such cement compositions are particularly useful for quick set self-levelling concrete.

Optionally, the cement composition may comprise:
(a) from about 35 to about 55% by weight of dried red mud; and
(b) from about 5 to about 15% by weight of gypsum;
(c) from about 15 to about 35% by weight of pozzolan;
(d) from about 5 to about 15% by weight of metasilicate; and
(e) from about 1 to about 5% by weight of retarder.

Suitably, such cement compositions are particularly useful for fire-proofing applications, or for soil stabilization or for backfilling fence posts.

Optionally, the cement composition may comprise:
(a) from about 20 to about 55% by weight of red mud; and
(b) from about 5 to about 15% by weight of gypsum;
(c) from about 10 to about 35% by weight of pozzolan;
(d) from about 2 to about 20% by weight of metasilicate;
(e) from about 1 to about 5% by weight of retarder;
(f) from about 1 to about 5% by weight of zeolite; and
(g) optionally from about 0.1 to about 5% by weight of a rheology and permeability adjusting polymer or copolymer.

Optionally, the cement composition may comprise:
(a) from about 20 to about 55% by weight of red mud; and
(b) from about 5 to about 15% by weight of gypsum;
(c) from about 10 to about 35% by weight of pozzolan;
(d) from about 2 to about 20% by weight of metasilicate; and
(e) from about 1 to about 5% by weight of retarder.

For example, the cement composition may comprise:
(a) from about 20 to about 55% by weight of dried red mud; and
(b) from about 5 to about 15% by weight of gypsum;
(c) from about 10 to about 35% by weight of pozzolan;
(d) from about 2 to about 20% by weight of metasilicate;
(e) from about 1 to about 5% by weight of retarder;
(f) from about 1 to about 5% by weight of zeolite; and
(g) optionally from about 0.1 to about 5% by weight of a rheology and permeability adjusting polymer or copolymer.

Also disclosed is a cement composition formed by the method disclosed herein, for example, provided herein is a cement composition comprising:
(a) red mud; and
(b) gypsum;
to provide a cement composition, wherein the red mud is present in an amount of from about 20 wt % to about 95 wt % based on the total weight of the cement composition, and wherein the gypsum is present in an amount of from about 5 wt % to about 50 wt % based on the total weight of the cement composition.

Optionally, the red mud may be present in an amount of from about 60 to about 95 wt % based on the total weight of the cement composition and the gypsum is present in an amount of from about 5 to about 40 wt % based on the total weight of the cement composition. Advantageously, when the red mud is present in an amount of from about 60 to about 95 wt % based on the total weight of the cement composition and the gypsum is present in an amount of from about 5 to about 40 wt % based on the total weight of the cement composition, the cement composition is particularly well suited for forming quick set concrete, for example quick set low strength concrete (with and without aggregate), and quick set well cement.

Optionally, the red mud is present in an amount of from about 25 to about 45 wt % based on the total weight of the cement composition and the gypsum is present in an amount of from about 5 to about 45 wt % based on the total weight of the cement composition. Advantageously, when the red mud is present in an amount of from about 25 to about 45 wt % based on the total weight of the cement composition and the gypsum is present in an amount of from about 5 to about 45 wt % based on the total weight of the cement composition, the cement composition is particularly useful for forming quick set self-levelling concrete.

Optionally, the red mud is present in an amount of from about 35 to about 55 wt % based on the total weight of the cement composition and the gypsum is present in an amount of from about 5 to about 15 wt % based on the total weight of the cement composition. Advantageously, when the red mud is present in an amount of from about 35 to about 55 wt % based on the total weight of the cement composition and the gypsum is present in an amount of from about 5 to 1 about 5 wt % based on the total weight of the cement composition, the cement composition is particularly well suited for forming fire proofing concrete, or for soil stabilization and/or for backfilling fence posts.

Suitably, the red mud comprises Fe₂O₃, SiO₂, Al₂O₃, CaO, TiO₂, Na₂O, P₂O₅, and K₂O.

Optionally, the cement composition further comprises a pozzolan. For example, the cement composition may comprise a pozzolan in an amount of from about 10 to about 35 wt % based on the total weight of the cement composition, such as in an amount of from about 15 to about 30 wt % based on the total weight of the cement composition. Suitably, the cement composition may comprise a pozzolan in an amount of from about 20 to about 25 wt % based on the total weight of the cement composition.

Suitably, the pozzolan comprises calcium oxide or calcium hydroxide and silicon dioxide. The calcium oxide or calcium hydroxide may be present in (in the pozzolan) an amount of from about 1 to about 60 wt % based on the total weight of the pozzolan. The silicon dioxide may be present (in the pozzolan) in an amount of from about 5 to about 70 wt % based on the total weight of the pozzolan. Suitably, the calcium oxide or calcium hydroxide is present in an amount of from about 1 to about 60 wt % based on the total weight of the pozzolan and the silicon dioxide is present in an amount of from about 5 to about 70 wt % based on the total weight of the pozzolan.

Suitably, the pozzolan is selected from the group comprising carbide slag, granulated ground blast furnace slag, fly ash, attapulgite, kaolin, zeolites, and ground waste glass.

The cement composition may further comprise metasilicate. Suitably, the metasilicate is sodium metasilicate or sodium metasilicate pentahydrate.

Optionally the metasilicate is present in an amount of from about 2 to about 20 wt % based on the total weight of the cement composition, such as in an amount of from about 4 to about 18 wt %, optionally, from about 6 to about 16 wt %, such as from about 8 to about 12 wt % based on the total weight of the cement composition.

Optionally, the cement composition comprises sodium metasilicate in an amount of from about 2 wt % to about 20 wt % based on the total weight of the cement composition.

The cement composition may further comprise a retarder. The retarder may be selected from the group comprising: sodium tetraborate; tartaric acid; boric acid; sodium citric dehydrate and citric acid.

Suitably, the retarder is present in an amount of from about 1 to about 20 wt % based on the total weight of the cement composition, more suitably in an amount of from about 1 to about 15 wt %, such as in an amount of from about 4 to about 12 wt % based on the total weight of the cement composition, for example in an amount of from about 5 to about 10 wt % based on the total weight of the cement composition. For example, the retarder may be present in an amount of from about 1 to about 10 wt % based on the total weight of the cement composition, or from about 4 to about 10 wt %, optionally from about 5 to about 10 wt % based on the total weight of the cement composition.

The cement composition may further comprise zeolite. Optionally, the cement composition further comprises zeolite in an amount of from about 1 to about 5 wt % based on the total weight of the cement composition.

The cement composition may further comprise a rheology modifier and/or a permeability adjuster. For example, the cement composition may further comprise a rheology modifier and permeability adjusting polymer or copolymer.

Suitably, the rheology and permeability adjusting polymer or copolymer is selected from latex, vinyl acetate and polyvinyl alcohol.

The cement composition may comprise further additives. For example, the cement composition may comprise further additives in an amount of from about 0.1 to about 3 wt % based on the total weight of the cement composition.

Suitably, such further additives include micro fibres, macro fibres, viscosity modifiers or other cement additives known to the person skilled in the art. For example, the micro or macro fibres may be present in an amount of from about 0.1 wt % to about 3 wt % of the total weight of the cement composition.

Optionally, the cement composition may comprise:
(a) from about 60 to about 95% by weight of red mud; and
(b) from about 5 to about 40% by weight of gypsum.

Suitably, such cement compositions are particularly useful for quick set low strength concrete.

Optionally, the cement composition may comprise:
(a) from about 20 to about 55% by weight of dried red mud; and
(b) from about 5 to about 15% by weight of gypsum;
(c) from about 10 to about 35% by weight of pozzolan; and
(d) from about 2 to about 20% by weight of metasilicate.

Suitably, such cement compositions are particularly useful for quick set self-levelling concrete.

Optionally, the cement composition may comprise:
(a) from about 35 to about 55% by weight of dried red mud; and
(b) from about 5 to about 15% by weight of gypsum;
(c) from about 15 to about 35% by weight of pozzolan;
(d) from about 5 to about 15% by weight of metasilicate; and
(e) from about 1 to about 5% by weight of retarder.

Suitably, such cement compositions are particularly useful for fire-proofing applications, or for soil stabilization or for backfilling fence posts.

Optionally, the cement composition may comprise:
(a) from about 20 to about 55% by weight of red mud; and
(b) from about 5 to about 15% by weight of gypsum;
(c) from about 10 to about 35% by weight of pozzolan;
(d) from about 2 to about 20% by weight of metasilicate;
(e) from about 1 to about 5% by weight of retarder;
(f) from about 1 to about 5% by weight of zeolite; and
(g) optionally from about 0.1 to about 5% by weight of a rheology and permeability adjusting polymer or copolymer.

Optionally, the cement composition may comprise:
(a) from about 20 to about 55% by weight of red mud; and
(b) from about 5 to about 15% by weight of gypsum;
(c) from about 10 to about 35% by weight of pozzolan;
(d) from about 2 to about 20% by weight of metasilicate; and
(e) from about 1 to about 5% by weight of retarder.

For example, the cement composition may comprise:
(a) from about 20 to about 55% by weight of dried red mud; and
(b) from about 5 to about 15% by weight of gypsum;
(c) from about 10 to about 35% by weight of pozzolan;
(d) from about 2 to about 20% by weight of metasilicate;
(e) from about 1 to about 5% by weight of retarder;
(f) from about 1 to about 5% by weight of zeolite; and
(g) optionally from about 0.1 to about 5% by weight of a rheology and permeability adjusting polymer or copolymer.

In another aspect, the present disclosure provides a method for forming a cementitious composition comprising the steps of combining the cement composition disclosed herein with water.

Optionally, the water to cement composition weight ratio is in the range of from about 0.20 to about 0.90. For example, the water to cement composition ratio may be in the range of from about 0.30 to about 0.90, such as from about 0.40 to about 0.90, for example from about 0.40 to about 0.80, optionally from about 0.40 to about 0.75.

The cementitious composition may further comprise an air entraining admixture.

Suitably, the cementitious composition further comprises an air entraining admixture in an amount of from about 2 to about 10 volume % based on the total volume of the cementitious composition, optionally from about 3 to about 8 volume %, such as from about 4 to about 7 volume % based on the total volume of the cementitious composition.

In yet another aspect, the present disclosure provides a cementitious composition formed by the method disclosed herein, for example, by combining the cement composition disclosed herein and water.

Optionally, the water to cement composition weight ratio is in the range of from about 0.20 to about 0.90. For example, the water to cement composition ratio may be in the range of from about 0.30 to about 0.90, such as from about 0.40 to about 0.90, for example from about 0.40 to about 0.80, optionally from about 0.40 to about 0.75.

The cementitious composition may be a pre-set cementitious composition or cured (set).

In a still further aspect, the present disclosure provides a method for preparing a concrete composition, comprising combining a cement composition as disclosed herein, aggregate material and water to form the concrete composition.

The cement composition may be present in an amount of from about 25 to about 98 wt % based on a dry weight of the concrete composition, such as in an amount of from about 35 to about 90 wt %, optionally from about 45 to about 85 wt % based on the dry weight of the concrete composition.

The aggregate material may be one or more of sand, gravel, crushed stone, iron blast blast-furnace slag, lightweight filler, mineral aggregate, and any combinations thereof.

The aggregate material may be present in an amount of from about 1 to about 90 wt % based on the dry weight of the concrete composition, such as in an amount of from about 2.5 to about 85 wt %, optionally from about 3 to about 80 wt % based on the dry weight of the concrete composition.

The aggregate material may comprise a sand size aggregate material having a minimum particle size of 200 μm, or the sand sizes specified in the standard ASTM C33 Standard Specification for Concrete Aggregate. The aggregate material may comprise a sand size aggregate material having a maximum nominal particle size of 4.25 mm. For example, the aggregate material may comprise a sand size aggregate material having a particle size in the range of from of 200 μm to 4.25 mm.

The aggregate material may be a lightweight filler material.

Suitably, the aggregate material comprises sand.

Optionally, the method for preparing the concrete composition may comprise adding a retarder. For example, though the cement composition may comprise a retarder, the method for forming the concrete disclosed herein may comprise adding additional retarder. The additional retarder may be added in an amount of from about 1 to about 10 wt % based on the dry weight of the concrete composition.

The method for preparing the concrete composition may further comprise adding additives, such as polymers or copolymers to modify other properties of the concrete composition. Such additives may be added in an amount of from about 0.05 wt % to about 0.6 wt % based on the dry weight of the concrete composition. For example, micro or macro fibres may be present in an amount of from about 0.05 wt % to about 0.6 wt % of the total weight of the concrete composition.

The present disclosure also provides a concrete composition comprising the cement composition disclosed herein, aggregate material and water.

The concrete composition may be formed by combining the cement composition disclosed herein, aggregate material and water. For example, the concrete composition may be formed by the method for preparing a concrete composition disclosed herein.

The cement composition may be present in an amount of from about 25 to about 98 wt % based on a dry weight of the concrete composition, such as in an amount of from about 35 to about 90 wt %, optionally from about 45 to about 85 wt % based on the dry weight of the concrete composition.

The aggregate material may be one or more of sand, gravel, crushed stone, iron blast blast-furnace slag, lightweight filler, mineral aggregate, and any combinations thereof.

The aggregate material may be present in an amount of from about 1 to about 90 wt % based on the dry weight of the concrete composition, such as in an amount of from about 2.5 to about 85 wt %, optionally from about 3 to 80 wt % based on the dry weight of the concrete composition.

The aggregate material may comprise a sand size aggregate material having a minimum particle size of 200 μm, or the sand sizes specified in the standard ASTM C33 Standard Specification for Concrete Aggregate. The aggregate material may comprise a sand size aggregate material having a maximum nominal particle size of 4.25 mm. For example, the aggregate material may comprise a sand size aggregate material having a particle size in the range of from of 200 μm to 4.25 mm.

The aggregate material maybe a lightweight filler material.

Suitably, the aggregate material comprises sand.

Optionally, the concrete composition may be formed by combining the cement composition disclosed herein, aggregate material, a retarder, and water. For example, though the cement composition may comprise a retarder, the method for forming the concrete disclosed herein may comprise adding additional retarder. The additional retarder may be added in an amount of from about 1 to about 15 wt % based on the dry weight of the concrete composition.

Further additives may also be added, such as polymers or copolymers to modify properties of the concrete composition. Such additives may be added in an amount of from about 1 to about 15 wt % based on the dry weight of the concrete composition. The concrete composition may comprise air entraining admixture, for example the concrete composition may further comprise an air entraining admixture in an amount of from about 2 to about 10 volume % based on the total volume of the concrete composition, optionally, from 3 to about 8 volume %, such as from about 4 to about 7 volume % based on the total volume of the concrete composition.

The concrete composition may be a pre-set concrete composition or cured (set).

The cement composition of the present disclosure is useful in a wide range of applications, for example, for manufacturing quick set concrete, for example, quick set low strength concrete, quick set well cement, quick set self-levelling concrete compositions, fire proofing concrete compositions, for fencing applications i.e. anchoring fence posts or backfilling fence posts, and/or for soil stabilization.

The invention relates to the use of cement compositions, cementitious compositions and concrete compositions as defined herein in construction applications.

The cementitious composition is suitable for use in protecting structural steel or concrete from fire, wherein said use comprises applying the composition to the structural steel or concrete.

The concrete composition is suitable for use in protecting structural steel or concrete from fire, wherein said use comprises applying at least a partial coating of the concrete composition to the structural steel or concrete, thereby providing a fire resistant coating on the structural steel or concrete.

The cementitious composition is suitable for use in stabilizing fine grained expansive or compressible soils, wherein said use comprises mixing the cementitious composition with soil materials.

The concrete composition is suitable for use in stabilizing fine grained expansive or compressible soils, wherein said use comprises mixing the concrete composition with such soil materials.

The cementitious composition is suitable for use in increasing soil strength, wherein said use comprises mixing the composition with granular soil materials.

The concrete composition is suitable for use in increasing soil strength, wherein said use comprises mixing the composition with granular soil materials.

The cementitious compositions disclosed herein are suitable for use as a hydrocarbon well cement.

The concrete compositions disclosed herein are suitable for use as hydrocarbon well cement.

Provided herein is a method of cementing comprising:

providing a geopolymer cement composition comprising:
a cement component and water,
wherein the cement component comprises red mud and gypsum and optionally additives wherein the additives are present in no more than 50 wt % based on the total weight of the cement component,
wherein the red mud is present in an amount of from 40 wt % to 95 wt % and the gypsum is present in an amount of 5 wt % to 50 wt % based ion the total weight of the cement component, optionally wherein the geopolymer cement composition has a unit weight (or density) in the range of from 10 ppg to 25 ppg, optionally from 10 ppg to 20 ppg,
introducing the geopolymer cement composition into a subterranean formation; and allowing the geopolymer cement composition to set in the subterranean formation.

The red mud may be present in an amount of from 45 wt % to 90 wt %, such as from 50 wt % to 75 wt % based on the total weight of the cement component, optionally, wherein the red mud is present in an amount of from 55 wt % to 72 wt %, such as from 57 wt % to 71 wt % based on the total weight of the cement component.

The gypsum may be present in an amount of from 5 wt % to 35 wt %, such as from 5 wt % to 30 wt % based on the total weight of the cement component, optionally, wherein the gypsum is present in an amount of from 8 wt % to 28 wt %, such as from 9 wt % to 26 wt % based on the total weight of the cement component.

The cement component may comprises additives. For example, the additives comprise one or more of pozzolan, polymer, dispersant, zeolites, metasilicate and retarder.

The additives may comprise pozzolan. The pozzolan may be present in an amount of from 5 wt % to 50 wt % such as from 10 wt % to 30 wt % based on the total weight of the cement component.

The additives may comprise polymer. The polymer is optionally present in an amount of from 0.2 wt % to 2 wt % based on the total weight of the cement component.

The additives may comprise zeolites. The zeolites may be present in an amount of from 0.1 wt % to 10 wt %, such as from 0.1 wt % to 5 wt % based on the total weight of the cement component.

The additives may comprise dispersant. The dispersant may be present in an amount of from 0.15 to 5 wt % based on the total weight of the cement component.

The additives may comprise retarder. The retarder may be present in an amount of from 0.1 wt % to 30 wt %, such as from 0.1 wt % to 10 wt %, such as from 0.1 wt % to 5 wt % based on the total weight of the cement component.

The water to cement ratio may be in the range of from 0.4 to 0.9, optionally from 0.5 to 0.9, such as from 0.55 to 0.85.

Suitably, the geopolymer cement composition has a unit weight in the range of from 10 ppg to 20 ppg, optionally from 10 ppg to 17 ppg as determined in accordance with ASTM C138.

Suitably, the geopolymer cement composition does not include protein, and/or a foaming agent.

Also disclosed is a method of servicing a subterranean formation having one or more lost circulation zones, comprising:
introducing a lost circulation composition into a lost circulation zone,
the lost circulation composition comprising a cement component and water; and allowing the lost circulation composition to set in the lost circulation zone, wherein the cement component comprises: red mud and gypsum and optionally additives, wherein the additives are present in no more than 50 wt % based on the total weight of the cement component,
wherein the red mud is present in an amount of from 40 wt % to 95 wt % and the gypsum is present in an amount of 5 wt % to 50 wt % based ion the total weight of the cement component, optionally wherein the lost circulation cement composition has a unit weight (or density) in the range of from 10 ppg to 25 ppg, optionally from 10 ppg to 20 ppg, and
allowing the lost circulation composition to set in the lost circulation zone.

The red mud may be present in an amount of from about 50 wt % to 75 wt % based on the total weight of the cement component, optionally, the red mud is present in an amount of from 55 wt % to 72 wt %, such as from 57 wt % to 71 wt % based on the total weight of the cement component.

The gypsum may be present in an amount of from 5 wt % to 30 wt % based on the total weight of the cement component, optionally, wherein gypsum is present in an amount of from 8 wt % to 28 wt %, such as from 9 wt % to 26 wt % based on the total weight of the cement component.

The lost circulation cement composition may have a unit weight in the range of from 10 ppg (1198 kg/m³) to 15 ppg (1797 kg/m³).

The lost circulation composition may have a compressive strength after 24 hours in the range of from 7 MPa to 21 MPa in accordance with ASTM C39, optionally the compressive strength after 24 hours is in the range of from 10 MPa to 20 MPa.

The water to cement ratio may be in the range of from 0.5 to 0.9, such as from 0.55 to 0.85.

The lost circulation composition may have a thickening time at 37.8° C. in the range of from 2.5 hours to 5 hours. The lost circulation composition may have a thickening time at 60° C. in the range of from 1.5 to 4 hours. The lost circulation composition may have a thickening time at 104.4° C. in the range of from 1.5 to 3.5 hours.

The lost circulation composition may have a 10-second static gel strength of at least about 15 lbf/100 ft² (7.18 N/m²) at room temperature, and the lost circulation composition may have a 10 minute static gel strength of at least about 25 lbf/100 ft² (11.97 N/m²) at room temperature.

The lost circulation composition may comprise additives. The additives may comprise one or more of pozzolan, polymer, dispersant, zeolites, metasilicate and retarder.

The additives may comprise pozzolan. The pozzolan may be present in an amount of 1 wt % to 30 wt % based on the total weight of the cement component.

The additives may comprise polymer. The polymer may be present in an amount of from 0.01 wt % to 2 wt %, such as from 0.01 wt % to 1 wt % based on the total weight of the cement component.

The additives may comprise metasilicate. The metasilicate may be present in an amount of from 1 wt % to 12 wt % such as in an amount of from about 1 wt % to 8 wt %, suitably from 1.5 wt % to 6 wt % based on the total weight of the cement component.

The additives may comprise zeolites. The zeolites may be present in an amount of from 0.1 wt % to 10 wt %, such as in an amount of from 0.1 wt % to 5 wt %, optionally, from 0.1 wt % to 1 wt % based on the total weight of the cement component.

The additives may comprise dispersant. The dispersant may be present in an amount of from 0.1 wt % to 5 wt %, such as in an amount of from 0.1 wt % to 1 wt %, optionally from 0.1 wt % to 0.5 wt % based on the total weight of the cement component.

The additives may comprise retarder. The retarder may be present in an amount of from 0.1 wt % to 30 wt %, such as from 1 wt % to 10 wt %, optionally from 1 wt % to 5 wt % based on the total weight of the cement component.

Disclosed is a method for cementing comprising providing a geopolymer cement composition comprising:
a cement component and water,
wherein the cement component comprises red mud and gypsum and optionally additives wherein the additives are present in no more than 50 wt % based on the total weight of the cement component,
wherein the red mud is present in an amount of from 50 wt % to 75 wt % and the gypsum is present in an amount of 5 wt % to 20 wt % based ion the total weight of the cement component, optionally wherein the geopolymer cement composition has a unit weight (or density) in the range of from 10 (1198 kg/m³) ppg to 20 ppg (2396 kg/m³), such as from 10 (1198 kg/m³) ppg to 15.5 ppg (1857 kg/m³)
introducing the geopolymer cement composition into a wellbore annulus in a subterranean formation during a primary cementing operation; and
allowing the geopolymer cement composition to set in the subterranean formation.

The red mud may be present in an amount of from about 52 wt % to 72 wt % based on the total weight of the cement component, optionally, the red mud is present in an amount of from 55 wt % to 72 wt %, such as from 55 wt % to 65 wt % based on the total weight of the cement component.

The gypsum may be present in an amount of from 5 wt % to 30 wt % based on the total weight of the cement component, optionally, the gypsum is present in an amount of from 5 wt % to 25 wt %, such as from 7 wt % to 20 wt % based on the total weight of the cement component.

The geopolymer cement composition may have a unit weight in the range of from 10 ppg (1198 kg/m³) to 15 ppg (1797 kg/m³).

The geopolymer cement composition has a 24 hour compressive strength in the range of from 4 MPa to 24 MPa.

The geopolymer cement composition may have a thickening time at 37.8° C. of from 0.5 hours to 3.5 hours. The geopolymer cement composition may have a thickening time at 60° C. of from 0.8 hours to 3.4 hours. The geopolymer cement composition may have a thickening time at 60° C. of from 0.5 hours to 3.5 hours.

The geopolymer cement composition may comprise additives. The additives may comprise one or more of pozzolan, polymer, dispersant, zeolites, metasilicate and retarder.

The additives may comprise pozzolan. The pozzolan may be present in an amount of 1 wt % to 35 wt % based on the total weight of the cement component, optionally, the pozzolan is present in an amount of from about 10 to 30 wt %, such as from about 15 wt % to 25 wt % based on the total weight of the cement component.

The additives may comprise polymer. The polymer may be present in an amount of from 0.01 wt % to 2 wt %, such as from 0.01 wt % to 1 wt % based on the total weight of the cement component.

The additives may comprise metasilicate. The metasilicate may be present in an amount of from 1 wt % to 12 wt % such as in an amount of from about 1 wt % to 10 wt %, suitably from 2 wt % to 8 wt % based on the total weight of the cement component.

The additives may comprise zeolites. The zeolites may be present in an amount of from 0.1 wt % to 10 wt %, such as in an amount of from about 0.5 wt % to 5 wt %, such as from 1 to 4 wt % based on the total weight of the cement component.

The additives comprise dispersant. The dispersant may be present in an amount of from 0.1 wt % to 5 wt %, such as in an amount of from about 0.1 wt % to 1 wt %, optionally in an amount of from 0.1 wt % to 0.5 wt % based on the total weight of the cement component.

The additives may comprise retarder. The retarder may be present in an amount of from 0.1 wt % to 30 wt %, such as from 1 wt % to 10 wt %, such as from 1 to 5 wt % based on the total weight of the cement component.

The water to cement ratio may be in the range of from 0.5 to 0.9, such as from 0.52 to 0.88, optionally from 0.55 to 0.85.

Further disclosed is a method of plugging a wellbore, comprising providing a geopolymer cement composition comprising:
a cement component and water, wherein the cement component comprises red mud and gypsum and optionally additives wherein the additives are present in no more than 50 wt % based on the total weight of the cement component, wherein the red mud is present in an amount of from 40 wt % to 95 wt % and the gypsum is present in an amount of 5 wt % to 50 wt % based ion the total weight of the cement component, optionally wherein the geopolymer cement composition has a unit weight (or density) in the range of from 10 (1198 kg/m³) ppg to 20 ppg (2396 kg/m³), such as from 10 (1198 kg/m³) ppg to 17 ppg (2037 kg/m³) introducing the geopolymer cement composition into the wellbore; and allowing the geopolymer cement composition to set in the wellbore.

The red mud may be present in an amount of from about 45 wt % to 90 wt % based on the total weight of the cement component, optionally, wherein the red mud is present in an amount of from 48 wt % to 88 wt %, such as from 50 wt % to 85 wt % based on the total weight of the cement component.

The gypsum may be present in an amount of from 10 wt % to 40 wt % based on the total weight of the cement component, optionally, wherein the gypsum is present in an amount of from 15 wt % to 35 wt %, such as from 15 wt % to 30 wt % based on the total weight of the cement component.

The geopolymer cement composition has a 24 hour compressive strength in the range of from 13 MPa to 34 MPa, suitably in the range of from 18 MPa to 30 MPa.

The geopolymer cement composition may have a thickening time at 37.8° C. of from 1 hour to 5 hours. The geopolymer cement composition may have a thickening time at 60° C. of from 0.5 hours to 3 hours.

The cement component may comprises additives. The additives may comprise one or more of pozzolan, polymer, dispersant, zeolites, metasilicate and retarder.

The additives may comprise pozzolan. The pozzolan may be present in an amount of 1 wt % to 35 wt % based on the total weight of the cement component, optionally, the pozzolan is present in an amount of from about 10 to 30 wt %, such as from about 15 wt % to 25 wt % based on the total weight of the cement component.

The additives may comprise polymer. The polymer may be present in an amount of from 0.01 wt % to 2 wt %, such as from 0.01 wt % to 1 wt % based on the total weight of the cement component.

The additives may comprise metasilicate. The metasilicate may be present in an amount of from 1 wt % to 12 wt % such as in an amount of from about 1 wt % to 10 wt %, suitably from 1 wt % to 6 wt % based on the total weight of the cement component.

The additives may comprise zeolites. The zeolites may be present in an amount of from 0.1 wt % to 10 wt %, such as in an amount of from about 0.5 wt % to 5 wt %, such as from 1 to 4 wt % based on the total weight of the cement component.

The additives may comprise dispersant. The dispersant may be present in an amount of from 0.1 wt % to 5 wt %, such as in an amount of from about 0.1 wt % to 0.5 wt % based on the total weight of the cement component.

The additives may comprise retarder. The retarder may be present in an amount of from 0.1 wt % to 30 wt %, such as from 0.1 wt % to 10 wt %, such as from 1 to 5 wt % based on the total weight of the cement component.

The water to cement ratio may be in the range of from 0.3 to 0.7, such as from 0.4 to 0.6.

Also provided is a method for preparing method of preparing a cement composition comprising combining:
(a) red mud; and
(b) gypsum;
to provide a cement composition, wherein the red mud is present in an amount of from 40 wt % to 65 wt % based on the total weight of the cement composition, and wherein the gypsum is present in an amount of from 5 wt % to 25 wt % based on the total weight of the cement composition;
said composition further comprising:
pozzolan in an amount of from 10 to 35 wt % based on the total weight of the cement composition,
metasilicate in an amount of from 2 to 20 wt %, such as from 4 wt % to 18 wt %, from 6 wt % to 16 wt % based on the total weight of the cement composition.

The red mud may be present in an amount of from 45 wt % to 60 wt %, such as from 47 wt % to 58 wt % based on the total weight of the cement composition.

The gypsum may be present in an amount of from 5 wt % to 20 wt %, such as from 5 wt % to 15 wt % based on the total weight of the cement composition.

The pozzolan may be present in an amount of from 15 wt % to 32 wt %, optionally from 20 wt % to 25 wt % based on the total weight of the cement composition.

The pozzolan may be selected from the group comprising carbide slag, granulated ground blast furnace slag, fly ash, attapulgite, kaolin, zeolites, and ground waste glass.

The cement composition may further comprise metasilicate. The metasilicate may optionally be present in an amount of from 2 to 20 wt %, such as from 4 wt % to 18 wt %, from 6 wt % to 16 wt %, optionally from 8 wt % to 12 wt % based on the total weight of the cement composition, optionally, wherein the metasilicate is sodium metasilicate or sodium metasilicate pentahydrate.

The cement composition may further comprise zeolite, optionally in an amount of from 1 to 5 wt % based on the total weight of the cement composition.

The cement composition may further comprise a retarder. Optionally, the retarder is selected from the group consisting of: sodium tetraborate; tartaric acid; boric acid; sodium citric dehydrate and citric acid, further optionally, wherein the retarder is present in an amount of from 1 wt % to 20 wt % of the cement composition.

Also disclosed is a method for forming a cementitious composition comprising a cement composition/component with water, optionally, wherein the water to cement ratio ranges from 0.10 to 0.9, wherein the cement component comprises:
(a) red mud; and
(b) gypsum;
wherein the red mud is present in an amount of from 40 wt % to 65 wt % based on the total weight of the cement component, and wherein the gypsum is present in an amount of from 5 wt % to 25 wt % based on the total weight of the cement component;
said cement component further comprising:
pozzolan in an amount of from 10 to 35 wt % based on the total weight of the cement component,
metasilicate in an amount of from 2 to 20 wt %, such as from 4 wt % to 18 wt %, from 6 wt % to 16 wt % based on the total weight of the cement component.

The red mud may be present in an amount of from 45 wt % to 60 wt %, such as from 47 wt % to 58 wt % based on the total weight of the cement component.

The gypsum may be present in an amount of from 5 wt % to 20 wt %, such as from 5 wt % to 15 wt % based on the total weight of the cement component.

The pozzolan may be present in an amount of from 15 wt % to 32 wt %, optionally from 20 wt % to 25 wt % based on the total weight of the cement component.

The pozzolan may be selected from the group comprising carbide slag, granulated ground blast furnace slag, fly ash, attapulgite, kaolin, zeolites, and ground waste glass.

The cement component may further comprise metasilicate. The metasilicate may optionally be present in an amount of from 2 to 20 wt %, such as from 4 wt % to 18 wt %, from 6 wt % to 16 wt %, optionally from 8 wt % to 12 wt % based on the total weight of the cement component, optionally, wherein the metasilicate is sodium metasilicate or sodium metasilicate pentahydrate.

The cement component may further comprise zeolite, optionally in an amount of from 1 to 5 wt % based on the total weight of the cement component.

The cement component may further comprise a retarder. Optionally, the retarder is selected from the group consisting of: sodium tetraborate; tartaric acid; boric acid; sodium citric dehydrate and citric acid, further optionally, wherein the retarder is present in an amount of from 1 wt % to 20 wt % of the cement component.

The method may further comprise the step of allowing the cementitious composition to set.

Further disclosed is a cementitious composition formed by the method disclosed herein.

In a still further aspect, disclosed herein is a method for forming a concrete composition comprising combining a cement composition/component as disclosed herein with aggregate material and water to form the concrete composition, wherein the cement composition comprises:
(a) red mud; and
(b) gypsum;
wherein the red mud is present in an amount of from 40 wt % to 65 wt % based on the total weight of the cement composition, and wherein the gypsum is present in an amount of from 5 wt % to 25 wt % based on the total weight of the cement composition;
said cement composition further comprising:
pozzolan in an amount of from 10 to 35 wt % based on the total weight of the cement composition, metasilicate in an amount of from 2 to 20 wt %, such as from 4 wt % to 18 wt %, from 6 wt % to 16 wt % based on the total weight of the cement composition.

The cement composition is present in an amount of from 10 to 98 wt % based on the dry weight of the concrete composition, optionally where the cement composition is present in an amount of from 10 wt % to 60 wt %, further optionally, wherein the cement composition is present in an amount of from 15 wt % to 50 wt %, such as from 15 wt % to 40 wt % based on the dry weight of the concrete composition.

The aggregate material may be selected from sand, gravel, crushed stone, iron blast-furnace slag, lightweight filler, mineral aggregate, and any combinations thereof.

The water to cement ratio may be in the range of from 0.1 to 0.9, such as from 0.15 to 0.8, optionally from 0.15 to 0.5, for example from 0.2 to 0.45.

The method may further comprise allowing the concrete composition to set.

The concrete composition may have a 28 day compressive strength of greater than 25 MPa, such as greater than 30 MPa.

The concrete composition may have a 28 day compressive strength in the range of from 25 MPa to 250 MPa, optionally from 25 MPa to 150 MPa, such as from 30 MPa to 100 MPa.

Also disclosed is a concrete composition formed by the method disclosed herein.

Disclosed herein is a cement composition comprising:
red mud and gypsum, wherein the red mud is present in an amount of from 45 wt % to 60 wt % based on the total weight of the cement composition, and wherein the gypsum is present in an amount of from 5 wt % to 20 wt % based on the total weight of the cement composition;
said composition further comprising: pozzolan in an amount of from 10 to 35 wt % based on the total weight of the cement composition, metasilicate in an amount of from 4 to 18 wt % based on the total weight of the cement composition, and zeolite in an amount of from 0.5 wt % to 5 wt % based on the total weight of the cement composition.

Suitably, the composition does not comprise a protein and/or a foaming agent.

Disclosed herein is a method of preparing a cement composition comprising combining:
(a) red mud; and
(b) gypsum;
to provide a cement composition, wherein the red mud is present in an amount of from 20 wt % to 95 wt % based on the total weight of the cement composition, and wherein the gypsum is present in an amount of from 5 wt % to 50 wt % based on the total weight of the cement composition.

The red mud may be present in an amount of from 30 wt % to 95 wt %, optionally from 40 wt % to 95 wt %, such as from 50 wt % to 85 wt % based on the total weight of the cement composition.

The gypsum is present in an amount of from 5 wt % to 25 wt %, optionally from 5 wt % to 20 wt %, such as from 5 wt % to 15 wt % based on the total weight of the cement composition.

The red mud may comprise Fe₂O₃, SiO₂, Al₂O₃, CaO, TiO₂, Na₂O, P₂O₅, and K₂O.

The cement composition may further comprise a pozzolan, optionally in an amount of from 10 to 35 wt %, such as from 15 wt % to 30 wt %, optionally from 20 wt % to 25 wt % based on the total weight of the cement composition.

The pozzolan comprises calcium oxide or calcium hydroxide, and silicon dioxide, wherein the calcium oxide or calcium hydroxide is present in an amount of from 1 to 60 wt % based on the total weight of the pozzolan, and wherein the silicon dioxide is present in an amount of from 5% to 70 wt % based on the total weight of the pozzolan.

The pozzolan may be selected from the group comprising carbide slag, granulated ground blast furnace slag, fly ash, attapulgite, kaolin, zeolites, and ground waste glass.

The cement composition may further comprise metasilicate, optionally in an amount of from 2 to 20 wt %, such as from 4 wt % to 18 wt %, from 6 wt % to 16 wt %, optionally from 8 wt % to 12 wt % based on the total weight of the cement composition.

The metasilicate may be sodium metasilicate or for example sodium metasilicate pentahydrate.

The cement composition may further comprise zeolite, optionally in an amount of from 1 to 5 wt % based on the total weight of the cement composition.

The cement composition may further comprises a retarder. The retarder may be selected from the group consisting of: sodium tetraborate; tartaric acid; boric acid; sodium citric dehydrate and citric acid. The retarder may be present in an amount of from 1 wt % to 20 wt % of the cement composition.

The cement composition formed by the method disclosed herein is also described.

A method for forming a cementitious composition is also disclosed said method comprising the step of combining a cement composition as disclosed herein with water.

The water to cement ratio may range from 0.20 to 0.9.

A cementitious composition formed by the method is also disclosed.

A method for forming a concrete composition comprising combining a cement composition/component, with aggregate material and water to form the concrete composition is also disclosed, wherein the cement composition comprises:
(a) red mud; and
(b) gypsum;
wherein the red mud is present in an amount of from 20 wt % to 95 wt % based on the total weight of the cement composition, and wherein the gypsum is present in an amount of from 5 wt % to 50 wt % based on the total weight of the cement composition.

The cement component may be present in an amount of from 25 to 98 wt % based on the dry weight of the concrete composition.

The aggregate material may be selected from sand, gravel, crushed stone, iron blast-furnace slag, lightweight filler, mineral aggregate, and any combinations thereof.

The aggregate material may be present in an amount of from 1 to 90 wt % based on the dry weight of the concrete composition.

The method may involve the step of allowing the concrete to set.

Also disclosed is a concrete formed by the method disclosed herein.

A still further disclosure herein is a method of fireproofing an object comprising applying a cementitious composition to at least partially coat the object with the cementitious composition thereby forming a fire resistant coating on the object, wherein the cementitious composition comprises a cement component and water, wherein the cement component comprises:
(a) red mud; and
(b) gypsum;
wherein the red mud is present in an amount of from 20 wt % to 95 wt % based on the total weight of the cement component, and wherein the gypsum is present in an amount of from 5 wt % to 50 wt % based on the total weight of the cement component.

The red mud may be present in an amount of from 35 wt % to 60 wt %, such as from 40 wt % to 55 wt % based on the total weight of the cement component.

The gypsum may be present in an amount of from 5 wt % to 20 wt %, such as from 5 wt % to 15 wt % based on the total weight of the cement component.

The cement component may further comprise pozzolan, optionally in an amount of from 10 to 40 wt %, such as from 10 wt % to 35 wt %, optionally, from 15 wt % to 30 wt %, based on the total weight of the cement component.

The pozzolan may comprises calcium oxide or calcium hydroxide, and silicon dioxide, optionally, wherein the calcium oxide or calcium hydroxide is present in an amount of from 1 to 60 wt % based on the total weight of the pozzolan, and wherein the silicon dioxide is present in an amount of from 5% to 70 wt % based on the total weight of the pozzolan.

The pozzolan may be selected from the group comprising carbide slag, granulated ground blast furnace slag, fly ash, attapulgite, kaolin, zeolites, and ground waste glass.

The cement component may further comprise metasilicate, optionally in an amount of from 2 to 20 wt %, such as from 4 wt % to 18 wt %, from 6 wt % to 16 wt %, optionally from 8 wt % to 12 wt % based on the total weight of the cement component.

The metasilicate may be sodium metasilicate and/or sodium metasilicate pentahydrate.

The cement component may further comprise zeolite, optionally in an amount of from 1 to 5 wt %, such as from 1.5 to 4 wt % based on the total weight of the cement component.

The cement component may further comprise a retarder, optionally, wherein the retarder is selected from the group consisting of: sodium tetraborate; tartaric acid; boric acid; sodium citric dehydrate and citric acid, further optionally, wherein the retarder is present in an amount of from 1 wt % to 20 wt % such as in an amount of from 1 wt % to 5 wt % based on the total weight of the cement component.

Also disclosed is a method of fireproofing an object comprising applying a concrete composition to at least partially coat the object with the concrete composition thereby forming a fire resistant coating on the object, wherein the concrete composition comprises a cement component, aggregate and water, wherein the cement component comprises:
(a) red mud; and
(b) gypsum;
wherein the red mud is present in an amount of from 20 wt % to 95 wt % based on the total weight of the cement composition, and wherein the gypsum is present in an amount of from 5 wt % to 50 wt % based on the total weight of the cement composition.

The red mud may be present in an amount of from 35 wt % to 60 wt %, such as from 40 wt % to 55 wt % based on the total weight of the cement component.

The gypsum may be present in an amount of from 5 wt % to 20 wt %, such as from 5 wt % to 15 wt % based on the total weight of the cement component.

The cement component may further comprise pozzolan, optionally in an amount of from 10 to 40 wt %, such as from 10 wt % to 35 wt %, optionally, from 15 wt % to 30 wt %, based on the total weight of the cement component.

The pozzolan may comprises calcium oxide or calcium hydroxide, and silicon dioxide, optionally, wherein the calcium oxide or calcium hydroxide is present in an amount of from 1 to 60 wt % based on the total weight of the pozzolan, and wherein the silicon dioxide is present in an amount of from 5% to 70 wt % based on the total weight of the pozzolan.

The pozzolan may be selected from the group comprising carbide slag, granulated ground blast furnace slag, fly ash, attapulgite, kaolin, zeolites, and ground waste glass.

The cement component may further comprise metasilicate, optionally in an amount of from 2 to 20 wt %, such as from 4 wt % to 18 wt %, from 6 wt % to 16 wt %, optionally from 8 wt % to 12 wt % based on the total weight of the cement component.

The metasilicate may be sodium metasilicate and/or sodium metasilicate pentahydrate.

The cement component may further comprise zeolite, optionally in an amount of from 1 to 5 wt %, such as from 1.5 to 4 wt % based on the total weight of the cement component.

The cement component may further comprise a retarder, optionally, wherein the retarder is selected from the group consisting of: sodium tetraborate; tartaric acid; boric acid; sodium citric dehydrate and citric acid, further optionally, wherein the retarder is present in an amount of from 1 wt % to 20 wt % such as in an amount of from 1 wt % to 5 wt % based on the total weight of the cement component.

The cement component may be present in an amount of from 25 to 98 wt %, such as from about 25 wt % to 95 wt %, optionally from 30 to 70 wt % based on the dry weight of the concrete composition.

The aggregate material may be selected from sand, gravel, crushed stone, iron blast-furnace slag, lightweight filler, mineral aggregate, and any combinations thereof.

Suitably, the aggregate material is lightweight filler or sand.

Suitably, the concrete has a 28 day compressive strength of at least 30 MPa, optionally, wherein the 28 day compressive strength is in the range of from 30 MPa to 100 MPa, such as from 30 MPa to 60 MPa.

Suitably, the concrete has a thermal conductivity in the range of from 0.1 to 0.8 W/(m·K), optionally, from 0.2 to 0.7 W/(m·K).

### DETAILED DESCRIPTION

The present invention relates to a method of preparing cement compositions, and such cement compositions per se. The present invention relates to preparing cementitious compositions, and such cementitious compositions per se. The present invention further relates to a method of preparing concrete compositions, and to such concrete compositions per se. The cement compositions, cementitious compositions and concrete compositions may be prepared according to the methods disclosed herein. More particularly, the present application relates to the use of the cementitious compositions and the concrete compositions in various applications, such as construction. The compositions can be used as quick set and low to high strength concrete materials.

The compositions disclosed herein are formed using red mud. Red mud is a by-product of the Bayer process which is used for the producing aluminium from alumina. Aluminium/Aluminum is a critical metal used globally and a constituent in many different products and materials. The need for aluminium increases every year with a corresponding increase in population and industry. Alumina is the base ingredient in aluminum and the most common method of production is the Bayer Process. During the Bayer Process, bauxite mineral which contains an abundance of alumina is dried and ground. The dried and ground bauxite is then subjected to a strong sodium hydroxide solution and heat, then, combined with the addition of alumina hydroxide, pressure is applied which digests the alumina. The alumina is extracted and the remaining waste material is commonly referred to as “Red Mud” or “Bauxite Residue”. Red Mud is abundant in high pH sodium, ferrous oxide, alumina, calcium, and silicon dioxide (i.e. silica).

The Bayer process leaves a sodium hydroxide rich waste. The sodium hydroxide rich waste is deposited in large impoundments where the silicon dioxide concentrations in the bauxite are digested into the sodium hydroxide, leaving a variable molar concentration and combination of sodium silicate and sodium hydroxide, along with other associated metal materials.

The present invention relates to methods of preparing cement compositions, cementitious compositions and concrete compositions comprising red mud. The compositions disclosed herein provide a more environmentally friendly alternative to Ordinary Portland Cement compositions, as they are manufactured using a waste product of the Bayer Process, namely red mud. Thus, the compositions provided herein provide an alternative to OPC cement compositions, with a reduced carbon footprint. The methods of the present invention utilise red mud, a waste material from the Bayer Process. Hence, the products and methods presented herein repurposes waste from the Bayer process, by providing an efficient use for red mud.

In one aspect, the invention relates to a method of preparing a cement composition comprising combining:
(a) from about 20 to about 95% by weight of red mud; and
(b) from about 5 to about 50% by weight of gypsum;
to provide a cement composition.

This method gives rise to a dry cement material, which can be used in a variety of applications.

Disclosed is a method of cementing comprising:
providing a geopolymer cement composition comprising:
a cement component and water,
wherein the cement component comprises red mud and gypsum and optionally additives wherein the additives are present in no more than 50 wt % based on the total weight of the cement component,
wherein the red mud is present in an amount of from 40 wt % to 95 wt % and the gypsum is present in an amount of 5 wt % to 50 wt % based ion the total weight of the cement component, optionally wherein the geopolymer cement composition has a unit weight (or density) in the range of from 10 (1198 kg/m³) ppg to 25 ppg, optionally from 10 ppg (1198 kg/m³) to 20 ppg (2396 kg/m³),
introducing the geopolymer cement composition into a subterranean formation; and allowing the geopolymer cement composition to set in the subterranean formation.

Also disclosed is a method of servicing a subterranean formation having one or more lost circulation zones, comprising:
introducing a lost circulation composition into a lost circulation zone,
the lost circulation composition comprising a cement component and water; and allowing the lost circulation composition to set in the lost circulation zone, wherein the cement component comprises: red mud and gypsum and optionally additives, wherein the additives are present in no more than 50 wt % based on the total weight of the cement component,
wherein the red mud is present in an amount of from 40 wt % to 95 wt % and the gypsum is present in an amount of 5 wt % to 50 wt % based ion the total weight of the cement component, optionally wherein the lost circulation cement composition has a unit weight (or density) in the range of from 10 ppg to 25 ppg, optionally from 10 ppg to 20 ppg, and allowing the lost circulation composition to set in the lost circulation zone.

Also disclosed is a method for cementing comprising providing a geopolymer cement composition comprising:
a cement component and water,
wherein the cement component comprises red mud and gypsum and optionally additives wherein the additives are present in no more than 50 wt % based on the total weight of the cement component,
wherein the red mud is present in an amount of from 50 wt % to 75 wt % and the gypsum is present in an amount of 5 wt % to 20 wt % based ion the total weight of the cement component, optionally wherein the geopolymer cement composition has a unit weight (or density) in the range of from 10 ppg to 20 ppg, such as from 10 ppg to 15.5 ppg,
introducing the geopolymer cement composition into a wellbore annulus in a subterranean formation during a primary cementing operation; and allowing the geopolymer cement composition to set in the subterranean formation.

A still further aspect of the present disclosure is a method of plugging a wellbore, comprising providing a geopolymer cement composition comprising:
a cement component and water,
wherein the cement component comprises red mud and gypsum and optionally additives wherein the additives are present in no more than 50 wt % based on the total weight of the cement component,
wherein the red mud is present in an amount of from 40 wt % to 95 wt % and the gypsum is present in an amount of 5 wt % to 50 wt % based ion the total weight of the cement component, optionally wherein the geopolymer cement composition has a unit weight (or density) in the range of from 10 ppg to 20 ppg, such as from 10 ppg to 17 ppg;
introducing the geopolymer cement composition into the wellbore; and allowing the geopolymer cement composition to set in the wellbore.

A still further aspect of the disclosure is a method for preparing method of preparing a cement composition comprising combining:
(a) red mud; and
(b) gypsum;
to provide a cement composition, wherein the red mud is present in an amount of from 40 wt % to 65 wt % based on the total weight of the cement composition, and wherein the gypsum is present in an amount of from 5 wt % to 25 wt % based on the total weight of the cement composition;
said composition further comprising:
pozzolan in an amount of from 10 to 35 wt % based on the total weight of the cement composition,
metasilicate in an amount of from 2 to 20 wt %, such as from 4 wt % to 18 wt %, from 6 wt % to 16 wt % based on the total weight of the cement composition.

A yet further aspect of the disclosure is a method of forming a cementitious composition comprising a cement composition with water, optionally, wherein the water to cement ratio ranges from 0.10 to 0.9, wherein the cement composition comprises:
(a) red mud; and
(b) gypsum;
wherein the red mud is present in an amount of from 40 wt % to 65 wt % based on the total weight of the cement composition, and wherein the gypsum is present in an amount of from 5 wt % to 25 wt % based on the total weight of the cement composition;
said cement composition further comprising:
pozzolan in an amount of from 10 to 35 wt % based on the total weight of the cement composition,
metasilicate in an amount of from 2 to 20 wt %, such as from 4 wt % to 18 wt %, from 6 wt % to 16 wt % based on the total weight of the cement composition.

Also disclosed is a method of forming a concrete composition comprising combining a cement composition with aggregate material and water to form the concrete composition, wherein the cement composition comprises:
(a) red mud; and
(b) gypsum;
wherein the red mud is present in an amount of from 40 wt % to 65 wt % based on the total weight of the cement composition, and wherein the gypsum is present in an amount of from 5 wt % to 25 wt % based on the total weight of the cement composition;
said cement composition further comprising:
pozzolan in an amount of from 10 to 35 wt % based on the total weight of the cement composition,
metasilicate in an amount of from 2 to 20 wt %, such as from 4 wt % to 18 wt %, from 6 wt % to 16 wt % based on the total weight of the cement composition.

A further aspect of the disclosure is a cement composition comprising: red mud and gypsum, wherein the red mud is present in an amount of from 45 wt % to 60 wt % based on the total weight of the cement composition, and wherein the gypsum is present in an amount of from 5 wt % to 20 wt % based on the total weight of the cement composition;
said composition further comprising:
pozzolan in an amount of from 10 to 35 wt % based on the total weight of the cement composition, metasilicate in an amount of from 4 to 18 wt % based on the total weight of the cement composition, and zeolite in an amount of from 0.5 wt % to 5 wt % based on the total weight of the cement composition.

A still further aspect of the disclosure is a method of forming a concrete composition comprising combining a cement composition with aggregate material and water to form the concrete composition, wherein the cement composition comprises:
(a) red mud; and
(b) gypsum;
wherein the red mud is present in an amount of from 40 wt % to 65 wt % based on the total weight of the cement composition, and wherein the gypsum is present in an amount of from 5 wt % to 25 wt % based on the total weight of the cement composition;
said cement composition further comprising:
pozzolan in an amount of from 10 to 35 wt % based on the total weight of the cement composition,
metasilicate in an amount of from 2 to 20 wt %, such as from 4 wt % to 18 wt %, from 6 wt % to 16 wt % based on the total weight of the cement composition.

A yet further aspect of the disclosure is a cement composition comprising:
red mud and gypsum, wherein the red mud is present in an amount of from 45 wt % to 60 wt % based on the total weight of the cement composition, and wherein the gypsum is present in an amount of from 5 wt % to 20 wt % based on the total weight of the cement composition;
said composition further comprising:
pozzolan in an amount of from 10 to 35 wt % based on the total weight of the cement composition, metasilicate in an amount of from 4 to 18 wt % based on the total weight of the cement composition, and zeolite in an amount of from 0.5 wt % to 5 wt % based on the total weight of the cement composition.

An even further aspect of the disclosure is a method of preparing a cement composition comprising combining:
(a) red mud; and
(b) gypsum;
to provide a cement composition, wherein the red mud is present in an amount of from 20 wt % to 95 wt % based on the total weight of the cement composition, and wherein the gypsum is present in an amount of from 5 wt % to 50 wt % based on the total weight of the cement composition.

An even further aspect of the disclosure is a method for forming a concrete composition comprising combining a cement composition/component, with aggregate material and water to form the concrete composition, wherein the cement composition comprises:
(a) red mud; and
(b) gypsum;
wherein the red mud is present in an amount of from 20 wt % to 95 wt % based on the total weight of the cement composition, and wherein the gypsum is present in an amount of from 5 wt % to 50 wt % based on the total weight of the cement composition.

Another aspect of the disclosure is a method of fireproofing an object comprising applying a cementitious composition to at least partially coat the object with the cementitious composition thereby forming a fire resistant coating on the object, wherein the cementitious composition comprises a cement component and water, wherein the cement component comprises:
(a) red mud; and
(b) gypsum;
wherein the red mud is present in an amount of from 20 wt % to 95 wt % based on the total weight of the cement composition, and wherein the gypsum is present in an amount of from 5 wt % to 50 wt % based on the total weight of the cement composition.

A still further aspect of the disclosure is a method of fireproofing an object comprising applying a concrete composition to at least partially coat the object with the concrete composition thereby forming a fire resistant coating on the object, wherein the concrete composition comprises a cement component, aggregate and water, wherein the cement component comprises:
(a) red mud; and
(b) gypsum;
wherein the red mud is present in an amount of from 20 wt % to 95 wt % based on the total weight of the cement composition, and wherein the gypsum is present in an amount of from 5 wt % to 50 wt % based on the total weight of the cement composition.

In each of the aspects and embodiments disclosed herein the compositions suitably may not comprise a protein or a foaming agent.

In each of the aspects and embodiments disclosed herein the red mud can comprise components selected from the list comprising: Fe₂O₃, SiO₂, Al₂O₃, CaO, TiO₂, Na₂O, P₂O₅, and K₂O.

Some variations in the chemical composition of Red mud can occur. These variations consist primarily of the calcium and silica-dioxide concentrations. The variations occur as a result of the type and quality of Bauxite utilized in the production of alumina. Some alumina extraction techniques include the addition of calcium hydroxide in the process, along with other minor variations in the alumina production process. Fortunately, the resulting waste material at each facility is very consistent as the alumina production process rarely changes during the course of an alumina production plant.

While minor variations exist in the chemistry of Red Mud worldwide, the amount of each component present can vary between “standard” and “non-standard” Red Mud.

The red mud may comprise 50-60 wt % Fe₂O₃, 3-15 wt % SiO₂, 11-22 wt % Al₂O₃, 3-15 wt % CaO, 1-7 wt % TiO₂, 1-12 wt % Na₂O, 0.25-5 wt % P₂O₅, and 1-7 wt % K₂O based on the total weight of the red mud. This is typical of “standard” red mud, where iron (III) oxide and alumina (i.e. Al₂O₃) may constitute major components.

The red mud may comprise 5-10 wt % Fe₂O₃, 8-23 wt % SiO₂, 15-30 wt % Al₂O₃, 10-21 wt % CaO, 1-7 wt % TiO₂, 3-15 wt % Na₂O, 0.25-5 wt % P₂O₅, and 0.1-2 wt % K₂O based on the total weight of the red mud. This is typical of “non-standard” red mud, where silica (i.e. SiO₂), alumina (Al₂O₃) and quicklime (CaO) and may constitute major components.

The red mud used here is dried red mud i.e. red mud having a liquid content (for example, a moisture or water content) of from 0 to about 5 wt %, suitably, having a liquid content of 0 to about 3 wt % based on the total weight of the red mud. For example, the red mud may have a liquid content of from 0 to about 5 wt %, suitably from 0 to about 3 wt %.

Red Mud is sometimes referred to as “Brown Mud”. Brown Mud is a waste material like Red Mud from the Bayer Process, but Brown Mud is a waste from a secondary extraction of alumina from Red Mud; Brown Mud has a reduced alumina content and a very high pH when hydrated. Brown mud can also be used in the present invention in addition to or as a replacement for red mud.

Red Mud cement mixtures known in the art are prepared via methods which force and/or enhance covalent bonding of metals. Known hydraulic (water-activated) methods for preparing cementitious compositions develop covalent bonds in long-chain inorganic molecular structures through the addition of proteins, or via dissociation of metal molecules caused by sodium hydroxide or other strong bases. The addition of proteins can give rise to the formation of a covalent bond between silicates and hydroxides. The dissociation of metal molecules separates oxygen and metal ions, such that they are able to share electrons with other molecules during water mixing (as a result of exposure to hydrogen and oxygen) and form covalent bonds.

The Bayer Process is used to extract aluminum (oxy) hydroxides from bauxites and get alumina which can be smelted to furnish aluminium. There are four main steps in the Bayer Process: digestion, clarification, precipitation and calcination. In the first step, bauxite is physically processed by grinding, and then treated with concentrated sodium hydroxide solution. The resulting slurry is pumped into large digestion tanks where the slurry is exposed to pressure and heat. The sodium hydroxide reacts with the aluminium containing minerals of bauxite to form a concentrated solution of sodium aluminate and insoluble materials called red mud which are separated in the clarification step. Red mud is a mixture of compounds derived from bauxite and of compounds formed or introduced during the Bayer process. It is disposed of from the Bayer Process as a slurry having a solid concentration in the range of from 10 to 30 wt % and a pH of about 13. Red mud contains silica, aluminium, iron, calcium, titanium as well a plethora of minor constituents such as sodium, potassium, chromium, vanadium, nickel, barium, copper, manganese, lead, zinc etc. The red mud used in the present disclosure is dried red mud, having a liquid content (e.g. a moisture or water content) of typically less than 5 wt %, preferably less than 3 wt %, suitably, from 0 to 3 wt %.

Liquid hydroxide (alkali-activated) methods for preparing geopolymer cement are also known in the art, and use liquid sodium hydroxide and liquid silicates. Examples of such methods known in the art are those disclosed in CN107352928A and CN116283351B. In alkali-activated methodologies, the development of covalent bonds in long-chain molecular structures occurs through a dissociation of metal molecules caused by sodium or other elevated pH hydroxides. This is a carbon intensive process. The methods and compositions described herein do not require liquid activators, proteins, or volume stability mechanisms, which are required by methodologies known in the art. The methods described herein therefore require fewer components, such as dried red mud and gypsum only to provide a cement composition, or dried red mud, gypsum and water only to provide a cementitious composition, or dried red mud, gypsum, aggregate and water to form a concrete composition.

Advantageously, the methods and compositions disclosed herein do not require the addition of protein, or additional basic materials. When combined with water, the red mud cement composition disclosed herein is sufficiently basic that the addition of further base is not required to activate reactions leading to covalent bond formation between silica materials and metals. Further, the compositions disclosed herein suitably do not contain a foaming agent.

In each of the aspects and embodiments disclosed herein references to strength refer to compressive strength.

Components have their normal meaning which are known to the person skilled in the art.

For the avoidance of doubt in each of the aspects and embodiments disclosed herein:
Pozzolan: Any suitable pozzolan may be used. For example, pozzolan may comprise calcium oxide or calcium hydroxide, and silicon dioxide, and optionally, the calcium oxide or calcium hydroxide is present in an amount of from 1 to 60 wt % based on the total weight of the pozzolan, and wherein the silicon dioxide is present in an amount of from 5% to 70 wt % based on the total weight of the pozzolan.
Pozzolan: may be selected from the group comprising carbide slag, granulated ground blast furnace slag, fly ash, attapulgite, kaolin, zeolites, and ground waste glass.
Metasilicate: may for example be sodium metasilicate or a hydrate thereof, such as sodium metasilicate pentahydrate
Retarder: any suitable retarder may be used. For example, the retarder may be selected from the group consisting of sodium tetraborate; tartaric acid; boric acid; sodium citric dehydrate and citric acid.
Aggregate: any suitable aggregate may be used. For example, the aggregate material may be selected from sand, gravel, crushed stone, iron blast-furnace slag, lightweight filler, mineral aggregate, and any combinations thereof.
Water: any suitable water may be used. The water may be fresh water or salt water, e.g., an unsaturated aqueous salt solution or a saturated aqueous salt solution such as brine or seawater.

The concretes disclosed herein may be suitably reinforced, for example with fibers, steel, rebar etc. The person skilled in the art will understand what materials may be used.

Disclosed herein is a method for preparing a cement composition comprising combining:
(a) red mud; and
(b) gypsum;
to provide a cement composition, wherein the red mud is present in an amount of from about 20 wt % to about 95 wt % based on the total weight of the cement composition, and wherein the gypsum is present in an amount of from about 5 wt % to about 50 wt % based on the total weight of the cement composition.

The red mud may be present in an amount of from about 25 to about 95 wt %, such as from about 30 to about 90 wt % based on the total weight of the cement composition, optionally, from about 35 to about 85 wt %, such as from about 40 wt % to about 80 wt % based on the total weight of the cement composition, for example about 45 to about 75 wt % based on the total weight of the cement composition. For example, the red mud composition may be present in an amount of from about 50 to about 95 wt %, such as from about 60 to about 95 wt % based on the total weight of the cement composition. Alternatively, the red mud may be present in an amount of from about 25 to about 55 wt %, such as about 25 to about 50 wt %, for example from about 25 wt % to about 45 wt % based on the total weight of the cement composition. Alternatively, the red mud may be present in an amount of from about 35 to about 55 wt % based on the total weight of the cement composition.

The gypsum is present in an amount of from about 5 wt % to about 50 wt % based on the total weight of the cement composition, such as from about 10 to about 45 wt %, optionally from about 15 wt % to about 40 wt %. For example, the gypsum may be present in an amount of from about 5 to about 45 wt %, optionally from about 5 to about 40 wt %, such as from about 5 to about 35 wt %, such as from about 5 to about 25 wt %, for example from about 5 to about 15 wt % based on the total weight of the cement composition.

Optionally, the red mud may be present in an amount of from about 60 to about 95 wt % based on the total weight of the cement composition and the gypsum is present in an amount of from about 5 to about 40 wt % based on the total weight of the cement composition. Advantageously, when the red mud is present in an amount of from about 60 to about 95 wt % based on the total weight of the cement composition and the gypsum is present in an amount of from about 5 to about 40 wt % based on the total weight of the cement composition, the cement composition is particularly well suited for forming quick set concrete, for example quick set low strength concrete (with and without aggregate), and quick set well cement.

Optionally, the red mud is present in an amount of from about 25 to about 45 wt % based on the total weight of the cement composition and the gypsum is present in an amount of from about 5 to about 45 wt % based on the total weight of the cement composition. Advantageously, when the red mud is present in an amount of from about 25 to about 45 wt % based on the total weight of the cement composition and the gypsum is present in an amount of from about 5 to about 45 wt % based on the total weight of the cement composition, the cement composition is particularly useful for forming quick set self-levelling concrete.

Optionally, the red mud is present in an amount of from about 35 to about 55 wt % based on the total weight of the cement composition and the gypsum is present in an amount of from about 5 to about 15 wt % based on the total weight of the cement composition. Advantageously, when the red mud is present in an amount of from about 35 to about 55 wt % based on the total weight of the cement composition and the gypsum is present in an amount of from about 5 to about 15 wt % based on the total weight of the cement composition, the cement composition is particularly well suited for forming fire proofing concrete, or for soil stabilization and/or for backfilling fence posts.

Suitably, the red mud comprises Fe₂O₃, SiO₂, Al₂O₃, CaO, TiO₂, Na₂O, P₂O₅, and K₂O.

Optionally, the cement composition further comprises a pozzolan.

Optionally, the pozzolan may be present in an amount of from about 10 to about 35 wt % based on the total weight of the cement composition, such as in an amount of from about 15 to about 30 wt % based on the total weight of the cement composition. Suitably, the cement composition may comprise a pozzolan in an amount of from about 20 to about 25 wt % based on the total weight of the cement composition.

Suitably, the pozzolan comprises calcium oxide or calcium hydroxide and silicon dioxide. The calcium oxide or calcium hydroxide may be present (in the pozzolan) in an amount of from about 1 to about 60 wt % based on the total weight of the pozzolan. The silicon dioxide may be present (in the pozzolan) in an amount of from about 5% to about 70 wt % based on the total weight of the pozzolan. Suitably, the calcium oxide or calcium hydroxide is present in an amount of from about 1 to about 60 wt % based on the total weight of the pozzolan and the silicon dioxide is present in an amount of from about 5 to about 70 wt % based on the total weight of the pozzolan.

Suitably, the pozzolan is selected from the group comprising carbide slag, granulated ground blast furnace slag, fly ash, and ground waste glass.

Pozzolans are broadly defined as any material that when combined with Calcium Hydroxide produces a cemented condition. Most pozzolans achieve this by containing an abundance of silicon dioxide, but other materials like alumina, calcium, ferrous oxide, and other metallic molecules exist in pozzolans that control the quality and strength of the cemented condition. The quantification of the capacity of a pozzolan to react with calcium hydroxide and water is given by measuring its pozzolanic activity. Pozzolans are used to reduce the quantity of OPC required in concrete and cementitious mixtures. Cementitious mixtures made from blends of OPC with pozzolans have reduced environmental cost, as less OPC is required, thereby fewer greenhouse gasses are emitted in the production of such blends. Furthermore the addition of pozzolans enables modulation of physical properties, for example, cured/hardened concrete formed using pozzolans has higher compressive strength, and enhanced durability due to the pozzolanic reaction in which calcium hydroxide is consumed to produce additional calcium silicate hydrate and calcium aluminate hydrate reaction products. These pozzolanic reaction products fill in pores and result in a refining of the pore size distribution.

Standard granulated ground blast furnace slag may be used as a pozzolan. The blast furnace slag comprises 0-10 wt % Fe₂O₃, 25-40 wt % SiO₂, 8-25 wt % Al₂O₃, 30-60 wt % CaO, and 1-18% MgO.

Standard Class C Fly Ash may be used as a pozzolan. The fly ash may comprise 1-15 wt % Fe₂O₃, 25-50 wt % SiO₂, 10-35 wt % Al₂O₃, 30-60 wt % CaO, and 0.1-8 wt % MgO.

Standard Class F Fly Ash may be used as a pozzolan. The fly ash may comprise 1-15 wt % Fe₂O₃, 30-70 wt % SiO₂, 8-30 wt % Al₂O₃, 0.1-15 wt % CaO, and 0.1-8 wt % MgO.

Gypsum is calcium sulfate. The calcium sulfate can have the chemical formula CaSO₄ or CaSO₄·2H₂O.

Gypsum (CaSO4·2H₂O) is a moisture and chemical sensitive material. When combined with red mud in the presence of water as described herein, silicon dioxide molecules are attached to sulfates through covalent bonding which results in concrete having amorphous/glassy regions and removes the moisture and chemical sensitivity of the cured material. By adjusting the amount of red mud and gypsum present (and their ratio) is important to ensure adequate amounts of silica dioxide/oxygen ions are present to capture sulfate molecules and the oxygen ions therein through covalent bonding. Advantageously, the present inventors have identified cement compositions comprising optimal ratios of red mud and gypsum for various applications. This ensures that for a particular application adequate amounts of silica dioxide/oxygen ions are present to capture sulfate containing molecules through covalent bonding. When elevated compressive or tensile strength is necessary and when balancing constituents is prudent, sodium metasilicate or high calcium pozzolans may be added.

Calcium sulfate can act as a Pozzolanic Activator in the methods described herein.

Calcium sulfate can act as a rheology enhancer in the methods described herein.

It is known to use alkaline materials, such as calcium hydroxide to enhance the reactivity of pozzolanic materials. In methodologies known in the art (such as water-activated and alkali-activated methods of preparing cement), sulfates are utilized as a volume stability enhancer, and are typically included at concentrations up to 2 wt % in cement compositions, including in red mud cement compositions. Further, sulfates are not utilized as an activator, or as a rheology enhancer to reduce the sticky characteristic of geopolymers, as used in the methods described herein. All geopolymers include a sticky rheology as a result of elevated silica-dioxide concentrations, which are in a liquid state. The elevated gypsum content utilized in the methods and compositions of this invention reduces the sticky liquid phase rheology due to the partially soluble nature of gypsum that dilutes the silica-dioxide sticky characteristic.

In known methodologies, volume stability, strength, and set time are controlled by the quantity and molar concentration of activator materials, as well as by balancing calcium, alumina, ferrous oxide, and sodium or potassium silicate amounts, and additionally adding internal expansion materials such as oxides and sulfates.

Known methodologies use small concentrations of sulfates to achieve volume stability, whereas the present invention as described herein utilizes much larger concentrations of sulfates to achieve strength/activation and rheological enhancements. When sulfates (for example, gypsum) are added to Red Mud, the sulfate (such as calcium sulfate) activates the pozzolan components in red mud i.e. the calcium, silicon and aluminium containing complexes of red mud, and creates a cementitious material. This can be achieved without adding sodium metasilicate or liquid activators.

Furthermore, the volume stability of cured/hardened cementitious and concrete compositions disclosed herein is enhanced as a result of the molecular disassociation occurring from the Bayer Process on metal molecules The Bayer Process forces molecular disassociation of metal molecules and produces covalent bonds after water mixing and during concrete curing. Reformation of molecules occurs during mixing with water, without the need for inclusion of shrinkage control devices or expansion inducing materials. The methods described herein therefore require fewer components to provide a cementitious composition or a concrete composition.

The present invention as described herein therefore removes the need for shrinkage control devices, metasilicate or metasilicate pentahydrate, proteins, and all liquid activators including silicates and hydroxides which are required in methods known in the art.

The method may further comprise adding from about 2 to 20% by weight of metasilicate. Although the method of present invention does not require the addition of metasilicate, metasilicate may additionally be added. The metasilicate can be added out of convenience or for cost effectiveness or sustainability purposes. More specifically, metasilicate can be added where additions of gypsum, pozzolans, or other constituents are economically less feasible than adding metasilicate. Further, the carbon footprint of various materials can be considered and the mixture of components used can be balanced with regard to production and logistical carbon intensity. Metasilicate may be added where it is more sustainable to do so.

The metasilicate can be metasilicate pentahydrate, such as sodium metasilicate pentahydrate.

The metasilicate can be sodium metasilicate. Optionally the metasilicate is present in an amount of from about 2 to about 20 wt % based on the total weight of the cement composition, such as in an amount of from about 4 to about 18 wt %, optionally, from about 6 to about 16 wt %, such as from about 8 to about 12 wt % based on the total weight of the cement composition.

The present inventors have recognized that the metallic molecules in red mud disassociate to variable degrees during the Bayer Process, due to the addition of a corrosive liquid containing sodium hydroxide in the Bayer Process. The waste product of the Bayer Process (Red Mud) contains sodium silicate (which has a chemical formula of Na₂OSiO₂). The concentration of Na₂OSiO₂ in red mud can vary from about 5% to about 25% wt %, dependent upon the source of bauxite used in the Bayer Process. By utilizing the sodium silicate inherent to red mud, the present invention negates the requirement for the addition of sodium metasilicate (Na₂OSiO₃). Prior art metasilicate additions varied from between about 5 to about 45 wt %. Sodium metasilicate is therefore not required by the method of the present invention, but may still be added.

The cement composition may further comprise a retarder. The retarder may be selected from the group comprising: sodium tetraborate; tartaric acid; boric acid; sodium citric dehydrate and citric acid.

Suitably, the retarder is present in an amount of from about 1 to about 20 wt % based on the total weight of the cement composition, more suitably in an amount of from about 1 to about 15 wt %, such as in an amount of from about 4 to about 12 wt % based on the total weight of the cement composition, for example in an amount of from about 5 to about 10 wt % based on the total weight of the cement composition. For example, the retarder may be present in an amount of from about 1 to about 10 wt % based on the total weight of the cement composition, or from about 4 to about 10 wt %, optionally from about 5 to about 10 wt % based on the total weight of the cement composition.

The cement composition may further comprise zeolite. Optionally, the cement composition further comprises zeolite in an amount of from about 1 to about 5 wt % based on the total weight of the cement composition.

The cement composition may further comprise a rheology modifier and/or a permeability adjuster. For example, the cement composition may further comprise a rheology modifier and permeability adjusting polymer or copolymer.

Suitably, the rheology and permeability adjusting polymer or copolymer is selected from latex, vinyl acetate and polyvinyl alcohol.

Optionally, the cement composition may comprise:
(a) from about 60 to about 95% by weight of red mud; and
(b) from about 5 to about 40% by weight of gypsum.

Suitably, such cement compositions are particularly useful for quick set low strength concrete.

Optionally, the cement composition may comprise:
(a) from about 20 to about 55% by weight of dried red mud; and
(b) from about 5 to about 15% by weight of gypsum;
(c) from about 10 to about 35% by weight of pozzolan; and
(d) from about 2 to about 20% by weight of metasilicate.

Suitably, such cement compositions are particularly useful for quick set self-levelling concrete.

Optionally, the cement composition may comprise:
(a) from about 35 to about 55% by weight of dried red mud; and
(b) from about 5 to about 15% by weight of gypsum;
(c) from about 15 to about 35% by weight of pozzolan;
(d) from about 5 to about 15% by weight of metasilicate; and
(e) from about 1 to about 5% by weight of retarder.

Suitably, such cement compositions are particularly useful for fire-proofing applications, or for soil stabilization or for backfilling fence posts. For example, such compositions may be used to form cementitious compositions or concrete compositions that can be at least partially coated on an object, thereby applying a fire resistant layer to the object.

Optionally, the cement composition may comprise:
(a) from about 20 to about 55% by weight of red mud; and
(b) from about 5 to about 15% by weight of gypsum;
(c) from about 10 to about 35% by weight of pozzolan;
(d) from about 2 to about 20% by weight of metasilicate;
(e) from about 1 to about 5% by weight of retarder;
(f) from about 1 to about 5% by weight of zeolite; and
(g) optionally from about 0.1 to about 5% by weight of a rheology and permeability adjusting polymer or copolymer.

Optionally, the cement composition may comprise:
(a) from about 20 to about 55% by weight of red mud; and
(b) from about 5 to about 15% by weight of gypsum;
(c) from about 10 to about 35% by weight of pozzolan;
(d) from about 2 to about 20% by weight of metasilicate; and
(e) from about 1 to about 5% by weight of retarder.

For example, the cement composition may comprise:
(a) from about 20 to about 55% by weight of dried red mud; and
(b) from about 5 to about 15% by weight of gypsum;
(c) from about 10 to about 35% by weight of pozzolan;
(d) from about 2 to about 20% by weight of metasilicate;
(e) from about 1 to about 5% by weight of retarder;
(f) from about 1 to about 5% by weight of zeolite; and
(g) optionally from about 0.1 to about 5% by weight of a rheology and permeability adjusting polymer or copolymer.

Also disclosed is a cement composition formed by the method disclosed herein, for example, provided herein is a cement composition comprising:
(a) red mud; and
(b) gypsum;
to provide a cement composition, wherein the red mud is present in an amount of from about 20 wt % to 95 wt % based on the total weight of the cement composition, and wherein the gypsum is present in an amount of from about 5 wt % to about 50 wt % based on the total weight of the cement composition.

Optionally, the red mud may be present in an amount of from about 60 to about 95 wt % based on the total weight of the cement composition and the gypsum is present in an amount of from about 5 to about 40 wt % based on the total weight of the cement composition. Advantageously, when the red mud is present in an amount of from about 60 to about 95 wt % based on the total weight of the cement composition and the gypsum is present in an amount of from about 5 to about 40 wt % based on the total weight of the cement composition, the cement composition is particularly well suited for forming quick set concrete, for example quick set low strength concrete (with and without aggregate), and quick set well cement.

Optionally, the red mud is present in an amount of from about 25 to about 45 wt % based on the total weight of the cement composition and the gypsum is present in an amount of from about 5 to about 45 wt % based on the total weight of the cement composition. Advantageously, when the red mud is present in an amount of from about 25 to about 45 wt % based on the total weight of the cement composition and the gypsum is present in an amount of from about 5 to about 45 wt % based on the total weight of the cement composition, the cement composition is particularly useful for forming quick set self-levelling concrete.

Optionally, the red mud is present in an amount of from about 35 to about 55 wt % based on the total weight of the cement composition and the gypsum is present in an amount of from about 5 to about 15 wt % based on the total weight of the cement composition. Advantageously, when the red mud is present in an amount of from about 35 to about 55 wt % based on the total weight of the cement composition and the gypsum is present in an amount of from about 5 to about 15 wt % based on the total weight of the cement composition, the cement composition is particularly well suited for forming fire proofing concrete, or for soil stabilization and/or for backfilling fence posts.

Suitably, the red mud comprises Fe₂O₃, SiO₂, Al₂O₃, CaO, TiO₂, Na₂O, P₂O₅, and K₂O.

Optionally, the cement composition further comprises a pozzolan. For example, the cement composition may comprise a pozzolan in an amount of from about 10 to about 35 wt % based on the total weight of the cement composition, such as in an amount of from about 15 to about 30 wt % based on the total weight of the cement composition. Suitably, the cement composition may comprise a pozzolan in an amount of from about 20 to about 25 wt % based on the total weight of the cement composition.

Suitably, the pozzolan comprises calcium oxide or calcium hydroxide and silicon dioxide. The calcium oxide or calcium hydroxide may be present in (in the pozzolan) an amount of from about 1 to about 60 wt % based on the total weight of the pozzolan. The silicon dioxide may be present (in the pozzolan) in an amount of from about 5 to about 70 wt % based on the total weight of the pozzolan. Suitably, the calcium oxide or calcium hydroxide is present in an amount of from about 1 to about 60 wt % based on the total weight of the pozzolan and the silicon dioxide is present in an amount of from about 5 to about 70 wt % based on the total weight of the pozzolan.

Suitably, the pozzolan is selected from the group comprising carbide slag, granulated ground blast furnace slag, fly ash, and ground waste glass.

The cement composition may further comprise metasilicate. Suitably, the metasilicate is sodium metasilicate.

Optionally the metasilicate is present in an amount of from about 2 to about 20 wt % based on the total weight of the cement composition, such as in an amount of from about 4 to about 18 wt %, optionally, from about 6 to about 16 wt %, such as from about 8 to about 12 wt % based on the total weight of the cement composition.

Optionally, the cement composition comprises sodium metasilicate in an amount of from about 2 wt % to about 20 wt % based on the total weight of the cement composition.

The cement composition may further comprise a retarder. The retarder may be selected from the group comprising: sodium tetraborate; tartaric acid; boric acid; sodium citric dehydrate and citric acid.

Suitably, the retarder is present in an amount of from about 1 to about 20 wt % based on the total weight of the cement composition, more suitably in an amount of from about 1 to about 15 wt %, such as in an amount of from about 4 to about 12 wt % based on the total weight of the cement composition, for example in an amount of from about 5 to about 10 wt % based on the total weight of the cement composition. For example, the retarder may be present in an amount of from about 1 to about 10 wt % based on the total weight of the cement composition, or from about 4 to about 10 wt %, optionally from about 5 to about 10 wt % based on the total weight of the cement composition.

The cement composition may further comprise zeolite. Optionally, the cement composition further comprises zeolite in an amount of from about 1 to about 5 wt % based on the total weight of the cement composition.

The cement composition may further comprise a rheology modifier and/or a permeability adjuster. For example, the cement composition may further comprise a rheology modifier and permeability adjusting polymer or copolymer.

Suitably, the rheology and permeability adjusting polymer or copolymer is selected from latex, vinyl acetate and polyvinyl alcohol.

The cement composition may comprise further additives. For example, the cement composition may comprise further additives in an amount of from about 1 to about 15 wt % based on the total weight of the cement composition.

Suitably, such further additives include micro fibres, macro fibres, viscosity modifiers and other cement additives. The micro or macro fibres may be present in an amount of from about 0.1 wt % to about 3 wt % of the total weight of the cement composition.

Optionally, the cement composition may comprise:
(a) from about 60 to about 95% by weight of red mud; and
(b) from about 5 to about 40% by weight of gypsum.

Suitably, such cement compositions are particularly useful for quick set low strength concrete.

Optionally, the cement composition may comprise:
(a) from about 20 to about 55% by weight of dried red mud; and
(b) from about 5 to about 15% by weight of gypsum;
(c) from about 10 to about 35% by weight of pozzolan; and
(d) from about 2 to about 20% by weight of metasilicate.

Suitably, such cement compositions are particularly useful for quick set self-levelling concrete.

Optionally, the cement composition may comprise:
(a) from about 35 to about 55% by weight of dried red mud; and
(b) from about 5 to about 15% by weight of gypsum;
(c) from about 15 to about 35% by weight of pozzolan;
(d) from about 5 to about 15% by weight of metasilicate; and
(e) from about 1 to about 5% by weight of retarder.

Suitably, such cement compositions are particularly useful for fire-proofing applications, or for soil stabilization or for backfilling fence posts.

Optionally, the cement composition may comprise:
(a) from about 20 to about 55% by weight of red mud; and
(b) from about 5 to about 15% by weight of gypsum;
(c) from about 10 to about 35% by weight of pozzolan;
(d) from about 2 to about 20% by weight of metasilicate;
(e) from about 1 to about 5% by weight of retarder;
(f) from about 1 to about 5% by weight of zeolite; and
(g) optionally from about 0.1 to about 5% by weight of a rheology and permeability adjusting polymer or copolymer.

Optionally, the cement composition may comprise:
(a) from about 20 to about 55% by weight of red mud; and
(b) from about 5 to about 15% by weight of gypsum;
(c) from about 10 to about 35% by weight of pozzolan;
(d) from about 2 to about 20% by weight of metasilicate; and
(e) from about 1 to about 5% by weight of retarder.

For example, the cement composition may comprise:
(a) from about 20 to about 55% by weight of dried red mud; and
(b) from about 5 to about 15% by weight of gypsum;
(c) from about 10 to about 35% by weight of pozzolan;
(d) from about 2 to about 20% by weight of metasilicate;
(e) from about 1 to about 5% by weight of retarder;
(f) from about 1 to about 5% by weight of zeolite; and
(g) optionally from about 0.1 to about 5% by weight of a rheology and permeability adjusting polymer or copolymer.

In another aspect, the present disclosure provides a method for forming a cementitious composition comprising the steps of combining the cement composition disclosed herein with water.

Optionally, the water to cement composition weight ratio is in the range of from 0.20 to 0.90. For example, the water to cement composition ratio may be in the range of from 0.30 to 0.90, such as from 0.40 to 0.90, for example from 0.40 to 0.80, optionally from 0.40 to 0.75.

In yet another aspect, the present disclosure provides a cementitious composition comprising the cement composition disclosed herein and water.

Optionally, the water to cement composition weight ratio is in the range of from 0.20 to 0.90. For example, the water to cement composition ratio may be in the range of from 0.30 to 0.90, such as from 0.40 to 0.90, for example from 0.40 to 0.80, optionally from 0.40 to 0.75.

Optionally, the cementitious composition is a pre-set cementitious composition i.e. a non-hardened cementitious composition, or for example a free-flowing cementitious composition.

Optionally, the cementitious composition is cured (i.e. set or hardened).

In a still further aspect, the present disclosure provides a method for preparing a concrete composition, comprising combining a cement composition as disclosed herein, aggregate material and water to form the concrete composition.

The cement composition may be present in an amount of from about 25 to about 98 wt % based on a dry weight of the concrete composition, such as in an amount of from about 35 to about 90 wt %, optionally from about 45 to about 85 wt % based on the dry weight of the concrete composition.

The aggregate material may be one or more of sand, gravel, crushed stone, iron blast-furnace slag, lightweight filler, mineral aggregate, and any combinations thereof.

The aggregate material may be present in an amount of from about 1 to about 90 wt % based on the dry weight of the concrete composition, such as in an amount of from about 2.5 to about 85 wt %, optionally from about 3 to about 80 wt % based on the dry weight of the concrete composition.

The aggregate material may comprise a sand size aggregate material having a minimum particle size of 200 μm, or the sand sizes specified in the standard ASTM C33 Standard Specification for Concrete Aggregate. The aggregate material may comprise a sand size aggregate material having a maximum nominal particle size of 4.25 mm. For example, the aggregate material may comprise a sand size aggregate material having a particle size in the range of from of 200 μm to 4.25 mm.

The aggregate material may be a lightweight filler material.

Suitably, the aggregate material comprises sand.

Optionally, the method for preparing the concrete composition may comprise adding a retarder. For example, though the cement composition may comprise a retarder, the method for forming the concrete disclosed herein may comprise adding additional retarder. The additional retarder may be added in an amount of from about 1 to about 10 wt % based on the dry weight of the concrete composition.

The method for preparing the concrete composition may further comprise adding additives, such as polymers or copolymers to modify other properties of the concrete composition. Such additives may be added in an amount of from about 0.05 to about 0.6 wt % based on the dry weight of the concrete composition.

The present disclosure also provides a concrete composition comprising the cement composition disclosed herein, aggregate material and water.

The concrete composition may be formed by combining the cement composition disclosed herein, aggregate material and water. For example, the concrete composition may be formed by the method for preparing a concrete composition disclosed herein.

The cement composition may be present in an amount of from about 25 to about 98 wt % based on a dry weight of the concrete composition, such as in an amount of from about 35 to about 90 wt %, optionally from about 45 to about 80 wt % based on the dry weight of the concrete composition.

The aggregate material may be one or more of sand, gravel, crushed stone, iron blast-furnace slag, filler, mineral aggregate, and any combinations thereof.

The aggregate material may be present in an amount of from about 1 to about 90 wt % based on the dry weight of the concrete composition, such as in an amount of from about 2.5 to about 85 wt %, optionally from about 3 to about 80 wt % based on the dry weight of the concrete composition.

The aggregate material may comprise a sand size aggregate material having a minimum particle size of 200 μm, or the sand sizes specified in the standard ASTM C33 Standard Specification for Concrete Aggregate. The aggregate material may comprise a sand size aggregate material having a maximum nominal particle size of 4.25 mm. For example, the aggregate material may comprise a sand size aggregate material having a maximum particle size in the range of from of 200 μm to 4.25 mm.

The aggregate material maybe a lightweight filler material.

Suitably, the aggregate material comprises sand.

Optionally, the concrete composition may be formed by combining the cement composition disclosed herein, aggregate material, a retarder, and water. For example, though the cement composition may comprise a retarder, the method for forming the concrete disclosed herein may comprise adding additional retarder. The additional retarder may be added in an amount of from 1 to about 15 wt % based on the dry weight of the concrete composition.

Further additives may also be added, such as polymers or copolymers to modify properties of the concrete composition. Such additives may be added in an amount of from about 1 to about 15 wt % based on the dry weight of the concrete composition.

Optionally, the concrete composition is a pre-set concrete composition.

Optionally, the concrete composition is cured (set).

The cement composition of the present disclosure is useful in a wide range of applications, for example, for manufacturing quick set concrete, for example, quick set low strength concrete, quick set well cement, quick set self-levelling concrete compositions, fire proofing concrete compositions, for fencing applications i.e. anchoring fence posts or backfilling fence posts, and/or for soil stabilization.

A method for forming a cement composition disclosed herein may comprise combining:
(a) from about 20 to about 55% by weight of dried red mud; and
(b) from about 5 to about 15% by weight of gypsum;
(c) from about 10 to about 35% by weight of pozzolan; and
(d) from about 2 to about 20% by weight of metasilicate.

For example, the combination may comprise:
(a) from about 20 to about 55% by weight of dried red mud; and
(b) from about 5 to about 15% by weight of gypsum;
(c) from about 10 to about 35% by weight of pozzolan;
(d) from about 2 to about 20% by weight of metasilicate; and
(e) from about 1 to about 5% by weight of retarder.

The combination may comprise:
(a) from about 20 to about 55% by weight of dried red mud; and
(b) from about 5 to about 15% by weight of gypsum;
(c) from about 10 to about 35% by weight of pozzolan;
(d) from about 2 to about 20% by weight of metasilicate;
(e) from about 1 to about 5% by weight of retarder; and
(f) from about 1 to about 5% by weight of zeolite.

The combination may comprise:
(a) from about 20 to about 55% by weight of dried red mud; and
(b) from about 5 to about 15% by weight of gypsum;
(c) optionally from about 10 to about 35% by weight of pozzolan;
(d) optionally from about 2 to about 20% by weight of metasilicate;
(e) optionally from about 1 to about 5% by weight of retarder;
(f) optionally from about 1 to about 5% by weight of zeolite; and
(g) optionally from about 0.1 to about 5% by weight of a rheology and permeability adjusting polymer or copolymer;
wherein the cement composition comprises (a) and (b) with any combination of (c) to (g) to total 100% by weight of the cement composition.

The cement composition disclosed herein may be combined with water to form a cementitious composition. For example, the cement composition can be combined with water in a weight ratio of water to cement of from about 0.20. Optionally, the cementitious composition disclosed herein may be formed by combining the cement composition disclosed herein with water in a water to cement weight ratio of up to about 0.90.

The primary components of the cement composition as described herein are red mud and gypsum. Further additives may include pozzolans, metasilicate, set time retarders, zeolite, polymers, copolymers, etc. depending on the requirements for the cement composition, based on as its intended application. The cement composition may be dry, or can be combined with water to form a cementitious composition which for example can have a pourable or spreadable consistency, based on the ratio of water to cement composition.

For example, the cementitious composition disclosed herein may be formed by combining:
from about 20 to about 95% by weight of dried red mud; and
from about 5 to about 50% by weight of gypsum, to form a cement composition as disclosed herein, which may further be combined with water in a weight ratio of up to 1:1.
   This gives rise to a wet cementitious composition, which can have a pourable or spreadable consistency, as required, depending on the amount of water added.
   This combination of materials can give rise to a quick-set cementitious composition.
   This combination of materials can achieve:
A compressive strength in the range of from 50 psi (34.5 Mpa) to 4,500 psi (31.0 Mpa) at ambient temperatures below 90° F. (32° C.);
A compressive strength in the range of from 150 psi (1.03 Mpa) to 6,000 psi (41.4 Mpa) at temperatures at or above 100° F. (37.8° C.); and
from 2 to 3 hours thickening time (70 cpi) at atmospheric pressure and 100° F.

A method of preparing concrete compositions is also disclosed herein.

The method of preparing a concrete composition comprises combining the cement composition disclosed herein, water and aggregate material to form a concrete composition as disclosed herein.

The primary components of the concrete composition as described herein are red mud, gypsum, water and aggregate. Further additives may also be included either in the base cement composition, or combined with the cement composition, water and aggregate when manufacturing the concrete composition disclosed herein. Examples of such additives include set time retarders, pigments, micro fibres, macro fibres, viscosity modifiers, polymers and copolymers, depending on the requirements for the concrete composition, based on as its intended application. The concrete composition can have a pourable or spreadable consistency, based on the ratio of water to dry weight ingredients i.e. cement composition plus aggregate plus any further additives. The concrete composition can be self-levelling.

The concrete composition is optionally cured after application, in ambient conditions, with heat, or by electrical or ultraviolet treatment.

The concrete composition may be formed by combining a combination of:
a cement composition, aggregate material and water,
wherein the cement composition is present in an amount of from about 25 to about 95 wt % based on dry weight of the combination, and wherein the aggregate material is present in an amount of from about 10 to about 75 wt % based on the total dry weight of the concrete composition;
wherein the cement composition comprises:
red mud, and
gypsum, wherein the red mud is present in an amount of from about 60 wt % to about 95 wt % based on the total weight of the cement composition, and wherein the gypsum is present in an amount of from about 5 to about 40 wt % based on the total weight of the cement composition;
wherein, optionally,
(wt) water:(wt) (cement composition+aggregate material) is from 1:20 to 1:1.
   The composition can be a quick-set concrete composition with the following properties:
From 50 psi (0.35 Mpa) to 4,500 psi (31.0 Mpa) at ambient temperatures below 90° F. (32° C.),
from 150 psi (1.03 Mpa) to 6,000 psi (41.4 Mpa) at temperatures at or above 100° F. (37.8° C.).

The cement composition disclosed herein is useful for preparing quick-set concrete compositions.

The concrete composition disclosed herein may be a quick-set concrete composition.

The broad framework requirements for accelerated concrete includes a material that can absorb water without significant mixing, can be mixed in an excavation using basic mechanical methods after water inclusion, achieve stability within from 5 to 180 minutes, has a compressive strength of from about 50 to 12,000 psi (0.34 to 83 Mpa) in 28 days and results in a stable concrete that is moisture and chemical resistant. In order to be suitable for backfilling fence posts, the concrete composition should not degrade embedded wood, other concrete, or metal elements used as posts, but to protect such elements from surrounding soil, thereby shielding such elements or parts thereof from possible biological and chemical degradation through contact with soil, as well as from weather, and water.

A quick-set concrete composition may be formed by combining a combination of:
a cement composition; aggregate material; and water;
wherein the cement composition is present in an amount of from about 25 to about 75 wt % based on the total dry weight of the concrete composition, wherein the aggregate material is present in an amount of from about 10 to about 75 wt % based on the total dry weight of the concrete composition;
optionally, wherein the aggregate material is a natural or synthetic normal weight, or heavy weight sand mixture.
wherein the cement composition comprises:
red mud, gypsum, a pozzolan, a metasilicate, and a retarder;
wherein the red mud is present in an amount of from about 20 wt % to about 55 wt % based on the total dry weight of the cement composition;
wherein the gypsum is present in an amount of from about 5 to about 15 wt % based on the total dry weight of the cement composition;
wherein the pozzolan is present in an amount of from about 10 to about 35 wt % based on the total dry weight of the cement composition;
wherein the metasilicate is present in an amount of from about 2 to about 20 wt % based on the total dry weight of the cement composition;
and wherein the retarder is present in an amount of from about 1 to about 10 wt % based on the total dry weight of the cement composition;
optionally, wherein the pozzolan is selected from the group consisting of carbide slag, granulated ground blast furnace slag, fly ash, ground waste glass, or other synthetic or natural pozzolan that contains about 1 to about 60% by weight of calcium oxide/hydroxide and from about 5 to about 70% silica dioxide, or combinations thereof;
optionally, wherein the metasilicate is an alkali metasilicate or metasilicate pentahydrate, such as sodium metasilicate,
optionally, wherein the retarder is a set-time retarder admixture;
wherein, optionally,
(wt) water:(wt) (cement composition+aggregate material) is from 1:20 to 1:1.
   The above combined materials when mixed with water have a pourable consistency, and when placed and tested in accordance with industry standards will achieve:
From 2,000 psi (13.8 Mpa) to 12,000 psi (82.9 Mpa) at ambient temperatures below 90° F. (32° C.),
and from 3,000 psi (20.7 Mpa) to 14,000 psi (96.6 Mpa) at temperatures at or above 100° F. (37.8° C.).

The cement or the cementitious composition may be suitable for use in preparing a self-levelling concrete composition.

The concrete composition may be a self-levelling concrete composition.

The broad framework requirements for self-levelling mixtures varies widely and is dependent upon the engineer's specific scope application, the depth of the layer which can be from about ⅛″ to 2 inches, the geographic location, and the long-term durability requirements. Often, the minimum compressive strength for exterior rated self-levelling is about 4,000 psi in 28-days, and about 2,500 psi for interior rated self-levelling mixtures. The finished surface is required to be flat and level, and many times floor flatness and levelness specifications are applied.

Uneven concrete, wood, and other flatwork features often require flattening to accommodate flatness and levelness specifications, floor coverings, chemical protection, and safety. Most times the uneven surface is levelled and flattened with viscous concrete mixtures that effort to reach a consistent level through the low viscosity fluid. The mixtures are referred to as self-levelling, screed, or possibly smoothing compound mixtures. The mixtures may be a combination of cement and sand (usually fine-grained sand), but are sometimes neat cement. When OPC is utilized, super-plasticizers are commonly added to achieve a very low viscosity. With red mud cement, high-range water reducers can be used, but the volume stability of red mud cement allows a very low viscosity to be obtained through the addition of water. When utilizing more than one size of sand, the particle size grading of the sand is typically densified to reduce water demand, and reduce the amount of required cement. The high strength of red mud cement achieves minimum strength specifications of from about 1,000 to 8,000 psi in 28 days, and 500 to 2,000 psi in one-day. The set time of red mud cement self-levelling mixtures can be adjusted to accommodate walking within about 1 to about 3 hours.

A self-levelling concrete composition may be formed by combining a combination of:
a cement composition; aggregate material; and water;
wherein the cement composition is present in an amount of from about 25 to about 75 wt % based on the total dry weight of the concrete composition,
wherein the aggregate material is present in an amount of from about 10 to about 75 wt % based on the total dry weight of the concrete composition;
optionally, wherein the aggregate material is a natural or synthetic normal weight, or heavy weight sand mixture;
wherein the cement composition comprises:
red mud, gypsum, a pozzolan, and metasilicate;
wherein the red mud is present in an amount of from about 20 wt % to about 55 wt % based on the total weight dry of the cement composition;
wherein the gypsum is present in an amount of from about 5 to about 15 wt % based on the total dry weight of the cement composition;
wherein the pozzolan is present in an amount of from about 10 to about 35 wt % based on the total dry weight of the cement composition;
wherein the metasilicate is present in an amount of from about 2 to about 20 wt % based on the total dry weight of the cement composition;
optionally, wherein the pozzolan is selected from the group consisting of carbide slag, granulated ground blast furnace slag, fly ash, ground waste glass, or other synthetic or natural pozzolan that contains about 1 to about 60% by weight of calcium oxide/hydroxide and from about 5 to about 70% silica dioxide, or combinations thereof;
optionally, wherein the metasilicate is an alkali metasilicate or metasilicate pentahydrate, such as sodium metasilicate;
wherein, optionally,
(wt) water:(wt) (cement composition+aggregate material) is from 1:20 to 1:1.
   The above combined materials when mixed with water have a pourable and self-levelling consistency, and when placed, and tested in accordance with industry standards will achieve:
From about 2,500 psi (17.24 Mpa) to 8,000 psi (55.17 Mpa) at ambient temperatures below 90° F. (32° C.).

The cement or the cementitious composition may be suitable for use in protecting structural steel or concrete from fire, wherein said use comprises applying the composition to the structural steel or concrete.

The concrete composition may be suitable for use in protecting structural steel or concrete from fire, wherein said use comprises applying the composition to the structural steel or concrete.

The broad framework requirements for fireproofing and renders includes a material that can absorb water without significant mixing, can be mixed and conveyed with standard industry equipment, and can achieve various industry fire protection requirements such as those presented by Under Writer Laboratories (UL) under their specifications including UL263 (cellulose) and UL1709 (hydrocarbon fires), and similar other requirements that vary around the world.

Structural steel, concrete, wood, and other construction materials often require protection from fire. In most cases, the protection is designed as a temporary measure that increases the time that emergency personnel have to rescue humans or other animals, or to provide additional time to extinguish the fire before catastrophic structural failure occurs. In some events, the material is applied as a façade generally referred to as Stucco or Render. The construction materials are protected by applying (by hand or spray) a protective covering at variable thicknesses dependent upon the intended hourly rating required for the constructed feature. Utilizing a combination of red mud and gypsum and lightweight aggregates when combined with water is an inexpensive and effective method of providing fire protection or a cosmetic facade.

A fire-proofing concrete composition may be formed by combining a combination of:
a cement composition; aggregate material; and water;
wherein the cement composition is present in an amount of from about 25 to about 75 wt % based on the total dry weight of the concrete composition;
wherein the aggregate material is a lightweight filler material, and is present in an amount of from about 10 to about 75 wt % based on the total dry weight of the concrete composition;
wherein the cement composition comprises:
red mud, gypsum, a pozzolan, metasilicate, and a retarder;
wherein the red mud is present in an amount of from about 20 wt % to about 55 wt % based on the total weight of the cement composition;
wherein the gypsum is present in an amount of from about 5 to about 15 wt % based on the total weight of the cement composition;
wherein the pozzolan is present in an amount of from about 10 to about 35 wt % based on dry weight of the cement composition;
and wherein the metasilicate is present in an amount of from about 2 to about 20 wt % based on dry weight of the cement composition;
and wherein the retarder is present in an amount of from about 1 to about 10 wt % based on dry weight of the cement composition;
optionally, wherein the pozzolan is selected from the group consisting of carbide slag, granulated ground blast furnace slag, fly ash, ground waste glass, or other synthetic or natural pozzolan that contains about 1 to about 60% by weight of calcium oxide/hydroxide and from about 5 to about 70% silica dioxide, or combinations thereof;
optionally, wherein the metasilicate is an alkali metasilicate or metasilicate pentahydrate, such as sodium metasilicate;
optionally, wherein the retarder is a set-time retarder admixture;
wherein, optionally,
(wt) water:(wt) (cement composition+aggregate material) is from 1:20 to 1:1.
   The above combined materials when mixed with water have a pump-able or pourable consistency, and when placed, and tested in accordance with industry standards will achieve:
From about 50 psi (0.34 Mpa) to 4,000 psi (27.6 Mpa) in 28 days of curing at ambient temperatures.

The cement or the cementitious composition may be suitable for use in stabilizing fine grained expansive or compressible soils, wherein said use comprises mixing the composition with soil materials.

The concrete composition may be suitable for use in stabilizing fine grained expansive or compressible soils, wherein said use comprises mixing the composition with soil materials.

The broad framework requirements for soil stabilization vary widely and are dependent upon the engineer's modification intent and the corresponding soil characteristics including particle size, plasticity, swell potential, R-Value, California Bearing Ratio, Resilient Modulus, shear strength, compressibility, and permeability. For the purpose intended, “modification intent” is defined as slope stability, roadway subgrade, base course, foundation subgrade, etc., and the corresponding decrease in permeability, increase in density, strength, or other properties as intended to be improved by the modification.

The dry blended material may be mixed with soil as a stabilization mechanism, mixed with water and used in standard concrete mixing equipment. The concrete mixture may be cured normally in ambient conditions, cured with heat, or cured by electrical or ultraviolet treatment.

For aggregate material combinations, the requirements are most typically compressive strength for use below pavement sections, or as a roller compacted concrete for various purposes including water retention structures. For soil, the requirements are much wider and can include stabilizing a compressible sand or silt, or stabilizing a clayey material. Sands and silts have low strength but typically do not contain an abundance of organic materials and stabilization with red mud Cement is highly effective and typically includes compressive strength. For clay soils that have moderate to high plasticity indexes, the swell potential must be mitigated. This occurs with Red mud Cement by migrating sodium and calcium ions to the surface of clay particles and displacing water and other ions. Further, the silica dioxide and other metal molecules in clay are cemented together thereby reducing or removing plasticity, and increasing the compressive strength.

A soil stabilizing cement composition may be formed by combining:
from about 20 to about 95% by weight of dried red mud; and
from about 5 to about 50% by weight of gypsum, to form a cement composition as disclosed herein, which may further be combined with a pozzolan, and optionally water, for example, water may be added in a weight ratio of water to dry weight ingredients i.e. non-water ingredients such as cement composition plus pozzolan, of from 0.05:0.95 to up to 1:1.
   The cement composition may therefore comprise:
red mud, gypsum and pozzolan;
wherein the red mud is present in an amount of from about 20 wt % to about 55 wt % based on the total weight of the cement composition;
wherein the gypsum is present in an amount of from about 5 to about 15 wt % based on the total weight of the cement composition;
wherein the pozzolan is present in an amount of from about 10 to about 35 wt % based on the total weight of the cement composition;
optionally wherein the pozzolan is selected from the group consisting of carbide slag, granulated ground blast furnace slag, fly ash, ground waste glass, or other synthetic or natural pozzolan that contains about 1 to about 60% by weight of calcium oxide/hydroxide and from about 5 to about 70% silica dioxide, or combinations thereof.
   Water may be added to the cement composition to provide a cementitious composition.
   The soil stabilizing cement or cementitious composition may be used for soil stabilization, for example it may be added to moist or moisturized soil or to a combination of soil and/or aggregate material using industry mixing equipment including motor graders, pugmills, recyclers, or other similar equipment, and compacted to increase strength, reduce the permeability, reduce the plasticity, and decrease the soil and/or soil and aggregate materials combination's swell potential or compressibility.
   Optionally, from about 1 to about 10% by weight of cement composition can be added to soil, or added to soil plus aggregate material.

Suitably, a sufficient amount of water may be added to the soil or to the soil and aggregate combination to compact the materials to a minimum of 90% of the ASTM D1157, D698, or AASHTO T180, or T99 test standards.

A soil stabilizing concrete composition may be formed by combining a combination of:
a cement composition; and water; and soil and/or aggregate combinations;
wherein the cement composition is present in an amount of from about 25 to about 75 wt % based on the total dry weight of the concrete composition,
wherein the cement composition comprises:
red mud, gypsum, a pozzolan and metasilicate;
wherein the red mud is present in an amount of from about 20 wt % to about 55 wt % based on the total weight of the cement composition;
wherein the gypsum is present in an amount of from about 5 to about 15 wt % based on the total weight of the cement composition;
wherein the pozzolan is present in an amount of from about 10 to about 35 wt % based on the total weight of the cement composition;
wherein the metasilicate is present in an amount of from about 2 to about 20 wt % based on the total weight of the cement composition;
optionally, wherein the pozzolan is selected from the group consisting of carbide slag, granulated ground blast furnace slag, fly ash, ground waste glass, or other synthetic or natural pozzolan that contains about 1 to about 60% by weight of calcium oxide/hydroxide and from about 5 to about 70% silica dioxide, or combinations thereof;
optionally, wherein the metasilicate is an alkali metasilicate or metasilicate pentahydrate, such as sodium metasilicate
wherein, optionally,
(wt) water:(wt) (cement composition) is from 1:20 to 1:1.
   The above combined materials when mixed with water, and when placed, and tested in accordance with industry standards will achieve:
From about 25 to about 85% improvement in R-Value, CBR, or Resilient Modulus with soil and granular sand and aggregate combination materials having a plasticity index greater than non-plastic, but less than 90, and when the beginning R-Value is at least a value of 1;
from about 10 to about 50% improvement in unconfined compressive strength with soil and granular sand and aggregate combination materials having a plasticity index of non-plastic to less than 90;
from about 10 to about 100% reduction in plasticity index with soil and granular sand and aggregate combination materials having a plasticity index of a minimum of 1 but less than 90;
from about 3 to about 25% increase in compacted density with soil and granular sand and aggregate combination materials having a plasticity index of a minimum of 1 but less than 90;
from about 3 to about 75% decrease in water permeability with soil and granular sand and aggregate combination materials having a plasticity index of a minimum of 1 but less than 90;
from about 20 to about 100% increase in shear strength with soil and granular sand and aggregate combination materials having a plasticity index of a minimum of 1 but less than 90;
from about 50 to about 100% decrease in the loaded or unloaded swell potential of soil and granular sand and aggregate combination materials having a plasticity index of a minimum of 1 but less than 90.

The cement or the cementitious composition may be suitable for use in increasing soil strength, wherein said use comprises mixing the composition with granular soil materials.

The concrete composition may be suitable for use in increasing soil strength, wherein said use comprises mixing the composition with granular soil materials.

Soil modification occurs globally in soil and aggregate materials where increases in the bearing capacity, compressive strength, shear strength, and other structural characteristics is necessary. The structural modifications include reinforcements with grids, fabrics, and treatments with lime, fly ash, pozzolans, and cement. Utilizing a combination of Red Mud, gypsum, metasilicates, and pozzolans when mixed with soil and aggregate combinations and water is an inexpensive and effective method of increasing the structural capacity of soil and aggregate combinations for use in highways, airports, buildings, and other elements bearing upon or otherwise dependent upon subgrade support.

Cement or cementitious compositions can be added to soil and aggregate combination materials to increase strength, reduce permeability, reduce plasticity, and decrease the soil and/or aggregate combinations' swell potential or compressibility. If elevated strength is required, the cement/cementitious composition may further comprise sodium metasilicate and/or high calcium pozzolans.

Fence construction is a global construction scope including millions of miles of fence construction every year. Expediting the construction of fencing reduces cost and increases the safety of construction by reducing labour exposure hours and simplifying the construction process. Fencing consists of posts that are typically embedded through excavating and backfill or driven into the ground. Attached to and between the posts are beams, rails, slats, or wire to separate boundaries for the purpose of security, animal control, property boundaries, or cosmetic landscape improvements.

Many fence posts are backfilled with OPC mixtures or soil to increase the strength of posts from lateral influences. Backfilling with soil includes compaction of soil materials which is a safety concern, is less effective than concrete, requires significant additional time, and can be corrosive to the post materials. Backfilling with OPC concrete increases the carbon footprint of fencing and is a safety and time concern. Backfilling with a quick set concrete expedites the construction effort, reduces safety concerns, and provides maximum stability for the post to resist lateral influences caused by weather, equipment, animals, or humans. High strength concrete is not typically required but can be necessary with large fence construction. Variable geographic conditions are typical and some may require freeze and thaw resistance. Freeze and thaw resistance is achieved through the addition of polymers, copolymers, air entrainment additives, or more typically through the inherent low permeability of the concrete thereby reducing damage from thermal expansion and contraction, and water movement during freezing and thawing. In addition to neat cement mixtures, variable sizes of mineral and/or synthetic aggregates can be added to reduce the cement content, increase strength, and increase the durability properties of the concrete. Utilizing a combination of red mud and gypsum, combined with water and various sizes of aggregates is an inexpensive and effective method of backfilling fence posts.

Trenching for the purpose of installing utilities is a safety concern relative to excavation caving. Trenching causes instability in the ground particularly in areas where adjacent construction requires support. Returning stability to the ground in the area of trenching is a time sensitive concern and the faster the stability is returned, the less likely the damage to adjacent elements and failure of the trench. Compacting soil as trench backfill is a safety concern for workers, causes vibration in adjacent elements and associated additional instability, and is subject to consolidation or expansion depending upon the characteristics of the soil and the quality of the compaction effort. Utilizing a quick set concrete backfill in-lieu of soil backfill is a faster and more effective method of returning stability to the excavation. Using a strength-controlled material that does not gain too much strength is important to avoid difficulties in the future should the backfill require excavation for whatever purpose. In some instances, high strength will be necessary to support features above the trench such as roads and foundations. Utilizing a combination of red mud and gypsum combined with water and various sizes of aggregates is an inexpensive and effective method of backfilling trenches.

The cementitious composition can be pumped into hydrocarbon wells.

The concrete composition can be pumped into hydrocarbon wells.

The broad framework requirements for hydrocarbon well cements includes a material that can absorb water without significant mixing, can be mixed and conveyed with standard industry equipment, and can achieve various industry specifications such as those presented by the American Petroleum Institute.

Hydrocarbon well cements utilize OPC to cement well casing, to isolate various zones, to close abandoned wells, and to remediate lost circulation during drilling. Many variable additives are necessary to accommodate variable well cement applications when using OPC. These additives include polymers, copolymers, dispersants, set time accelerators, set time retarders, rheology adjusters, free fluid additives, fluid loss additives, and many others. High strength in these materials is not required and is typically a maximum minimum compressive strength of about 2,000 pounds per square inch (13.8 Mpa). Accelerated strength gain is mostly limited to a minimum of about 300 pounds per square inch (2.07 Mpa) in 8 hours, and at an elevated cure temperature of 100° F. (37.8° C.), and 2,000 pounds per square inch (13.8 Mpa) in 24 hours at 100° F. (37.8° C.). Other requirements exist as defined by industry standards such as the American Petroleum Institute (API) including Thickening Time, Fluid Loss, Free Fluid, and rheology. The requirements vary dependent upon the subsurface temperatures and pumping pressures that are defined by the cement application and the depth of drilling which can be as deep as 30,000 feet or more where subsurface temperatures can exceed 250° F. (121.1° C.) and pumping pressures can exceed 5,000 psi. The elevated temperatures and pressures substantially affect drilling cements by decreasing the set time, decreasing the thickening time, and compressing the fluid thereby increasing viscosity. Elevated pressures can cause packing in the particles due to fluid escape. Utilizing a combination of red mud and gypsum combined with water and various other materials is an inexpensive and effective method of cementing hydrocarbon wells.

Some design considerations are discussed hereinafter.

The method of preparing a cement composition disclosed herein comprising combining red mud and gypsum does not require the step of adding shrinkage control agents.

The method of preparing a cement composition disclosed herein comprising combining red mud and gypsum does not require the step of adding metasilicate or metasilicate pentahydrate. For example, the method of preparing a cement composition disclosed herein may not comprise adding metasilicate or metasilicate pentahydrate.

The method of preparing a cement composition disclosed herein comprising combining red mud and gypsum does not require the step of adding protein.

The method of preparing a cement composition disclosed herein comprising combining red mud and gypsum does not require the step of adding a liquid activator, such as a silicate or hydroxide.

The cement composition disclosed herein comprising red mud and gypsum does not require a shrinkage control agent.

The cement composition disclosed herein comprising red mud and gypsum does not require a metasilicate or metasilicate pentahydrate.

The cement composition disclosed herein comprising red mud and gypsum does not require protein.

The cement composition disclosed herein comprising red mud and gypsum does not require a liquid activator, such as a silicate or hydroxide.

Pozzolans with relatively high calcium concentrations (above 40-percent) have elevated reactivity when used in red mud cement and concrete. Reducing the concentration of these pozzolans may be preferred to avoid an immediate hardening of the cement or concrete mixture. Alternatively, increasing the amount of set-time retarder present, or using a combination of set-time retarder may delay hardening.

The particle shape and size of pozzolans can give rise to particular properties. Fly ash is a rounded particle and enhances the compaction and water reduction of mixtures. However, fly ash is a relatively small particle and smaller than Granulated Ground Blast Furnace Slag (GGBFS) and other pozzolans, which tends to increase water demand due to a larger surface area. Balancing all pozzolans relative to the size and shape of the particles is important.

When selecting aggregate materials, particle distribution should preferably be relatively dense as observed using a trend graph with sieve sizes raised to the 0.45 power. The particle distribution design should conform with OPC industry standards and include an assessment of the coarseness and workability values. Using small particles increases the surface area of the mineral aggregate combination and should be as large as possible while achieving other mixture requirements including aggregate suspension.

Manufactured aggregates and sand contain fractured faces that increase water demand. Using rounded and naturally occurring sands and aggregates is optimal. Using a maximum of 55-percent uncompacted voids in sand materials is optimal.

Compositions designed with fc (American Concrete Institute 318 Standard) strengths in excess of 35 Mpa can be temperature sensitive. Red mud cement and red mud concrete is positively affected by temperature increases with a corresponding increase in short term cure strength of freshly cast mixtures. However, the time of set can reduce with an increase in mixture temperature. Due to the exothermic reaction of sodium metasilicate and water, high strength mixtures can produce elevated mixture temperatures, exacerbated with larger batches. Trial batch tests and balancing should include large batches (minimum 0.09 cubic meters or 3-cubic feet) and variable water and ambient temperatures. A calibration should be conducted with variable retarder concentrations conducted at variable mixture temperatures, such that the retarder can be increased analytically with a corresponding increase in mixture temperature to accommodate high strength mixtures and elevated ambient and material temperatures. Mixing sodium metasilicate and sodium metasilicate pentahydrate at a ratio of about 80:20 respectively, is an effective method to reduce the exothermic temperature gain from the sodium metasilicate.

Hydrocarbon well casing in very deep drilling conditions and exceeding 10,000 feet experience elevated subsurface temperatures that can approach 148.9° C. (300° F.) at depths approaching 30,000 feet. Further, these mixtures typically require a maximum fluid unit weight of about 11 pounds per gallon to reduce pumping pressure. Water contents in excess of 75% are necessary to reduce the mixture unit weight, along with lightweight pozzolans. As water converts into a part of the chemical framework of Red Mud Cement/Concrete, fluid loss and free fluid is not a concern, as the water never leaves the cement/concrete mixture. The transition time is about 2 minutes.

Red Mud Cement/Concrete contains inherent nuclear shielding materials such as Ferrous Oxide and Boron based materials. Should the materials developed herein be intended for nuclear shielding purposes, heavy-weight aggregates and sands such as Basalt, Hematite, Magnetite, and other similar materials should be utilized in accordance with the procedures herein.

Soil characteristics vary dramatically on a project-to-project basis. Formulating the constituent concentration of Red Mud Cement for stabilization purposes may be necessary on many projects, in-lieu of utilizing standard Red Mud Cement. Variances in the calcium, silica-dioxide, and gypsum concentrations may be necessary and analysis and balancing should occur on every project.

The freezing temperature of water mixed, fresh and plastic red mud cement is below the freezing temperature of water. Formulations of various mixtures have been tested for freezing resistance at temperatures below −34.4° C. Due to variances in cement, water, and mineral aggregate content in many mixtures, verification of the freezing temperatures should occur before subjecting any mixture to extremely low temperatures.

Red mud cement/concrete attaches/bonds chemically to carbon steel and most other products including OPC, epoxies, and wood. Red mud cement/concrete will not attach to products containing elevated concentrations of zinc or aluminum. Red mud cement/concrete does not attach to many plastics.

Red mud cement/concrete has an elevated pH ranging from about 10.5 to 11.5 in a plastic state. Appropriate personal protective equipment should be used during the testing process.

Red mud cement has an elevated pH and a fine particle size that contains silica-dioxide. Appropriate personal protective equipment should be used when handling the cement.

The methods described herein can further include pre-treating the Red Mud and Red Mud pozzolan combinations with from about 0.05 to about 5% by weight of carbon dioxide to convert free sodium to carbonates which would otherwise occur during concrete curing and result in the precipitation of sodium carbonate and sodium bicarbonate when exposed to atmospheric carbon dioxide. The carbon dioxide source may be in the form of a gas, a super critical liquid, or a bubble. Carbon dioxide may be added before or after the pozzolan inclusion. Carbon dioxide may be added after the Red Mud, pozzolan, and other ingredients are added and after the addition of water, while the combination is in a plastic condition. In the event that carbon dioxide is not utilized to capture free sodium, diatomite, zeolites or other filter media may be added to capture and sequester materials that would otherwise precipitate from the concrete during or after initial curing.

### Preparation of Quick-Set Red Mud Cement or Concrete

Preparing a dry formulation for use in bagged mixtures, continuous mix production equipment, or Ready-Mix Concrete or other production facilities can be performed as follows:

Extract Red Mud from the waste impoundment or capture Red Mud from the Bayer Process prior to impoundment disposal. After drying the Red Mud at a temperature of about 300° F. to 500° F., reduce the particle size of the Red Mud to a minimum of 100% passing the #8 sieve size, but preferably a minimum of 75% passing the #325 sieve size. Add from 20 to 55% by weight of the Red Mud and from 5 to 15% by weight of calcium sulfate to a blender and mix until homogeneous. Combine with other materials for the production of various materials including all or some of the following components:
about 2 to about 20% by weight of an alkali metasilicate or metasilicate pentahydrate (e.g., sodium metasilicate, calcium metasilicate, or potassium metasilicate);
about 1 to about 10% by weight of a set time retarder, e.g., sodium tetraborate, tartaric acid, boric acid, sodium citric dihydrate, or citric acid;
about 10 to about 35% by weight of granulated ground blast furnace slag, fly ash, or other synthetic or natural pozzolan that contains about 5 to about 60% by weight of calcium hydroxide and from 5 to about 70% silica dioxide;
from about 10 to about 75% of lightweight filler materials and/or a dried natural or synthetic normal weight, lightweight, or normal weight sand and aggregate mixture;
from about 0.1 to about 5% of a rheology and permeability adjusting polymer or copolymer.
   Water may optionally be added.

### Definitions

References in the specification to “one embodiment”, “an embodiment”, “one aspect”, “an aspect” and similar indicate that the described embodiment or aspect may include a particular aspect, feature, structure or characteristic. Moreover, such phrases may, but do not necessarily, refer to the same embodiment or aspect referred to in other portions of the specification. Further, when a particular aspect, feature, structure or characteristic is described in connection with an embodiment or aspect, it is within knowledge of a person skilled in the art to affect or connect said aspect, feature, structure or characteristic with other embodiment or aspect, whether or not explicitly described. The singular forms “a”, “an” and “the” include plural references unless the context clearly dictates otherwise. Thus, for example, a reference to “a compound” includes a plurality of such compounds. It is further noted that the claims may be drafted to exclude any optional element. As such, this statement is intended to serve as antecedent basis for the use of exclusive terminology, such as “solely”, “only”, and the like, in connection with the recitation of claims elements or use of a “negative” limitation.

The term “and/or” means anyone of the items, any combination of the items, or all the items with which this term is associated.

The terms “comprising”, “having”, “including” and “containing” are to be construed as open-ended terms (i.e. meaning “including, but not limited to”) and are to be considered as providing support also for terms as “consist essentially of”, “consisting essentially of”, “consist of” or “consisting of”.

The terms “consist essentially of”, “consisting essentially of” are to be construed as a semi-closed terms, meaning that no other ingredients which materially affects the basic and novel characteristics (and optionally physiologically acceptable excipients and/or adjuvants) of the invention are included.

The terms “consists of”, “consisting of” are to be construed as a closed term.

Red mud cement, in accordance with the present disclosure, can conform as a hydraulic cement in general accordance with the ASTM C1157 Standard Performance Specification for Hydraulic Cements.

As used herein, the term “dried red mud” refers to a red mud composition having a liquid content of 2 wt % or less. Specifically dried red mud may have a liquid content of from 0 wt % to 5 wt %, such as from 0 to 3 wt %, optionally from 0 to 2 wt % based on the total weight of the red mud composition.

As used herein, the term “cement” or “cement component” refers to the combination of red mud with gypsum. Cement is a dry material. Other components may also be present.

As used herein, the term “cementitious composition” refers to the combination of red mud with gypsum, to which water has been added. A “cementitious composition” as defined herein is a wet material prior to curing/hardening. Other components may also be present.

As used herein, the term “water to cement ratio” is the ratio of the mass of water to the mass of cement used in a cementitious or concrete composition.

As used herein the term “about” may mean ±0.1% of the specified value, or ±0.5% of the specified value, or ±1% of the specified value. A value preceded by the term about also includes the specified value, e.g. about 5 includes 5.

As used herein the term “dry weight” means weight without water, or anhydrous weight, e.g. a concrete composition comprises a cement composition, aggregate material and water; a cement composition present in an amount of 25 wt % based on the dry weight of the concrete composition, implies that the remaining ingredients of the concrete minus water i.e. the aggregate material accounts for 75 wt % of the concrete composition.

When Red mud Cement is pumped into hydrocarbon wells, it is for example for the purpose of plugging abandoned wells, cementing new well casing and extraction zones, and for lost circulation cementing where areas are encountered during the drilling process where drilling fluids are lost in instable zones.

As used herein, the term “set time” refers to the amount of workable time the mixture is expected to last, after adding water. This is also referred to as “loss of cohesion”, or post water mixing “pot-life.” The term can be used in assessing the time expected for placement, finishing, or pumping. When the set time is expired, the mixture is expected to be a solid or semi-solid and cannot be moved. Set time is not associated with thixotropic characteristics.

As used herein, the term “thickening time” refers to hydrocarbon well cements and the time expected until the water mixed cement will reach from 50 to 70 cpi (centipoise) during the standard Thickening Time test procedure as defined by the American Petroleum Institute. The thickening time requirements and duration will vary dependent upon the well cement application, pumping pressures, temperature, cement constituents, and mixing time.

As used herein, the term “transition time” refers to the time that the hydrocarbon well cement is considered to be resistant to gas migration or release.

As used herein, the term “Sodium Silicate” refers to the inorganic compound silica dioxide that is inherent to bauxite and digested by dissolution into the sodium hydroxide used in the Bayer Process. Sodium silicate has a chemical formula of Na₂OSiO₂.

As used herein, the term “Sodium Metasilicate” refers to the manmade anhydrous or pentahydrate granular powder compound with a chemical formula of Na₂SiO₃.

As used herein, the term “R-Value” refers to the test procedure and test results performed on soil and granular aggregate materials conducted in accordance with the ASTM D2844 Standard Test Method for Resistance R-Value and Expansion Pressure of Compacted Soils.

As used herein, the term California Bearing Ratio (CBR) refers to the test procedure and test results performed on soil and granular aggregate materials conducted in accordance with the ASTM D1883 Standard Test Method for California Bearing Ratio (CBR) of Laboratory-Compacted Soils.

As used herein, the term “lightweight filler materials” refers to the manmade or naturally occurring expanded minerals that have a loose density of from 0.1 to 25 pounds per cubic foot, have a maximum thermal conductivity of 30 W/m·K, and are fire resistant such as volcanic cinders, perlite, bottom ash, vermiculite, and other similar minerals used in the fire protection industry.

As used herein, the term “calcium sulfate” refers to the inorganic powder compound with the chemical formula CaSO₄ or CaSO₄·2H₂O, commonly referred to as gypsum.

As used herein, the term “activator or activators” consists of the low, medium, or highly alkaline materials utilized to force a strength development in pozzolanic materials. For the purpose intended, “strength activation” includes the development of any permanent compressive, tensile, or flexural strength.

As used herein, the term “retarding agent” or “set time retarders” refers to inorganic materials consisting of either tartaric acid, sodium tetraborate, boric acid, sodium citrate dihydrate, or other similar materials that extend the setting time of material combinations after water is added.

As used herein, the term “rheology and permeability adjusting copolymer or polymer” refers to soluble dry materials such as latex, vinyl acetate, polyvinyl alcohol, and other materials that when combined with water reduce the water and air permeability of mixtures, becomes a permanent feature of the mixture, and adjusts the rheological properties of mixtures after water additions.

As used herein, the term “aggregate/s” refers to any natural or synthetic aggregate that is crushed or rounded and useful as a filler in Portland, geopolymers, and pozzolan polymer types of concrete. Aggregates are a granular material, such as sand, gravel, crushed stone, and iron blast-furnace slag, used with a cementing medium to form a concrete or mortar. Aggregates may be lightweight, normal weight, or heavy weight. Aggregates with elevated carbon or boron-based chemicals can provide a nuclear shielding device.

As used herein, the term “red mud” refers to the alkaline residue left from the Bayer Process of extracting alumina from the Bauxite Mineral. The term “red mud” is sometimes referred to as “brown mud” or “bauxite residue”.

As used herein, when reference is made to stabilizing fine grained, granular, expansive, or compressible soils, it includes modifying the soils through the addition of Red mud Cement and the corresponding increase in resilient modulus, California Bearing Ratio (CBR), or R-value of stable or unstable soil, and granular sand and aggregate materials for the use of slope stability, roadway construction, or building construction purposes.

Unit weight or density is weight per unit volume of a cement slurry/cementitious composition. The units Ppg refers to pounds per US gallon. Unit weight may be determined in accordance with ASTM C138.

Compressive strength is calculated in accordance with ASTM C39 after various specified periods, e.g. after 8 hours, after 24 hours, after 28 days.

Static gel strength tests may be performed using a Fann Model 35 viscometer in accordance with API Recommended Practice 10B-2 (ISO 10426-2).

Unless indicated otherwise herein, the term “about” is intended to include values, e.g. weight percentages, proximate to the recited range that are equivalent in terms of the functionality of the individual ingredient, the composition, or the embodiment.

A person skilled in the art will recognize that, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range.

A person skilled in the art will recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of anyone or more of members of a recited group. Accordingly, provisos may apply to any of the disclosed categories or embodiments whereby anyone or more of the recited elements, species, or embodiments, may be excluded from such categories or embodiments, for example, as used in an explicit negative limitation.

### Examples

The following examples are included for purpose of illustration of certain aspects and aspects of the invention, and are not intended to limit the invention.

### 1/ Quick-Set Low Strength Concrete Compositions Comprising Aggregate Material

| Comparative Example # | 1 | 2 |
|---|---|---|
| Red Mud (Dried) | 98.0% | 96.0% |
| Gypsum | 2.0% | 1.0% |
| Concrete Mixtures | | |
| Mineral Aggregate | 65.0% | 65.0% |
| Red Mud Cement | 35.0% | 35.0% |
| Water to Cement Ratio | 0.50 | 0.50 |
| 2-HOUR STRENGTH, | 0.20 | 0.13 |
| Mpa | | |
| 28-DAY STRENGTH, | 0.38 | 0.30 |
| Mpa | | |
| SET TIME, Minutes | 43.3 | 63 |

| Example # | 1 | 2 | 3 | 4 |
|---|---|---|---|---|
| Red Mud (Dried) | 95.0% | 80.00% | 70.00% | 60.00% |
| Gypsum | 5.0% | 20.00% | 30.00% | 40.00% |
| Concrete Mixtures | | | | |
| Mineral Aggregate | 65.0% | 65.0% | 65.0% | 65.0% |
| Red Mud Cement | 35.0% | 35.0% | 35.0% | 35.0% |
| Water to Cement | 0.50 | 0.50 | 0.50 | 0.50 |
| Ratio | | | | |
| 2-HOUR | 0.58 | 1.67 | 2.47 | 6.38 |
| STRENGTH, Mpa | | | | |
| 28-DAY | 1.86 | 9.02 | 21.93 | 28.26 |
| STRENGTH, Mpa | | | | |
| SET TIME, | 28.1 | 8.99 | 8.01 | 6.28 |
| Minutes | | | | |

The quick-set low strength concrete comprising aggregate material of Comparative Examples 1 and 2 exhibited reduced 2-hour strength, reduced 28-day strength, and a longer set-time, compared to the Examples 1 to 4.

### 2/ Quick-Set Low Strength Concrete Compositions Comprising Aggregate Material and Set-Time RETARDER

| Comparative Example # | 1 | 2 |
|---|---|---|
| Red Mud (Dried) | 98.0% | 99.0% |
| Gypsum | 2.0% | 1.0% |

Concrete Mixtures

| | | |
|---|---|---|
| Mineral Aggregate | 59.0% | 59.0% |
| Retarder | 6.0% | 6.0% |
| Red Mud Cement | 35.0% | 35.0% |
| Water to Cement Ratio | 0.50 | 0.50 |
| 2-HOUR STRENGTH, Mpa | 0.11 | 0.01 |
| 28-DAY STRENGTH, Mpa | 0.19 | 0.07 |
| SET TIME, Minutes | 210 | 240 |

| Example # | 1 | 2 | 3 | 4 |
|---|---|---|---|---|
| Red Mud (Dried) | 95.0% | 80.00% | 70.00% | 60.00% |
| Gypsum | 5.0% | 20.00% | 30.00% | 40.00% |

Concrete Mixtures

| | | | | |
|---|---|---|---|---|
| Mineral | 59.0% | 59.0% | 59.0% | 59.0% |
| Aggregate | | | | |
| Retarder | 6.0% | 6.0% | 6.0% | 6.0% |
| Red Mud Cement | 35.0% | 35.0% | 35.0% | 35.0% |
| Water to Cement | 0.50 | 0.50 | 0.50 | 0.50 |
| Ratio | | | | |
| 2-HOUR | 0.44 | 1.21 | 2.06 | 4.11 |
| STRENGTH, Mpa | | | | |
| 28-DAY | 1.38 | 7.77 | 17.74 | 17.2 |
| STRENGTH, Mpa | | | | |
| SET TIME, | 119.3 | 36.8 | 28.3 | 17.2 |
| Minutes | | | | |

The quick-set low strength concrete comprising aggregate material and set-time retarder of Comparative Examples 1 and 2 exhibited reduced 2-hour strength, reduced 28-day strength, and a longer set-time, compared to the Examples 1 to 4.

### 3/ Quick-Set Well Cement (Tested at 37.78° C.)

| Comparative Example # | 1 | 2 |
|---|---|---|
| Red Mud (Dried) | 98.0% | 99.0% |
| Gypsum | 2.0% | 1.0% |

Concrete Mixtures

| | | |
|---|---|---|
| Red Mud Cement | 100% | 100% |
| Water to Cement Ratio | 0.90 | 0.50 |
| Thickening Time (50 cpi), | 390.0 | 443.0 |
| minutes | | |
| 8-HOUR STRENGTH, Mpa | 1.68 | 0.93 |
| 24-Hour Strength, Mpa | 7.78 | 2.48 |
| UNIT WEIGHT, pounds per | 9.1 | 8.8 |
| gallon | | |

| Example # | 1 | 2 | 3 | 4 |
|---|---|---|---|---|
| Red Mud (Dried) | 95.0% | 80.00% | 70.00% | 60.00% |
| Gypsum | 5.0% | 20.00% | 30.00% | 40.00% |

Concrete Mixtures

| | | | | |
|---|---|---|---|---|
| Red Mud Cement | 100.0% | 100.0% | 100.0% | 100.0% |
| Water to Cement | 0.50 | 0.50 | 0.50 | 0.50 |
| Ratio | | | | |
| Thickening Time | 272.6 | 181.1 | 128.7 | 69.3 |
| (50 cpi), minutes | | | | |
| 8-HOUR | 2.08 | 3.17 | 5.38 | 9.57 |
| STRENGTH, Mpa | | | | |
| 24-Hour Strength, | 13.85 | 20.62 | 25.31 | 33.66 |
| Mpa | | | | |
| UNIT WEIGHT, | 10.5 | 13.2 | 15.2 | 16.21 |
| pounds per gallon | | | | |

The quick-set well cement of Comparative Examples 1 and 2 exhibited increased thickening time, reduced 8-hour strength and reduced 24-hour strength compared to the Examples 1 to 4. The quick-set well cement of the Comparative Examples also exhibited a lower unit weight compared to Examples 1 to 4.

### 4a/ Lost Circulation Composition

| Comparative Example # | LC CE1 | LC CE2 |
|---|---|---|
| Red Mud (Dried) | 70% | 70% |
| Gypsum | 25% | 25% |
| Metasilicate | 4.8% | 4.8% |
| Pozzolan | 0% | 0% |
| Polymer | 0% | 0% |
| Dispersant | 0.2% | 0.2% |
| Zeolites | 0% | 0% |

Lost Circulation Composition

| | | |
|---|---|---|
| Red Mud Cement | 100% | 100% |
| Water to Cement Ratio | 0.5 | 0.95 |
| Thickening Time, | 3.1 | 6.1 |
| Hrs @ 37.78° C. | | |
| Thickening Time, | 1.9 | 5.2 |
| Hrs @ 60° C. | | |
| Thickening Time, | 0.45 | 3.8 |
| Hrs @ 104.4° C. | | |
| Unit Weight, ppg | 15.3 | 9.8 |
| 8 hour strength, MPa | 5.9 | 0.7 |
| 24 hour strength, MPa | 22.1 | 4.5 |

| Examples # | LC1 | LC2 | LC3 |
|---|---|---|---|
| Red Mud (Dried) | 70% | 60% | 58% |
| Gypsum | 25% | 20% | 10% |
| Metasilicate | 4.8% | 2.0% | 4.0% |
| Pozzolan | 0% | 15% | 25% |
| Polymer | 0% | 0.8% | 0.8% |
| Dispersant | 0.2% | 0.2% | 0.2% |
| Zeolites | 0% | 2.0% | 2.0% |

Lost Circulation Composition

| | | | |
|---|---|---|---|
| Red Mud Cement | 100% | 100% | 100% |
| Water to Cement Ratio | 0.56 | 0.75 | 0.85 |
| Thickening Time, | 4.1 | 3.1 | 4.6 |
| Hrs @ 37.78° C. | | | |
| Thickening Time, | 3.3 | 2.2 | 3.2 |
| Hrs @ 60° C. | | | |
| Thickening Time, | 2.1 | 1.8 | 2.2 |
| Hrs @ 104.4° C. | | | |
| Unit Weight, ppg | 14.8 | 12.2 | 10.9 |
| 8 hour strength, MPa | 4.4 | 1.2 | 1.5 |
| 24 hour strength, MPa | 17.8 | 7.6 | 22.1 |

Lost circulation composition example 1 (LCC1) is particularly suitable applications less than 6,000 feet deep with moderate to low subsurface temperatures. The composition is moderately thixotropic and has elevated compressive strength.
Lost circulation composition example 2 is particularly suitable for applications greater than 6,000 feet deep but less than 15,000 feet deep, with moderate to elevated. The additional water acts as a retarder, slowing down thickening. The composition is very thixotropic.
Lost circulation composition example 3 is designed for applications up to 30,000 feet deep. The elevated water acts as a retarder, and unit weight reduction for high pressure pumping. The composition is very thixotropic.
In lost circulation composition comparative example 1, the thickening times are too short. The composition is challenging to pump.
In lost circulation composition comparative example 2, the thickening time is too long, and the compressive strength of the set composition is low, rendering the composition less suitable for sealing off lost circulation zones.

### 4b/ Long String (LS) Primary Cementing

| Comparative Example # | LSCE1 | LSCE2 |
|---|---|---|
| Red Mud (Dried) | 60.00% | 60.00% |
| Gypsum | 10.00% | 10.00% |
| Metasilicate | 6.00% | 6.00% |
| Pozzolan | 18.40% | 18.40% |
| Polymer | 0.40% | 0.40% |
| Dispersant | 0.20% | 0.20% |
| Zeolites | 2.00% | 2.00% |
| Retarder | 3.00% | 3.00% |

Long String Composition

| | | |
|---|---|---|
| Red Mud Cement | 100% | 100% |
| Water to Cement Ratio | 0.5 | 0.9 |
| Thickening Time, | 1.10 | 7.20 |
| Hrs @ 37.78° C. | | |
| Thickening Time, | 0.68 | 5.50 |
| Hrs @ 60° C. | | |
| Thickening Time, | 0.22 | 4.3 |
| Hrs @ 104.4° C. | | |
| Unit Weight, ppg | 15.90 | 9.00 |
| 8 hour strength, MPa | 4.99 | 0.24 |
| 24 hour strength, MPa | 27.80 | 0.29 |

| Example # | LS1 | LS2 | LS3 | LS4 |
|---|---|---|---|---|
| Red Mud (Dried) | 60.00% | 60.00% | 60.00% | 60.00% |
| Gypsum | 10.00% | 10.00% | 10.00% | 10.00% |
| Metasilicate | 6.00% | 6.00% | 6.00% | 6.00% |
| Pozzolan | 18.40% | 18.40% | 18.40% | 18.40% |
| Polymer | 0.40% | 0.40% | 0.40% | 0.40% |
| Dispersant | 0.20% | 0.20% | 0.20% | 0.20% |
| Zeolites | 2.00% | 2.00% | 2.00% | 2.00% |
| Retarder | 3.00% | 3.00% | 3.00% | 3.00% |

Long String Composition

| | | | | |
|---|---|---|---|---|
| Red Mud Cement | 100% | 100% | 100% | 100% |
| Water to Cement | 0.55 | 0.65 | 0.75 | 0.85 |
| Ratio | | | | |
| Thickening Time, | 1.80 | 2.20 | 3.40 | 5.10 |
| Hrs @ 37.78° C. | | | | |
| Thickening Time, | 1.20 | 1.65 | 2.16 | 3.00 |
| Hrs @ 60° C. | | | | |
| Thickening Time, | 0.78 | 1.1 | 1.55 | 2.04 |
| Hrs @ 104.4° C. | | | | |
| Unit Weight, ppg | 15.00 | 13.80 | 12.40 | 10.50 |
| 8 hour strength, | 3.86 | 2.10 | 1.33 | 0.75 |
| MPa | | | | |
| 24 hour strength, | 19.31 | 11.59 | 8.28 | 5.17 |
| MPa | | | | |

Long string (LS) example 1 (LS1) is particularly suitable for shallow casing (less than 6,000 feet deep), with low subsurface temperatures.
LS2 is particularly suitable for casing greater than 6,000 feet and up to 12,000 feet, with moderate to low subsurface temperatures.
LS3 is particularly suitable for casing greater than 12,000 feet but less than 20,000 feet with moderate to high subsurface temperatures and elevating pumping pressures.
LS4 is particularly suitable for casing greater than 20,000 feet with high subsurface temperatures and high pumping pressure.
LS comparative example 1 (LSCE1) has a lower water content, and thickening time is too short. The composition is difficult to pump.
LSCE2 has an increased water content and thickening times are excessive. The strength is too low for primary cementing.

### 4c/ Plug And Abandonment

| Comparative Example # | PA CE1 | PA CE2 |
|---|---|---|
| Red Mud (Dried) | 98.00% | 55.00% |
| Gypsum | 2.00% | 20.00% |
| Metasilicate | 0.00% | 7.80% |
| Pozzolan | 0.00% | 15.00% |
| Polymer | 0.00% | 0.00% |
| Dispersant | 0.00% | 0.20% |
| Zeolites | 0.00% | 2.00% |
| Retarder | 0.00% | 0.00% |

P&A Compositions

| | | |
|---|---|---|
| Red Mud Cement | 100% | 100% |
| Water to Cement Ratio | 0.9 | 0.56 |
| Thickening Time, | 6.50 | 1.50 |
| Hrs @ 37.78° C. | | |
| Thickening Time, | 5.80 | 34.00 |
| Hrs @ 60° C. | | |
| Thickening Time, | N/A | N/A |
| Hrs @ 104.4° C. | | |
| Unit Weight, ppg | 9.10 | 14.70 |
| 8 hour strength, MPa | 1.68 | 9.20 |
| 24 hour strength, MPa | 7.78 | 35.50 |

| Example # | PA1 | PA2 | PA3 | PA4 |
|---|---|---|---|---|
| Red Mud (Dried) | 80.00% | 70.00% | 60.00% | 50.00% |
| Gypsum | 20.00% | 30.00% | 15.00% | 32.80% |
| Metasilicate | 0.00% | 0.00% | 3.00% | 0.00% |
| Pozzolan | 0.00% | 0.00% | 19.80% | 15.00% |
| Polymer | 0.00% | 0.00% | 0.00% | 0.00% |
| Dispersant | 0.00% | 0.00% | 0.20% | 0.20% |
| Zeolites | 0.00% | 0.00% | 2.00% | 2.00% |
| Retarder | 0.00% | 0.00% | 0.00% | 0.00% |

PA Composition

| | | | | |
|---|---|---|---|---|
| Red Mud Cement | 100% | 100% | 100% | 100% |
| Water to Cement | 0.50 | 0.50 | 0.56 | 0.56 |
| Ratio | | | | |
| Thickening Time, | 3.02 | 2.14 | 2.10 | 1.70 |
| Hrs @ 37.78° C. | | | | |
| Thickening Time, | 1.75 | 1.20 | 1.18 | 0.85 |
| Hrs @ 60° C. | | | | |
| Thickening Time, | N/A | N/A | N/A | N/A |
| Hrs @ 104.4° C. | | | | |
| Unit Weight, ppg | 13.20 | 15.20 | 14.70 | 14.20 |
| 8 hour strength, | 3.17 | 5.38 | 5.51 | 5.02 |
| MPa | | | | |
| 24 hour strength, | 20.62 | 25.31 | 25.44 | 23.11 |
| MPa | | | | |

PA1 is particularly suitable for deep plugs in excess of 6,000 feet deep but less deep than 15,000 feet with moderate to elevated subsurface temperatures. The unit weight is lower for higher pressure pumping at greater depths.
PA2 is particularly suitable for shallow plugs less than 6,000 feet deep with low subsurface temperatures.
PA3 is particularly suitable for shallow plugs less than 6,000 feet deep with low subsurface temperatures. The higher water content acts as a retarder and reduces the unit weight.
PA4 is particularly suitable for near surface plugs of less than 3,000 feet deep with low subsurface temperatures.
PA CE1 has an elevated water content which reduces compressive strength and causes increased thickening time.
PA CE2 has an elevated metasilicate content which reduces thickening time, and the composition is very difficult to pump.
Advantageously, the compositions disclosed herein are particularly suitable for plug and abandonment application in oil and gas wells. The compositions disclosed herein advantageously do not comprise Portland cement and therefore have a lower carbon footprint, as well as offering excellent mechanical strength, good pumpability, low shrinkage and enhanced durability. Furthermore, the compositions disclosed herein are resistant to corrosion and can be employed at a variety of depths, temperatures and pressures in subterranean formations.

### 5/ Quick-Set Self-Levelling Concrete Compositions

| Comparative Example # | 1 | 2 |
|---|---|---|
| Red Mud (Dried) | 51.7% | 51.7% |
| Gypsum | 10.1% | 10.1% |
| Sodium metasilicate | 10.1% | 10.1% |
| Pozzolans | 28.2% | 28.2% |

Concrete Mixtures

| | | |
|---|---|---|
| Mineral Aggregate-Sand | 34.0% | 34.0% |
| Red Mud Cement | 66.0% | 66.0% |
| Water to Cement Ratio | 0.70 | 0.60 |
| 2-HOUR STRENGTH, Mpa | 1.03 | 2.21 |
| 28-DAY STRENGTH, Mpa | 18.65 | 22.16 |
| SET TIME, Minutes | 243 | 168 |

| Example # | 1 | 2 | 3 | 4 |
|---|---|---|---|---|
| Red Mud (Dried) | 39.2% | 51.67% | 40.25% | 29.91% |
| Gypsum | 20.6% | 10.07% | 20.59% | 42.25% |
| Sodium | 14.4% | 10.07% | 10.30% | 12.37% |
| metasilicate | | | | |
| Pozzolans | 25.8% | 28.18% | 28.86% | 15.47% |

Concrete Mixtures

| | | | | |
|---|---|---|---|---|
| Mineral | 68.7% | 34.0% | 33.9% | 68.7% |
| Aggregate-Sand | | | | |
| Red Mud Cement | 31.3% | 66.0% | 66.1% | 31.3% |
| Water to Cement | 0.41 | 0.43 | 0.43 | 0.50 |
| Ratio | | | | |
| 2-HOUR | 5.87 | 15.26 | 16.62 | 5.25 |
| STRENGTH, Mpa | | | | |
| 28-DAY | 28.02 | 52.04 | 57.17 | 24.81 |
| STRENGTH, Mpa | | | | |
| SET TIME, | 58.88 | 57.95 | 41.36 | 64 |
| Minutes | | | | |

The quick-set self-levelling compositions of Comparative Examples 1 and 2 exhibited reduced 2-hour strength, reduced 28-day strength, and a longer set-time, compared to the Examples 1 to 4.

### 6/ Exemplary Concrete Compositions for Fire-Proofing Applications

| Example # | 1 | 2 | 3 | 4 | 5 |
|---|---|---|---|---|---|
| Red Mud (Dried) | 50.0% | 40.00% | 45.00% | 45.00% | 49.0% |
| Gypsum | 10.0% | 6.00% | 10.00% | 10.00% | 11.0% |
| Sodium | 10.0% | 6.00% | 10.00% | 10.00% | 11.0% |
| metasilicate | | | | | |
| Pozzolan | 24.5% | 18.50% | 29.50% | 29.50% | 24.5% |
| Zeolite | 2.5% | 2.50% | 2.50% | 2.50% | 2.5% |
| Retarder | 3.0% | 3.00% | 3.00% | 3.00% | 3.0% |

Concrete Mixtures

| | | | | | |
|---|---|---|---|---|---|
| Lightweight Filler | 34.5% | 73.90% | 6.20% | 3.20% | 8.40% |
| Concrete Sand | 0.0% | 0.00% | 54.10% | 50.50% | 0.00% |
| Red Mud Cement | 65.5% | 26.10% | 39.70% | 46.30% | 91.60% |
| Water to Cement | 0.75 | 0.89 | 0.43 | 0.41 | 0.67 |
| Ratio | | | | | |
| LIGHTWEIGHT | 0.32 | 0.32 | 0.32 | 0.32 | 0.32 |
| FILLER SPECIFIC | | | | | |
| GRAVITY | | | | | |
| CONCRETE SAND | N/A | N/A | 2.71 | 2.71 | N/A |
| SPECIFIC | | | | | |
| GRAVITY | | | | | |
| 7-DAY | 15.17 | 1.38 | 20.7 | 25.05 | 23.88 |
| STRENGTH, Mpa | | | | | |
| 28-DAY | 31.92 | 3.45 | 36.48 | 43.38 | 36.24 |
| STRENGTH, Mpa | | | | | |
| COEFFICIENT OF | 2.4 × 10⁻⁶/° F. | 1.1 × 10⁻⁶/° F. | 4.1 × 10⁻⁶/° F. | 5.7 × 10⁻⁶/° F. | 3.1 × 10⁻⁶/° F. |
| THERMAL | | | | | |
| EXPANSION | | | | | |
| THERMAL | 0.29 | 0.11 | 0.54 | 0.62 | 0.37 |
| CONDUCTIVITY, | | | | | |
| (W/m · K) | | | | | |
| 28-DAY | −0.0002% | −0.0009% | 0.0009% | 0.0025% | −0.0002% |
| SHRINKAGE, % | | | | | |
| EQUILIBRIUM | 43.2 | 16.2 | 84.7 | 102.6 | 71.6 |
| UNIT WEIGHT, pcf | | | | | |
| SET TIME, | 48.3 | 124.4 | 48.8 | 55.5 | 41.1 |
| Minutes | | | | | |

25 mm Applied to W10 X 49

| | | | | | |
|---|---|---|---|---|---|
| UL263 | 5 | 5 | 2.5 | 2 | 4 |
| Time/Temperature | | | | | |
| Curve, hrs | | | | | |
| UL1709 | 4 | 4 | 1.5 | 1 | 3 |
| Time/Temperature | | | | | |
| Curve, hrs | | | | | |

### 7/ Exemplary Concrete Compositions Comprising Soil, or the Combination of Soil and Aggregate Material

| | | | | | |
|---|---|---|---|---|---|
| Example # | 1 | 2 | 3 | 4 | 5 |

Red Mud Cement

| | | | | | |
|---|---|---|---|---|---|
| Red Mud (Dried) | 50.0% | 50.0% | 50.0% | 50.0% | 50.0% |
| Gypsum | 10.0% | 10.00% | 10.00% | 10.00% | 10.0% |
| Sodium | 10.0% | 10.00% | 10.00% | 10.00% | 10.0% |
| metasilicate | | | | | |
| Pozzolan | 24.5% | 24.5% | 24.5% | 24.5% | 24.5% |

SOIL OR AGGREGATE COMBINATION UNTREATED CHARACTERISTICS

| | | | | | |
|---|---|---|---|---|---|
| CLASSIFICATION | A-1-a | A-1-b | A-2-4 | A-4 | A-7-5 |
| (AASHTO) | | | | | |
| LIQUID LIMIT | NON- | NON- | 28 | 49 | 71 |
| | ATTAINABLE | ATTAINABLE | | | |
| PLASTICITY INDEX | NON- | NON- | 5 | 9 | 62 |
| | PLASTIC | PLASTIC | | | |
| ASTM D698 | 138.9 | 131.9 | 124.6 | 111.3 | 88.4 |
| MAXIMUM | | | | | |
| DENSITY, pcf | | | | | |
| ASTM D698 | 6.2 | 8.3 | 9.9 | 22.8 | 53.3 |
| OPTIMUM | | | | | |
| MOISTURE, pcf | | | | | |
| DESCRIPTION | BASE | SANDY SOIL | CLAYEY | SILTY | CLAY |
| | COURSE | | SAND & | SAND | |
| | | | GRAVEL | W/CLAY | |
| UNTREATED | 90 | 76 | 42 | 8 | 2 |
| R-VALUE | | | | | |

SOIL OR AGGREGATE COMBINATION TREATED CHARACTERISTICS

| | | | | | |
|---|---|---|---|---|---|
| TREATMENT | 1.5 | 1.5 | 1.5 | 3 | 3 |
| CONCENTRATION, | | | | | |
| % | | | | | |
| LIQUID LIMIT | NON- | NON- | NON- | 22 | 34 |
| | ATTAINABLE | ATTAINABLE | ATTAINABLE | | |
| PLASTICITY INDEX | NON- | NON- | NON- | NON- | 7 |
| | PLASTIC | PLASTIC | PLASTIC | PLASTIC | |
| COMPRESSIVE | 8.70 | 9.11 | 5.17 | 3.59 | 1.39 |
| STRENGTH, Mpa | | | | | |
| TREATED R-VALE | 90 | 90 | 90 | 90 | 62 |
| TREATMENT | 3 | 3 | 3 | 5 | 7 |
| CONCENTRATION, | | | | | |
| % | | | | | |
| LIQUID LIMIT | NON- | NON- | NON- | NON- | NON- |
| | ATTAINABLE | ATTAINABLE | ATTAINABLE | ATTAINABLE | ATTAINABLE |
| PLASTICITY INDEX | NON- | NON- | NON- | NON- | NON- |
| | PLASTIC | PLASTIC | PLASTIC | PLASTIC | PLASTIC |
| COMPRESSIVE | 15.71 | 14.88 | 11.66 | 7.05 | 4.74 |
| STRENGTH, Mpa | | | | | |
| TREATED R-VALE | 90 | 90 | 90 | 90 | 90 |

### 8/ Exemplary Strengthened Concrete Compositions

| Example # | 1 | 2 | 3 | 4 | 5 |
|---|---|---|---|---|---|
| Red Mud (Dried) | 55.4% | 49.50% | 57.70% | 57.70% | 47.0% |
| Gypsum | 5.0% | 15.00% | 7.50% | 7.50% | 5.0% |
| Sodium metasilicate | 10.0% | 8.00% | 10.00% | 10.00% | 12.0% |
| Pozzolan | 25.1% | 20.00% | 15.00% | 15.00% | 30.3% |
| Zeolite | 2.5% | 2.50% | 2.50% | 2.50% | 2.5% |
| Retarder | 2.0% | 5.00% | 7.25% | 7.25% | 3.2% |

Concrete Mixtures

| | | | | | |
|---|---|---|---|---|---|
| Mineral Aggregate | 75.3% | 75.30% | 75.30% | 82.50% | 75.30% |
| Red Mud Cement | 24.7% | 24.70% | 24.70% | 17.50% | 24.70% |
| Water to Cement Ratio | 0.23 | 0.29 | 0.25 | 0.25 | 0.22 |
| COARSE AGGREGATE | 2.64 | 2.64 | 2.64 | 2.64 | 2.64 |
| SPECIFIC GRAVITY | | | | | |
| FINE AGGREGATE SPECIFIC | 2.61 | 2.61 | 2.61 | 2.61 | 2.61 |
| GRAVITY | | | | | |
| COARSE AGGREGATE | 0.88 | 0.88 | 0.88 | 0.88 | 0.88 |
| ABSORPTION, % | | | | | |
| FINE AGGREGATE | 0.70% | 0.70% | 0.70% | 0.70% | 0.70% |
| ABSORPTION, % | | | | | |
| FINE AGGREGATE FINENESS | 2.68 | 2.68 | 2.68 | 2.68 | 2.68 |
| MODULUS | | | | | |
| COARESENESS FACTOR | 63 | 63 | 63 | 63 | 63 |
| WORKABILITY FACTOR | 38 | 38 | 38 | 38 | 38 |
| SLUMP, MM | 156.25 | 168.75 | 187.5 | 168.75 | 150 |
| 7-DAY STRENGTH, Mpa | 27.22 | 24.89 | 30.11 | 13.73 | 39.31 |
| 28-DAY STRENGTH, Mpa | 68.59 | 68.22 | 71.95 | 32.03 | 76.41 |
| COEFFICIENT OF THERMAL | 5.8 × 10−6 | 6.4 × 10−6 | 6.7 × 10−6 | 5.4 × 10−6 | 6.8 × 10−6 |
| EXPANSION | in/° F. | in/° F. | in/° F. | in/° F. | in/° F. |
| 28-DAY SHRINKAGE, % | 0.0002% | 0.0007% | 0.0012% | 0.0025% | 0.0002% |
| SET TIME, Minutes | 112.8 | 72.6 | 171 | 185.1 | 128.3 |

### Embodiments

1. A method of cementing comprising:
providing a geopolymer cement composition comprising:
a cement component and water,
wherein the cement component comprises red mud and gypsum and optionally additives wherein the additives are present in no more than 50 wt % based on the total weight of the cement component,
wherein the red mud is present in an amount of from 40 wt % to 95 wt % and the gypsum is present in an amount of 5 wt % to 50 wt % based ion the total weight of the cement component, optionally wherein the geopolymer cement composition has a unit weight (or density) in the range of from 10 (1198 kg/m³) ppg to 25 ppg, optionally from 10 ppg (1198 kg/m³) to 20 ppg (2396 kg/m³),
introducing the geopolymer cement composition into a subterranean formation; and allowing the geopolymer cement composition to set in the subterranean formation.
   2. The method of embodiment 1, wherein the red mud is present in an amount of from 45 wt % to 90 wt %, such as from 50 wt % to 75 wt % based on the total weight of the cement component, optionally, wherein the red mud is present in an amount of from 55 wt % to 72 wt %, such as from 57 wt % to 71 wt % based on the total weight of the cement component.
   3. The method of embodiment 1 or 2, wherein the gypsum is present in an amount of from 5 wt % to 35 wt %, such as from 5 wt % to 30 wt % based on the total weight of the cement component, optionally, wherein the gypsum is present in an amount of from 8 wt % to 28 wt %, such as from 9 wt % to 26 wt % based on the total weight of the cement component.
   4. The method of any preceding embodiment, wherein the cement component comprises additives, and wherein the additives comprise one or more of pozzolan, polymer, dispersant, zeolites, metasilicate and retarder.
   5. The method of embodiment 4, wherein the additives comprise pozzolan, optionally, wherein the pozzolan is present in an amount of from 5 wt % to 50 wt % such as from 10 wt % to 30 wt % based on the total weight of the cement component.
   6. The method of embodiment 4 or 5, wherein the additives comprise polymer, optionally, wherein the polymer is present in an amount of from 0.2 wt % to 2 wt % based on the total weight of the cement component.
   7. The method of any one of embodiments 4 to 6, wherein the additives comprise metasilicate, optionally, wherein the metasilicate is present in an amount of from 1 wt % to 12 wt %, such as from 1 wt % to 8 wt %, optionally from 2 wt % to 7 wt % based on the total weight of the cement component.
   8. The method of any one of embodiments 4 to 7, wherein the additives comprise zeolites, optionally, wherein the zeolites are present in an amount of from 0.1 wt % to 10 wt %, such as from 0.1 wt % to 5 wt % based on the total weight of the cement component.
   9. The method of any one of embodiments 4 to 8, wherein the additives comprise dispersant, optionally, wherein the dispersant is present in an amount of from 0.15 to 5 wt % based on the total weight of the cement component.
   10. The method of any one of embodiments 4 to 9, wherein the additives comprise retarder, optionally, wherein the retarder is present in an amount of from 0.1 wt % to 30 wt %, such as from 0.1 wt % to 10 wt %, such as from 0.1 wt % to 5 wt % based on the total weight of the cement component.
   11. The method of any preceding embodiment, wherein the water to cement ratio is in the range of from 0.4 to 0.9, optionally from 0.5 to 0.9, such as from 0.55 to 0.85.
   12. The method of any preceding embodiment, wherein the lost circulation cement composition has a unit weight in the range of from 10 ppg (1198 kg/m³) to 20 ppg (2396 kg/m³), optionally from 10 ppg (1198 kg/m³) to 17 ppg (2037 kg/m³) as determined in accordance with ASTM C138.
   13. A method of servicing a subterranean formation having one or more lost circulation zones, comprising:
introducing a lost circulation composition into a lost circulation zone,
the lost circulation composition comprising a cement component and water; and allowing the lost circulation composition to set in the lost circulation zone, wherein the cement component comprises: red mud and gypsum and optionally additives, wherein the additives are present in no more than 50 wt % based on the total weight of the cement component,
wherein the red mud is present in an amount of from 40 wt % to 95 wt % and the gypsum is present in an amount of 5 wt % to 50 wt % based ion the total weight of the cement component, optionally wherein the lost circulation cement composition has a unit weight (or density) in the range of from 10 ppg to 25 ppg, optionally from 10 ppg to 20 ppg, and
allowing the lost circulation composition to set in the lost circulation zone.
   14. The method of embodiment 13, wherein the red mud is present in an amount of from about 50 wt % to 75 wt % based on the total weight of the cement component, optionally, wherein the red mud is present in an amount of from 55 wt % to 72 wt %, such as from 57 wt % to 71 wt % based on the total weight of the cement component.
   15. The method of embodiment 13 or 14, wherein the gypsum is present in an amount of from 5 wt % to 30 wt % based on the total weight of the cement component, optionally, wherein the gypsum is present in an amount of from 8 wt % to 28 wt %, such as from 9 wt % to 26 wt % based on the total weight of the cement component.
   16. The method of any one of embodiments 13 to 15, wherein the lost circulation cement composition has a unit weight in the range of from 10 ppg (1198 kg/m³) to 15 ppg (1797 kg/m³).
   17. The method of any one of embodiments 13 to 16, wherein the lost circulation composition has a compressive strength after 24 hours in the range of from 7 MPa to 21 MPa in accordance with ASTM C39, optionally wherein the compressive strength after 24 hours is in the range of from 10 MPa to 20 MPa.
   18. The method of any one of embodiments 13 to 17, wherein the water to cement ratio is in the range of from 0.5 to 0.9, such as from 0.55 to 0.85.
   19. The method of any one of embodiments 13 to 18, wherein the lost circulation composition has a thickening time at 37.8° C. in the range of from 2.5 hours to 5 hours.
   20. The method of any one of embodiments 13 to 19, wherein the lost circulation composition has a 10-second static gel strength of at least about 15 lbf/100 ft² (7.18 N/m²) at room temperature, and wherein the lost circulation composition has a 10 minute static gel strength of at least about 25 lbf/100 ft² (11.97 N/m²) at room temperature.
   21. The method of any one of embodiments 13 to 20, wherein the additives comprise one or more of pozzolan, polymer, dispersant, zeolites, metasilicate and retarder.
   22. The method of embodiment 21, wherein the additives comprise pozzolan, optionally, wherein the pozzolan is present in an amount of 1 wt % to 30 wt % based on the total weight of the cement component.
   23. The method of embodiment 21 or 22, wherein the additives comprise polymer optionally, wherein the polymer is present in an amount of from 0.01 wt % to 2 wt %, such as from 0.01 wt % to 1 wt % based on the total weight of the cement component.
   24. The method of any one of embodiments 21 to 23, wherein the additives comprise metasilicate, optionally, wherein the metasilicate is present in an amount of from 1 wt % to 12 wt % such as in an amount of from about 1 wt % to 8 wt %, suitably from 1.5 wt % to 6 wt % based on the total weight of the cement component.
   25. The method of any one of embodiments 21 to 24, wherein the additives comprise zeolites, optionally, wherein the zeolites are present in an amount of from 0.1 wt % to 10 wt %, such as in an amount of from 0.1 wt % to 5 wt %, optionally, from 0.1 wt % to 1 wt % based on the total weight of the cement component.
   26. The method of any one of embodiments 21 to 25, wherein the additives comprise dispersant, optionally, wherein the dispersant is present in an amount of from 0.1 wt % to 5 wt %, such as in an amount of from 0.1 wt % to 1 wt %, optionally from 0.1 wt % to 0.5 wt % based on the total weight of the cement component.
   27. The method of any one of embodiments 21 to 26, wherein the additives comprise retarder, optionally, wherein the retarder is present in an amount of from 0.1 wt % to 30 wt %, such as from 1 wt % to 10 wt %, optionally from 1 wt % to 5 wt % based on the total weight of the cement component.
   28. A method for cementing comprising providing a geopolymer cement composition comprising:
a cement component and water,
wherein the cement component comprises red mud and gypsum and optionally additives wherein the additives are present in no more than 50 wt % based on the total weight of the cement component,
wherein the red mud is present in an amount of from 50 wt % to 75 wt % and the gypsum is present in an amount of 5 wt % to 20 wt % based ion the total weight of the cement component, optionally wherein the geopolymer cement composition has a unit weight (or density) in the range of from 10 ppg to 20 ppg, such as from 10 ppg to 15.5 ppg,
introducing the geopolymer cement composition into a wellbore annulus in a subterranean formation during a primary cementing operation; and
allowing the geopolymer cement composition to set in the subterranean formation.
   29. The method of embodiment 28, wherein the red mud is present in an amount of from about 52 wt % to 72 wt % based on the total weight of the cement component, optionally, wherein the red mud is present in an amount of from 55 wt % to 72 wt %, such as from 55 wt % to 65 wt % based on the total weight of the cement component.
   30. The method of embodiment 28 or 29, wherein the gypsum is present in an amount of from 5 wt % to 30 wt % based on the total weight of the cement component, optionally, wherein the gypsum is present in an amount of from 5 wt % to 25 wt %, such as from 7 wt % to 20 wt % based on the total weight of the cement component.
   31. The method of any one of embodiments 28 to 30, wherein the geopolymer cement composition has a unit weight in the range of from 10 ppg to 15 ppg.
   32. The method of any one of embodiments 28 to 31, wherein the geopolymer cement composition has a 24 hour compressive strength in the range of from 4 MPa to 24 MPa.
   33. The method of embodiment 28 to 32, wherein the geopolymer cement composition has a thickening time at 37.8° C. of from 0.5 hours to 3.5 hours.
   34. The method of any one of embodiments 28 to 31, wherein the additives comprise one or more of pozzolan, polymer, dispersant, zeolites, metasilicate and retarder.
   35. The method of embodiment 34, wherein the additives comprise pozzolan, optionally, wherein the pozzolan is present in an amount of 1 wt % to 35 wt % based on the total weight of the cement component, optionally, wherein the pozzolan is present in an amount of from about 10 to 30 wt %, such as from about 15 wt % to 25 wt % based on the total weight of the cement component.
   36. The method of embodiment 34 or 35, wherein the additives comprise polymer optionally, wherein the polymer is present in an amount of from 0.01 wt % to 2 wt %, such as from 0.01 wt % to 1 wt % based on the total weight of the cement component.
   37. The method of any one of embodiments 34 to 36, wherein the additives comprise metasilicate, optionally, wherein the metasilicate is present in an amount of from 1 wt % to 12 wt % such as in an amount of from about 1 wt % to 10 wt %, suitably from 2 wt % to 8 wt % based on the total weight of the cement component.
   38. The method of any one of embodiments 34 to 37, wherein the additives comprise zeolites, optionally, wherein the zeolites are present in an amount of from 0.1 wt % to 10 wt %, such as in an amount of from about 0.5 wt % to 5 wt %, such as from 1 to 4 wt % based on the total weight of the cement component.
   39. The method of any one of embodiments 34 to 38, wherein the additives comprise dispersant, optionally, wherein the dispersant is present in an amount of from 0.1 wt % to 5 wt %, such as in an amount of from about 0.1 wt % to 1 wt %, optionally from 0.1 wt % to 0.5 wt % based on the total weight of the cement component.
   40. The method of any one of embodiments 34 to 39, wherein the additives comprise retarder, optionally, wherein the retarder is present in an amount of from 0.1 wt % to 30 wt %, such as from 1 wt % to 10 wt %, such as from 1 to 5 wt % based on the total weight of the cement component.
   41. The method of any one of embodiments 34 to 40, wherein the water to cement ratio is in the range of from 0.5 to 0.9, such as from 0.52 to 0.88, optionally from 0.55 to 0.85.
   42. A method of plugging a wellbore, comprising providing a geopolymer cement composition comprising:
a cement component and water,
wherein the cement component comprises red mud and gypsum and optionally additives wherein the additives are present in no more than 50 wt % based on the total weight of the cement component,
wherein the red mud is present in an amount of from 40 wt % to 95 wt % and the gypsum is present in an amount of 5 wt % to 50 wt % based ion the total weight of the cement component, optionally wherein the geopolymer cement composition has a unit weight (or density) in the range of from 10 ppg to 20 ppg, such as from 10 ppg to 17 ppg;
introducing the geopolymer cement composition into the wellbore; and allowing the geopolymer cement composition to set in the wellbore.
   43. The method of embodiment 42, wherein the red mud is present in an amount of from about 45 wt % to 90 wt % based on the total weight of the cement component, optionally, wherein the red mud is present in an amount of from 48 wt % to 88 wt %, such as from 50 wt % to 85 wt % based on the total weight of the cement component.
   44. The method of embodiment 42 or 43, wherein the gypsum is present in an amount of from 10 wt % to 40 wt % based on the total weight of the cement component, optionally, wherein the gypsum is present in an amount of from 15 wt % to 35 wt %, such as from 15 wt % to 30 wt % based on the total weight of the cement component.
   45. The method of any one of embodiments 42 to 44, wherein the geopolymer cement composition has a 24 hour compressive strength in the range of from 13 MPa to 34 MPa, suitably in the range of from 18 MPa to 30 MPa.
   46. The method of any one of embodiments 42 to 45, wherein the geopolymer cement composition has a thickening time at 37.8° C. of from 1 hour to 5 hours.
   47. The method of any one of embodiments 42 to 46, wherein the cement component comprises additives, and wherein the additives comprise one or more of pozzolan, polymer, dispersant, zeolites, metasilicate and retarder.
   48. The method of embodiment 47, wherein the additives comprise pozzolan, optionally, wherein the pozzolan is present in an amount of 1 wt % to 35 wt % based on the total weight of the cement component, optionally, wherein the pozzolan is present in an amount of from about 10 to 30 wt %, such as from about 15 wt % to 25 wt % based on the total weight of the cement component.
   49. The method of embodiment 47 or 48, wherein the additives comprise polymer optionally, wherein the polymer is present in an amount of from 0.01 wt % to 2 wt %, such as from 0.01 wt % to 1 wt % based on the total weight of the cement component.
   50. The method of any one of embodiments 47 to 49, wherein the additives comprise metasilicate, optionally, wherein the metasilicate is present in an amount of from 1 wt % to 12 wt % such as in an amount of from about 1 wt % to 10 wt %, suitably from 1 wt % to 6 wt % based on the total weight of the cement component.
   51. The method of any one of embodiments 47 to 50, wherein the additives comprise zeolites, optionally, wherein the zeolites are present in an amount of from 0.1 wt % to 10 wt %, such as in an amount of from about 0.5 wt % to 5 wt %, such as from 1 to 4 wt % based on the total weight of the cement component.
   52. The method of any one of embodiments 47 to 51, wherein the additives comprise dispersant, optionally, wherein the dispersant is present in an amount of from 0.1 wt % to 5 wt %, such as in an amount of from about 0.1 wt % to 0.5 wt % based on the total weight of the cement component.
   53. The method of any one of embodiments 47 to 52, wherein the additives comprise retarder, optionally, wherein the retarder is present in an amount of from 0.1 wt % to 30 wt %, such as from 0.1 wt % to 10 wt %, such as from 1 to 5 wt % based on the total weight of the cement component.
   54. The method of any one of embodiments 42 to 53, wherein the wherein the water to cement ratio is in the range of from 0.3 to 0.7, such as from 0.4 to 0.6.
   55. A method for preparing method of preparing a cement composition comprising combining:
(a) red mud; and
(b) gypsum;
to provide a cement composition, wherein the red mud is present in an amount of from 40 wt % to 65 wt % based on the total weight of the cement composition, and wherein the gypsum is present in an amount of from 5 wt % to 25 wt % based on the total weight of the cement composition;
said composition further comprising:
pozzolan in an amount of from 10 to 35 wt % based on the total weight of the cement composition,
metasilicate in an amount of from 2 to 20 wt %, such as from 4 wt % to 18 wt %, from 6 wt % to 16 wt % based on the total weight of the cement composition.
   56. The method of embodiment 55, wherein the red mud is present in an amount of from 45 wt % to 60 wt %, such as from 47 wt % to 58 wt % based on the total weight of the cement composition.
   57. The method of embodiment 55 or 56, wherein the gypsum is present in an amount of from 5 wt % to 20 wt %, such as from 5 wt % to 15 wt % based on the total weight of the cement composition.
   58. The method of any one of embodiments 55 to 57, wherein the pozzolan is present in an amount of from 15 wt % to 32 wt %, optionally from 20 wt % to 25 wt % based on the total weight of the cement composition.
   59. The method of embodiment 58, wherein the pozzolan is selected from the group comprising carbide slag, granulated ground blast furnace slag, fly ash, attapulgite, kaolin, zeolites, and ground waste glass.
   60. The method according to any one of embodiments 55 to 59, wherein the cement composition further comprises metasilicate, optionally in an amount of from 2 to 20 wt %, such as from 4 wt % to 18 wt %, from 6 wt % to 16 wt %, optionally from 8 wt % to 12 wt % based on the total weight of the cement composition, optionally, wherein the metasilicate is sodium metasilicate or sodium metasilicate pentahydrate.
   61. The method according to any one of embodiments 55 to 60, wherein the cement composition further comprises zeolite, optionally in an amount of from 1 to 5 wt % based on the total weight of the cement composition.
   62. The method according to any one of embodiments 55 to 61, wherein the cement composition further comprises a retarder, optionally, wherein the retarder is selected from the group consisting of: sodium tetraborate; tartaric acid; boric acid; sodium citric dehydrate and citric acid, further optionally, wherein the retarder is present in an amount of from 1 wt % to 20 wt % of the cement composition.
   63. A method for forming a cementitious composition comprising a cement composition with water, optionally, wherein the water to cement ratio ranges from 0.10 to 0.9, wherein the cement composition comprises:
(a) red mud; and
(b) gypsum;
wherein the red mud is present in an amount of from 40 wt % to 65 wt % based on the total weight of the cement composition, and wherein the gypsum is present in an amount of from 5 wt % to 25 wt % based on the total weight of the cement composition;
said cement composition further comprising:
pozzolan in an amount of from 10 to 35 wt % based on the total weight of the cement composition,
metasilicate in an amount of from 2 to 20 wt %, such as from 4 wt % to 18 wt %, from 6 wt % to 16 wt % based on the total weight of the cement composition.
   64. The method of embodiment 63, wherein the cementitious composition is allowed to set.
   65. A cementitious composition formed by the method of embodiment 63 or 64.
   66. A method of forming a concrete composition comprising combining a cement composition with aggregate material and water to form the concrete composition, wherein the cement composition comprises:
(a) red mud; and
(b) gypsum;
wherein the red mud is present in an amount of from 40 wt % to 65 wt % based on the total weight of the cement composition, and wherein the gypsum is present in an amount of from 5 wt % to 25 wt % based on the total weight of the cement composition;
said cement composition further comprising:
pozzolan in an amount of from 10 to 35 wt % based on the total weight of the cement composition,
metasilicate in an amount of from 2 to 20 wt %, such as from 4 wt % to 18 wt %, from 6 wt % to 16 wt % based on the total weight of the cement composition.
   67. The method of embodiment 66, wherein the cement composition is present in an amount of from 10 to 98 wt % based on the dry weight of the concrete composition, optionally where the cement composition is present in an amount of from 10 wt % to 60 wt %, further optionally, wherein the cement composition is present in an amount of from 15 wt % to 50 wt %, such as from 15 wt % to 40 wt % based on the dry weight of the concrete composition.
   68. The method of any one of embodiments 66 or 67, wherein the aggregate material is selected from sand, gravel, crushed stone, iron blast-furnace slag, lightweight filler, mineral aggregate, and any combinations thereof.
   69. The method of any one of embodiments 66 to 68, wherein the water to cement ratio is in the range of from 0.1 to 0.9, such as from 0.15 to 0.8, optionally from 0.15 to 0.5, for example from 0.2 to 0.45.
   70. The method of any one of embodiments 66 to 69, wherein the concrete composition is allowed to set.
   71. The method of any one of embodiments 66 to 70, wherein the concrete composition has a 28 day strength of greater than 25 MPa, such as greater than 30 MPa.
   72. The method of any one of embodiments 66 to 71, wherein the concrete composition has a 28 day strength in the range of from 25 MPa to 250 MPa, optionally from 25 MPa to 150 MPa, such as from 30 MPa to 100 MPa.
   73. A concrete composition formed by the method of any one of embodiments 66 to 72.
   74. A cement composition comprising:
red mud and gypsum, wherein the red mud is present in an amount of from 45 wt % to 60 wt % based on the total weight of the cement composition, and wherein the gypsum is present in an amount of from 5 wt % to 20 wt % based on the total weight of the cement composition;
said composition further comprising:
pozzolan in an amount of from 10 to 35 wt % based on the total weight of the cement composition, metasilicate in an amount of from 4 to 18 wt % based on the total weight of the cement composition, and zeolite in an amount of from 0.5 wt % to 5 wt % based on the total weight of the cement composition.
   75. The cement composition of embodiment 74, wherein the composition does not comprise a foaming agent.
   76. The cement composition of embodiment 74 or 75, wherein the composition does not comprise protein.
   77. A method of preparing a cement composition comprising combining:
(a) red mud; and
(b) gypsum;
to provide a cement composition, wherein the red mud is present in an amount of from 20 wt % to 95 wt % based on the total weight of the cement composition, and wherein the gypsum is present in an amount of from 5 wt % to 50 wt % based on the total weight of the cement composition.
   78. The method of embodiment 77, wherein the red mud is present in an amount of from 30 wt % to 95 wt %, optionally from 40 wt % to 95 wt %, such as from 50 wt % to 85 wt % based on the total weight of the cement composition.
   79. The method of embodiment 77 or 78, wherein the gypsum is present in an amount of from 5 wt % to 25 wt %, optionally from 5 wt % to 20 wt %, such as from 5 wt % to 15 wt % based on the total weight of the cement composition.
   80. The method of any one of embodiments 77 to 79, wherein the red mud comprises Fe₂O₃, SiO₂, Al₂O₃, CaO, TiO₂, Na₂O, P₂O₅, and K₂O.
   81. The method of any one of embodiments 77 to 80, wherein the cement composition further comprises pozzolan, optionally in an amount of from 10 to 35 wt %, such as from 15 wt % to 30 wt %, optionally from 20 wt % to 25 wt % based on the total weight of the cement composition.
   82. The method of any one of embodiments 77 to 81, wherein the pozzolan comprises calcium oxide or calcium hydroxide, and silicon dioxide, wherein the calcium oxide or calcium hydroxide is present in an amount of from 1 to 60 wt % based on the total weight of the pozzolan, and wherein the silicon dioxide is present in an amount of from 5% to 70 wt % based on the total weight of the pozzolan.
   83. The method of embodiment 81 or 82, wherein the pozzolan is selected from the group comprising carbide slag, granulated ground blast furnace slag, fly ash, attapulgite, kaolin, zeolites, and
   84. The method of any one of embodiments 77 to 83, wherein the cement composition further comprises metasilicate, optionally in an amount of from 2 to 20 wt %, such as from 4 wt % to 18 wt %, from 6 wt % to 16 wt %, optionally from 8 wt % to 12 wt % based on the total weight of the cement composition.
   85. The method of any one of embodiments 77 to 84, wherein the metasilicate is sodium metasilicate or sodium metasilicate pentahydrate.
   86. The method of any one of embodiments 77 to 85, wherein the cement composition further comprises zeolite, optionally in an amount of from 1 to 5 wt % based on the total weight of the cement composition.
   87. The method of any one of embodiments 77 to 86, wherein the cement composition further comprises a retarder, optionally, wherein the retarder is selected from the group consisting of: sodium tetraborate; tartaric acid; boric acid; sodium citric dehydrate and citric acid, further optionally, wherein the retarder is present in an amount of from 1 wt % to 20 wt % of the cement composition.
   88. A cement formed by the method of any one of embodiments 77 to 87.
   89. A method for forming a cementitious composition comprising the step of combining the cement composition of embodiment 88 with water.
   90. The method of embodiment 89, wherein the water to cement ratio ranges from 0.20 to 0.9.
   91. A cementitious composition formed by the method of embodiment 89 or 90.
   92. A method for forming a concrete composition comprising combining a cement composition/component, with aggregate material and water to form the concrete composition, wherein the cement composition comprises:
(a) red mud; and
(b) gypsum;
wherein the red mud is present in an amount of from 20 wt % to 95 wt % based on the total weight of the cement composition, and wherein the gypsum is present in an amount of from 5 wt % to 50 wt % based on the total weight of the cement composition.
   93. The method of embodiment 92, wherein the cement component is present in an amount of from 25 to 98 wt % based on the dry weight of the concrete composition.
   94. The method of embodiment 92 or 93, wherein the aggregate material is selected from sand, gravel, crushed stone, iron blast-furnace slag, lightweight filler, mineral aggregate, and any combinations thereof.
   95. The method of any one of embodiments 92 to 94, wherein the aggregate material is present in an amount of from 1 to 90 wt % based on the dry weight of the concrete composition.
   96. A concrete composition formed by the method of any one of embodiments 92 to 94.
   97. A method of fireproofing an object comprising applying a cementitious composition to at least partially coat the object with the cementitious composition thereby forming a fire resistant coating on the object, wherein the cementitious composition comprises a cement component and water, wherein the cement component comprises:
(a) red mud; and
(b) gypsum;
wherein the red mud is present in an amount of from 20 wt % to 95 wt % based on the total weight of the cement composition, and wherein the gypsum is present in an amount of from 5 wt % to 50 wt % based on the total weight of the cement composition.
   98. A method of fireproofing an object comprising applying a concrete composition to at least partially coat the object with the concrete composition thereby forming a fire resistant coating on the object, wherein the concrete composition comprises a cement component, aggregate and water, wherein the cement component comprises:
(a) red mud; and
(b) gypsum;
wherein the red mud is present in an amount of from 20 wt % to 95 wt % based on the total weight of the cement composition, and wherein the gypsum is present in an amount of from 5 wt % to 50 wt % based on the total weight of the cement composition.
   99. The method of embodiment 97 or 98, wherein the red mud is present in an amount of from 35 wt % to 60 wt %, such as from 40 wt % to 55 wt % based on the total weight of the cement component.
   100. The method of any one of embodiments 97 to 99, wherein the gypsum is present in an amount of from 5 wt % to 20 wt %, such as from 5 wt % to 15 wt % based on the total weight of the cement component.
   101. The method of any one of embodiments 97 to 100, wherein the cement component further comprises pozzolan, optionally in an amount of from 10 to 40 wt %, such as from 10 wt % to 35 wt %, optionally, from 15 wt % to 30 wt %, based on the total weight of the cement component.
   102. The method of any one of embodiments 97 to 101, wherein the pozzolan comprises calcium oxide or calcium hydroxide, and silicon dioxide, wherein the calcium oxide or calcium hydroxide is present in an amount of from 1 to 60 wt % based on the total weight of the pozzolan, and wherein the silicon dioxide is present in an amount of from 5% to 70 wt % based on the total weight of the pozzolan.
   103. The method of embodiment 101 or 102, wherein the pozzolan is selected from the group comprising carbide slag, granulated ground blast furnace slag, fly ash, attapulgite, kaolin, zeolites, and 104. The method of any one of embodiments 97 to 103, wherein the cement component further comprises metasilicate, optionally in an amount of from 2 to 20 wt %, such as from 4 wt % to 18 wt %, from 6 wt % to 16 wt %, optionally from 8 wt % to 12 wt % based on the total weight of the cement component.
   105. The method of any one of embodiments 97 to 104, wherein the metasilicate is sodium metasilicate or sodium metasilicate pentahydrate.
   106. The method of any one of embodiments 97 to 105, wherein the cement component further comprises zeolite, optionally in an amount of from 1 to 5 wt %, such as from 1.5 to 4 wt % based on the total weight of the cement component.
   107. The method of any one of embodiments 97 to 106, wherein the cement component further comprises a retarder, optionally, wherein the retarder is selected from the group consisting of: sodium tetraborate; tartaric acid; boric acid; sodium citric dehydrate and citric acid, further optionally, wherein the retarder is present in an amount of from 1 wt % to 20 wt % such as in an amount of from 1 wt % to 5 wt % based on the total weight of the cement component.
   108. The method of any one of embodiments 98, and 99 to 107 as dependent on embodiment 98, wherein the wherein the cement component is present in an amount of from 25 to 98 wt %, such as from about 25 wt % to 95 wt %, optionally from 30 to 70 wt % based on the dry weight of the concrete composition.
   109. The method of embodiment 98, and 99 to 108 as dependent on embodiment 98, wherein the aggregate material is selected from sand, gravel, crushed stone, iron blast-furnace slag, lightweight filler, mineral aggregate, and any combinations thereof.
   110. The method of embodiment 109, wherein the aggregate material is sand or lightweight filler.
   111. The method of any one of embodiments 98, and 99 to 110 as dependent on embodiment 98, wherein concrete has a 28 day compressive strength of at least 30 MPa, optionally, wherein the 28 day compressive strength is in the range of from 30 MPa to 100 MPa, such as from 30 MPa to 60 MPa.
   112. The method of any one of embodiments 98, and 99 to 111 as dependent on embodiment 98, wherein the concrete has a thermal conductivity in the range of from 0.1 to 0.8 W/(m·K), optionally, from 0.2 to 0.7 W/(m·K).

1. A method of servicing a subterranean formation having one or more lost circulation zones, comprising:
introducing a lost circulation composition into a lost circulation zone,
the lost circulation composition comprising a cement component and water; and allowing the lost circulation composition to set in the lost circulation zone, wherein the cement component comprises: red mud and gypsum and optionally additives, wherein the additives are present in no more than 50 wt % based on the total weight of the cement component,
wherein the red mud is present in an amount of from 40 wt % to 95 wt % and the gypsum is present in an amount of 5 wt % to 50 wt % based ion the total weight of the cement component, optionally wherein the lost circulation cement composition has a unit weight (or density) in the range of from 10 ppg to 25 ppg, optionally from 10 ppg to 20 ppg, and
allowing the lost circulation composition to set in the lost circulation zone.

2. The method of claim 1, wherein the red mud is present in an amount of from about 50 wt % to 75 wt % based on the total weight of the cement component, optionally, wherein the red mud is present in an amount of from 55 wt % to 72 wt %, such as from 57 wt % to 71 wt % based on the total weight of the cement component.

3. The method of claim 1, wherein the gypsum is present in an amount of from 5 wt % to 30 wt % based on the total weight of the cement component, optionally, wherein the gypsum is present in an amount of from 8 wt % to 28 wt %, such as from 9 wt % to 26 wt % based on the total weight of the cement component.

4. The method of any one of claim 1, wherein the lost circulation cement composition has a unit weight in the range of from 10 ppg (1198 kg/m³) to 15 ppg (1797 kg/m³).

5. The method of claim 1, wherein the lost circulation composition has a compressive strength after 24 hours in the range of from 7 MPa to 21 MPa in accordance with ASTM C39, optionally wherein the compressive strength after 24 hours is in the range of from 10 MPa to 20 MPa.

6. The method of claim 1, wherein the water to cement ratio is in the range of from 0.5 to 0.9, such as from 0.55 to 0.85.

7. The method of claim 1, wherein the lost circulation composition has a thickening time at 37.8° C. in the range of from 2.5 hours to 5 hours.

8. The method of claim 1, wherein the lost circulation composition has a 10-second static gel strength of at least about 15 lbf/100 ft² (7.18 N/m²) at room temperature, and wherein the lost circulation composition has a 10 minute static gel strength of at least about 25 lbf/100 ft² (11.97 N/m²) at room temperature.

9. The method of claim 1, wherein the additives comprise metasilicate, optionally, wherein the metasilicate is present in an amount of from 1 wt % to 12 wt % such as in an amount of from about 1 wt % to 8 wt %, suitably from 1.5 wt % to 6 wt % based on the total weight of the cement component.

10. A method for cementing comprising providing a geopolymer cement composition comprising:
a cement component and water,
wherein the cement component comprises red mud and gypsum and optionally additives wherein the additives are present in no more than 50 wt % based on the total weight of the cement component,
wherein the red mud is present in an amount of from 50 wt % to 75 wt % and the gypsum is present in an amount of 5 wt % to 20 wt % based ion the total weight of the cement component, optionally wherein the geopolymer cement composition has a unit weight (or density) in the range of from 10 ppg to 20 ppg, such as from 10 ppg to 15.5 ppg,
introducing the geopolymer cement composition into a wellbore annulus in a subterranean formation during a primary cementing operation; and
allowing the geopolymer cement composition to set in the subterranean formation.

11. The method of claim 10, wherein the red mud is present in an amount of from 52 wt % to 72 wt % based on the total weight of the cement component, optionally, wherein the red mud is present in an amount of from 55 wt % to 72 wt %, such as from 55 wt % to 65 wt % based on the total weight of the cement component.

12. The method of claim 11, wherein the gypsum is present in an amount of from 5 wt % to 30 wt % based on the total weight of the cement component, optionally, wherein the gypsum is present in an amount of from 5 wt % to 25 wt %, such as from 7 wt % to 20 wt % based on the total weight of the cement component.

13. The method of claim 11, wherein the geopolymer cement composition has a unit weight in the range of from 10 ppg (1198 kg/m³) to 15 ppg (1797 kg/m³).

14. The method of claim 11, wherein the geopolymer cement composition has a 24 hour strength in the range of from 4 MPa to 24 MPa.

15. The method of claim 11, wherein the additives comprise pozzolan, optionally, wherein the pozzolan is present in an amount of 10 to 30 wt %, such as from about 15 wt % to 25 wt % based on the total weight of the cement component.

16. The method of claim 11, wherein the additives comprise metasilicate, optionally, wherein the metasilicate is present in an amount of from 1 wt % to 12 wt % such as in an amount of from 1 wt % to 10 wt %, suitably from 2 wt % to 8 wt % based on the total weight of the cement component.

17. The method of claim 11, wherein the water to cement ratio is in the range of from 0.5 to 0.9, such as from 0.52 to 0.88, optionally from 0.55 to 0.85.

18. A method of plugging a wellbore, comprising providing a geopolymer cement composition comprising:
a cement component and water,
wherein the cement component comprises red mud and gypsum and optionally additives wherein the additives are present in no more than 50 wt % based on the total weight of the cement component,
wherein the red mud is present in an amount of from 40 wt % to 95 wt % and the gypsum is present in an amount of 5 wt % to 50 wt % based ion the total weight of the cement component, optionally wherein the geopolymer cement composition has a unit weight (or density) in the range of from 10 (1198 kg/m³) ppg to 20 ppg (2396 kg/m³), such as from 10 (1198 kg/m³) ppg to 17 ppg (2037 kg/m³)
introducing the geopolymer cement composition into the wellbore; and allowing the geopolymer cement composition to set in the wellbore.

19. The method of claim 18, wherein the red mud is present in an amount of from about 45 wt % to 90 wt % based on the total weight of the cement component, optionally, wherein the red mud is present in an amount of from 48 wt % to 88 wt %, such as from 50 wt % to 85 wt % based on the total weight of the cement component.

20. The method of claim 18, wherein the gypsum is present in an amount of from 10 wt % to 40 wt % based on the total weight of the cement component, optionally, wherein the gypsum is present in an amount of from 15 wt % to 35 wt %, such as from 15 wt % to 30 wt % based on the total weight of the cement component.

21. The method of claim 18, wherein the geopolymer cement composition has a 24 hour compressive strength in the range of from 13 MPa to 34 MPa, suitably in the range of from 18 MPa to 30 MPa.

22. The method of claim 18, wherein the wherein the water to cement ratio is in the range of from 0.3 to 0.7, such as from 0.4 to 0.6.
